(19) United States
(12) Patent Application Publication
(10) Pub. No.: US 2025/0301158 A1
(43) Pub. Date: Sep. 25, 2025

(54) METHOD AND APPARATUS FOR CROSS-COMPONENT PREDICTION FOR VIDEO CODING

(71) Applicant: BEIJING DAJIA INTERNET INFORMATION TECHNOLOGY CO., LTD., Beijing (CN)

(72) Inventors: Hong-Jheng JHU, San Diego, CA (US); Che-Wei KUO, San Diego, CA (US); Xiaoyu XIU, San Diego, CA (US); Ning YAN, San Diego, CA (US); Wei CHEN, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/230,675

(22) Filed: Jun. 6, 2025

Related U.S. Application Data
(63) Continuation of application No. PCT/US2023/083209, filed on Dec. 8, 2023.
(63) Continuation of application No. PCT/US2023/084298, filed on Dec. 15, 2023.
(60) Provisional application No. 63/431,359, filed on Dec. 9, 2022.
(60) Provisional application No. 63/433,317, filed on Dec. 16, 2022.

(51) Int. Cl. H04N 19/189; H04N 19/176; H04N 19/186

(52) U.S. Cl. CPC H04N 19/189; H04N 19/176; H04N 19/186

(57) ABSTRACT

The present disclosure provides a method for decoding video data, comprising: obtaining a bitstream, obtaining an information related to one or more convolutional cross-component models (CCCMs) from the bitstream, wherein each of the one or more CCCMs comprises a filter shape and a set of weighting coefficients corresponding to the filter shape for predicting each of the chroma sample values of a video block from the bitstream based on a plurality of corresponding luma sample values, and decoding the video data based on the information related to the one or more CCCMs.

### CROSS-REFERENCE TO RELATED APPLICATION

This application is a continuation of the following PCT applications: PCT Application No. PCT/US2023/083209 filed on Dec. 8, 2023 and claims priority to Provisional Application No. 63/431,359 filed on Dec. 9, 2022; and PCT Application No. PCT/US2023/084298 filed on Dec. 15, 2023 and claims priority to Provisional Application No. 63/433,317 filed on Dec. 16, 2022. The entire content thereof is incorporated herein by reference in its entirety.

### TECHNICAL FIELD

This application is related to video coding and compression. More specifically, this application relates to methods and apparatus on improving the coding efficiency of the image/video blocks which applies cross-component prediction technology.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide methods and apparatus on improving the coding efficiency of the image/video blocks which applies cross-component prediction technology.

The following presents a simplified summary of one or more aspects according to the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one aspect of the present disclosure, there provides a method for decoding video data. The method comprises: receiving an encoded block of luma samples for a block of the video data; decoding the encoded block of luma samples to obtain reconstructed luma samples for the block; classifying a luma sample for the block into one of a plurality of sample groups based on edge information of the luma sample, wherein the luma sample is obtained from one or more of the reconstructed luma samples to correspond to a chroma sample for the block; and predicting the chroma sample by applying one of a plurality of linear prediction models corresponding to the classified sample group to the luma sample.

According to one aspect of the present disclosure, there provides a computer system comprising one or more processors and one or more storage devices storing computer-executable instructions that, when executed, cause the one or more processors to perform the operations including: receiving an encoded block of luma samples for a block of the video data; decoding the encoded block of luma samples to obtain reconstructed luma samples for the block; classifying a luma sample for the block into one of a plurality of sample groups based on edge information of the luma sample, wherein the luma sample is obtained from one or more of the reconstructed luma samples to correspond to a chroma sample for the block; and predicting the chroma sample by applying one of a plurality of linear prediction models corresponding to the classified sample group to the luma sample.

According to one aspect of the present disclosure, a method for video decoding with an Edge-classified linear model (ELM) is provided. The method may include: receiving an encoded block of luma samples for a first block of video signal; decoding the encoded block of luma samples to obtain reconstructed luma samples; classifying the reconstructed luma samples into plural sample groups based on direction and strength of edge information; applying different linear prediction models to the reconstructed luma samples in different sample groups; predicting chroma samples for the first block of video signal based on the applied linear prediction models.

According to one aspect of the present disclosure, a method for video decoding with a Filter-based linear model (FLM) is provided. The method may include: receiving an encoded block of luma samples for a first block of video signal; decoding the encoded block of luma samples to obtain reconstructed luma samples; determining a luma sample region and a chroma sample region to derive a multiple linear regression (MLR) model; deriving the MLR model by pseudo inverse matrix calculation; applying the MLR model to the reconstructed luma samples; predicting chroma samples for the first block of video signal based on the applied MLR model.

According to one aspect of the present disclosure, a method for video decoding with a Gradient linear model (GLM) is provided. The method may include: receiving an encoded block of luma samples for a first block of video signal; decoding the encoded block of luma samples to obtain reconstructed luma samples; utilizing the sample gradients to exploit the correlation between luma AC information and chroma intensities; determining a luma sample region and a chroma sample region to derive a multiple linear regression (MLR) model; deriving the MLR model by pseudo inverse matrix calculation; applying the MLR model to the reconstructed luma samples; predicting chroma samples for the first block of video signal based on the applied MLR model.

According to one aspect of the present disclosure, a method for video coding without down-sampled process in convolutional cross-component model (CCCM) is provided. The method may include: receiving an encoded block of luma samples for a first block of video signal; decoding the encoded block of luma samples to obtain reconstructed luma samples; utilizing non-down-sampled luma reference values and/or different selection of non-down-sampled luma reference; determining a luma sample region and a chroma sample region to derive a convolutional cross-component model (CCCM); deriving the CCCM parameters by LDL decomposition; applying the CCCM to the reconstructed luma samples; predicting chroma samples for the first block of video signal based on the applied CCCM.

According to one aspect of the present disclosure, a method for video coding with a LDL decomposition in a cross-component linear model (CCLM)/Multi-model LM (MMLM) is provided. The method may include: receiving an encoded block of luma samples for a first block of video signal; decoding the encoded block of luma samples to obtain reconstructed luma samples; determining a luma sample region and a chroma sample region to derive a cross-component linear model (CCLM)/Multi-model LM (MMLM); deriving the CCLM/MMLM parameters by LDL decomposition; applying the CCLM/MMLM to the reconstructed luma samples; predicting chroma samples for the first block of video signal based on the applied CCLM/MMLM.

According to one aspect of the present disclosure, a method for video coding with a minimal samples restriction in FLM/GLM/ELM/CCCM is provided. The method may include: determining, whether a FLM/GLM/ELM/CCCM scheme is applied in the intra prediction, wherein the number of samples larger than or equal to predefined number in the coded block.

According to one aspect of the present disclosure, a method for video coding with a non-down-sampled and down-sampled luma reference values in CCCM is provided.

According to one aspect of the present disclosure, a method for video coding with a combined multiple modes of FLM/GLM/ELM/CCCM/CCLM is provided.

According to one aspect of the present disclosure, there is provided a method for decoding video data, comprising: obtaining a bitstream; obtaining an information related to one or more convolutional cross-component models (CCCMs) from the bitstream, wherein each of the one or more CCCMs comprises a filter shape and a set of weighting coefficients corresponding to the filter shape for predicting each of the chroma sample values of a video block from the bitstream based on a plurality of corresponding luma sample values; and decoding the video data based on the information related to the one or more CCCMs.

According to one aspect of the present disclosure, there is provided a method for encoding video data, comprising: obtaining an information related to one or more convolutional cross-component models (CCCMs), wherein each of the one or more CCCMs comprises a filter shape and a set of weighting coefficients corresponding to the filter shape for predicting each of the chroma sample values of a video block based on a plurality of corresponding luma sample values; encoding the video data based on the information related to the one or more CCCMs; and obtaining a bitstream comprising the encoded video data and the information related to the one or more CCCMs.

According to one aspect of the present disclosure, there is provided a method for decoding video data, comprising: obtaining a video block from a bitstream; predicting, with a convolutional cross-component model (CCCM), each of the chroma sample values of the video block, wherein the CCCM comprises a filter shape and a set of weighting coefficients determined based on external luma samples and external chroma samples of an external region of the video block, wherein the set of weighting coefficients comprises a weighting coefficient corresponding to a distance value representative of a distance between the center luma sample of the filter and a reference luma sample; and obtaining predicted video block using the predicted internal chroma sample values.

According to one aspect of the present disclosure, there is provided a method for encoding video data, comprising: obtaining a video block; predicting, with a convolutional cross-component model (CCCM), each of the chroma sample values of the video block, wherein the CCCM comprises a filter shape and a set of weighting coefficients determined based on external luma samples and external chroma samples of an external region of the video block, wherein the set of weighting coefficients comprises a weighting coefficient corresponding to a distance value representative of a distance between the center luma sample of the filter and a reference luma sample; and generating a bitstream comprising an encoded video block by using the predicted chroma sample values.

According to one aspect of the present disclosure, there is provided a method for decoding video data, comprising: obtaining the luma sample values of a first video block from a bitstream; obtaining a set of weighting coefficients corresponding to a filter shape for a second video block from the bitstream, wherein the set of weighting coefficients and the filter shape were used to predict each of the chroma sample values of the second video block based on a plurality of corresponding luma sample values of the second video block; predicting, with the set of weighting coefficients and the filter shape, each of the chroma sample values of the first video block based on a plurality of corresponding luma sample values of the first video block; and obtaining predicted first video block using the predicted chroma sample values of the first video block.

According to one aspect of the present disclosure, there is provided a method for encoding video data, comprising: obtaining the luma sample values of a first video block; obtaining a set of weighting coefficients corresponding to a filter shape for a second video block, wherein the set of weighting coefficients and the filter shape were used to predict each of the chroma sample values of the second video block based on a plurality of corresponding luma sample values of the second video block; predicting, with the set of weighting coefficients and the filter shape, each of the chroma sample values of the first video block based on a plurality of corresponding luma sample values of the first video block; and generating a bitstream comprising an encoded first video block by using the predicted chroma sample values.

According to one aspect of the present disclosure, there is provided a method for decoding video data, comprising: obtaining a video block from a bitstream; obtaining a reference luma sample value and a reference chroma sample value in an external region of the video block; predicting each of the chroma sample values of the video block by: applying a convolutional cross-component model (CCCM) to a plurality of non-down-sampled luma sample values each reduced by the reference luma sample value, and summing the result of the CCCM and the reference chroma sample value; and obtaining predicted video block using the predicted chroma sample values.

According to one aspect of the present disclosure, there is provided a method for encoding video data, comprising: obtaining a video block; obtaining a reference luma sample value and a reference chroma sample value in an external region of the video block; predicting each of the chroma sample values of the video block by: applying a convolutional cross-component model (CCCM) to a plurality of non-down-sampled luma sample values each reduced by the reference luma sample value, and summing the result of the CCCM and the reference chroma sample value; and generating a bitstream comprising an encoded video block by using the predicted chroma sample values.

According to one aspect of the present disclosure, there is provided a method for decoding video data, comprising: obtaining a video block from a bitstream; predicting each of the chroma sample values of the video block by applying a convolutional cross-component model (CCCM) to a plurality of non-down-sampled luma samples collocated with the chroma sample to be predicted, wherein the coordinates of the center luma sample of the plurality of non-down-sampled luma samples are determined based on the coordinates of the chroma sample to be predicted and the chroma format of the video block; and obtaining predicted video in block using the predicted chroma sample values.

According to one aspect of the present disclosure, there is provided a method for encoding video data, comprising: obtaining a video block; predicting each of the chroma sample values of the video block by applying a convolutional cross-component model (CCCM) to a plurality of non-down-sampled luma samples collocated with the chroma sample to be predicted, wherein the coordinates of the center luma sample of the plurality of non-down-sampled luma samples are determined based on the coordinates of the chroma sample to be predicted and the chroma format of the video block; and generating a bitstream comprising an encoded video block by using the predicted internal chroma sample values.

According to one aspect of the present disclosure, there is provided a computer system, comprising: one or more processors; and one or more storage devices storing computer-executable instructions that, when executed, cause the one or more processors to perform the operations of the method of the present disclosure.

According to one aspect of the present disclosure, there is provided a computer program product, storing computer-executable instructions that, when executed, cause one or more processors to perform the operations of the method of the present disclosure.

According to one aspect of the present disclosure, there is provided a computer readable storage medium storing instructions which when executed by a computing device having one or more processors, cause the one or more processors to perform the decoding method of the present disclosure and storing a bitstream to be decoded by the decoding method of the present disclosure.

According to one aspect of the present disclosure, there is provided a computer readable storage medium storing instructions which when executed by a computing device having one or more processors, cause the one or more processors to perform the encoding method of the present disclosure and storing a bitstream generated by the encoding method of the present disclosure.

According to one aspect of the present disclosure, there is provided a computer readable medium storing a bitstream, wherein the bitstream is to be decoded by performing the operations of the method of the present disclosure.

According to one aspect of the present disclosure, there is provided a computer readable medium storing a bitstream, wherein the bitstream is obtained by performing the operations of the method of the present disclosure.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A, 4B, 4C, 4D and 4E are block diagrams illustrating how a frame is recursively partitioned into multiple video blocks of different sizes and shapes in accordance with some implementations of the present disclosure.

FIG. 5 illustrates a general diagram of block-based video encoder for the VVC.

FIGS. 6A, 6B, 6C, 6D and 6E are diagrams illustrating block partitions in the VVC.

FIG. 7 illustrates a general diagram of video decoder for the VVC.

FIG. 8 is a diagram illustrating locations of the samples used for the derivation of α and β.

FIGS. 9A, 9B and 9C are diagrams illustrating examples of MDLM, MDLM_L and MDLM_T.

FIG. 10 is a diagram illustrating an example of classifying the neighboring samples into two groups.

FIG. 11 is a diagram illustrating a knee point T.

FIGS. 12A to 12B are diagrams illustrating an effect of the slope adjustment parameter “u”.

FIG. 13 is a diagram illustrating used collocated reconstructed luma samples.

FIG. 14 is a diagram illustrating used neighboring reconstructed samples.

FIGS. 15A, 15B, 15C and 15D are diagrams illustrating a process of decoder side intra mode derivation.

FIG. 16 is a diagram illustrating an example of four reference lines neighboring to a prediction block.

FIG. 17 is a diagram illustrating a spatial part of the convolutional filter.

FIG. 18 is a diagram illustrating a reference area (with its paddings) used to derive the filter coefficients.

FIGS. 19A to 19B are diagrams illustrating a chroma sample may simultaneously correlate to multiple luma samples.

FIG. 20 is a diagram illustrating coefficients/offset of multiple (e.g., 6) luma samples with respect to 1 chroma sample are trained to linear predict the chroma sample inside the CU.

FIG. 21 is a diagram illustrating different chroma types/color formats can have different predefined filter shapes/taps.

FIG. 22 is a diagram illustrating a FLM can only use top or left luma/chroma samples (extended) for parameter derivation.

FIG. 23 is a diagram illustrating a FLM can use different lines for parameter derivation.

FIGS. 24A, 24B, 24C and 24D are diagrams illustrating pre-operations before applying the MLR model (GLM 1-tap/2-tap).

FIG. 25 is a diagram illustrating examples of different shape/number of filter taps.

FIG. 26 is a diagram illustrating examples of different shape/number of filter taps.

FIGS. 27A to 27B are diagrams illustrating examples of different shape/number of filter taps.

FIGS. 28A, 28B, 28C, 28D, 28E, 28F and 28G are diagrams illustrating examples of different set of filter taps.

FIGS. 29A to 29B are diagrams illustrating 2-fold training for implicitly filter shape derivation.

FIG. 30 is a diagram illustrating non-down-sampled luma samples.

FIG. 31 illustrates a workflow of a method for decoding video data according to one or more aspects of the present disclosure.

FIG. 32 illustrates a workflow of a method for encoding video data according to one or more aspects of the present disclosure.

FIG. 33 illustrates a workflow of a method for decoding video data according to one or more aspects of the present disclosure.

FIG. 34 illustrates a workflow of a method for encoding video data according to one or more aspects of the present disclosure.

FIG. 35 illustrates a workflow of a method for decoding video data according to one or more aspects of the present disclosure.

FIG. 36 illustrates a workflow of a method for encoding video data according to one or more aspects of the present disclosure.

FIG. 37 illustrates a workflow of a method for decoding video data according to one or more aspects of the present disclosure.

FIG. 38 illustrates a workflow of a method for encoding video data according to one or more aspects of the present disclosure.

FIG. 39 illustrates a workflow of a method for decoding video data according to one or more aspects of the present disclosure.

FIG. 40 illustrates a workflow of a method for encoding video data according to one or more aspects of the present disclosure.

FIG. 41 is a diagram illustrating a computing environment coupled with a user interface, according to some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

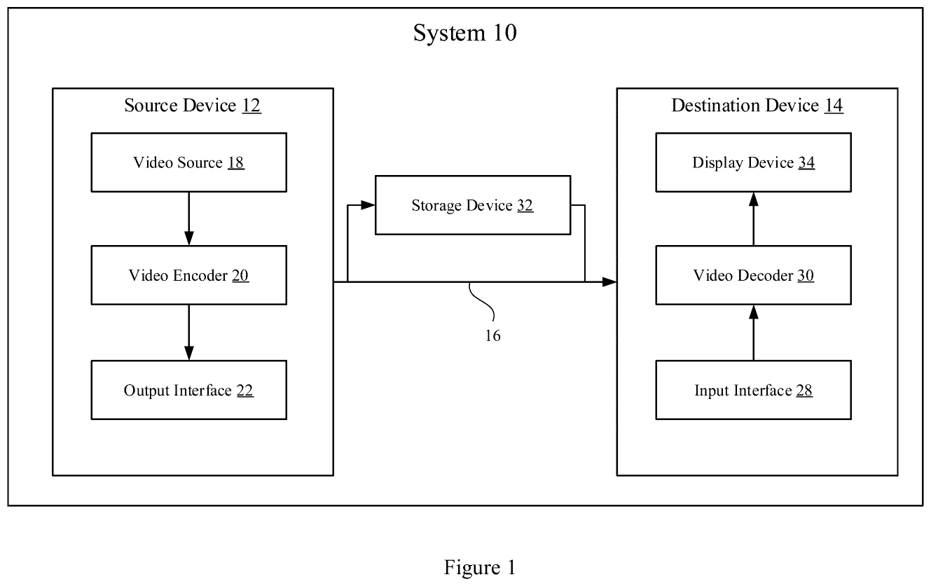

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

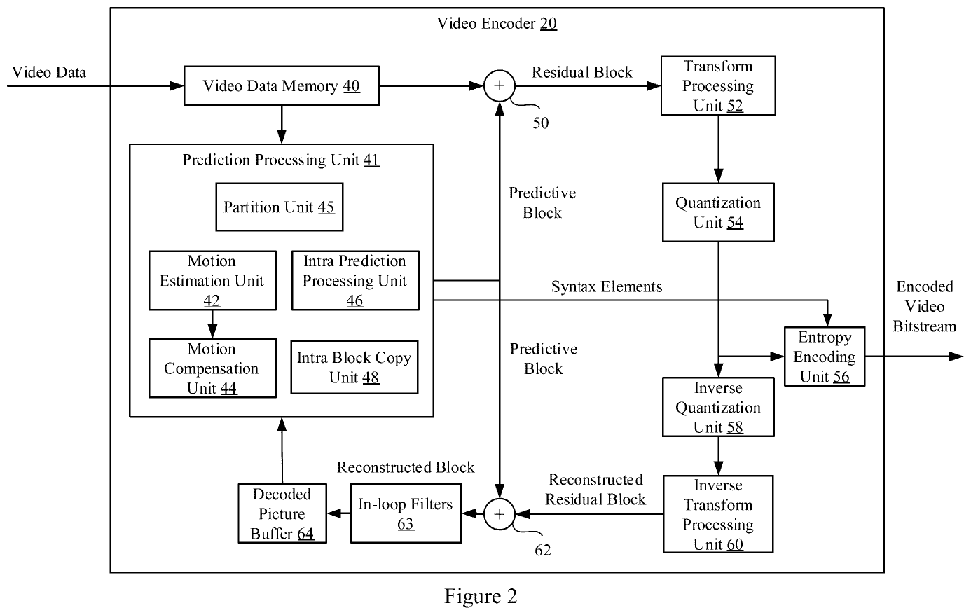

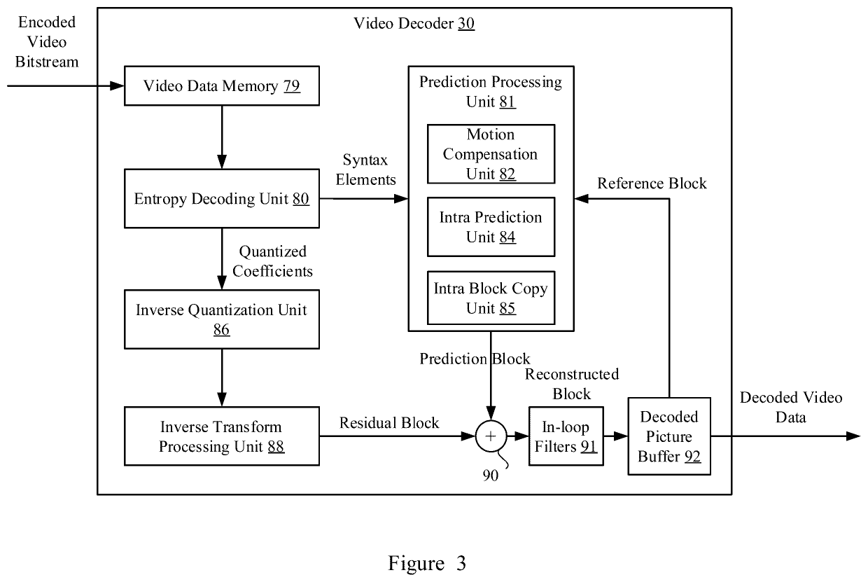

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

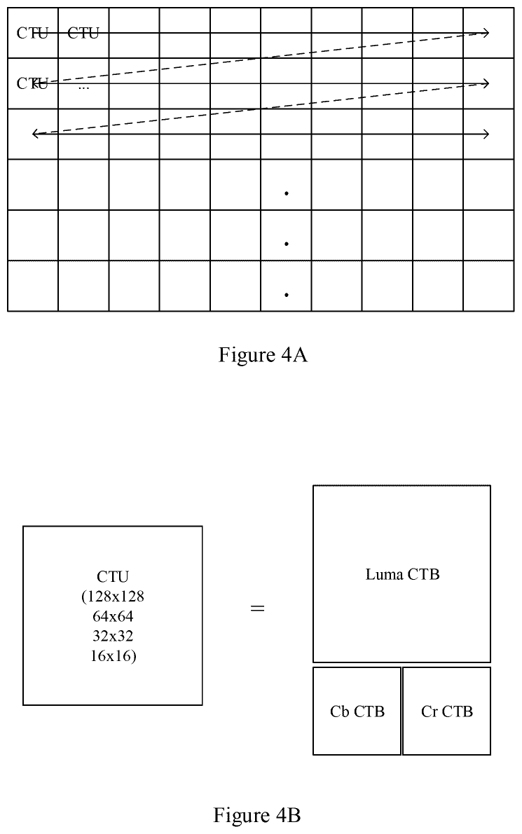

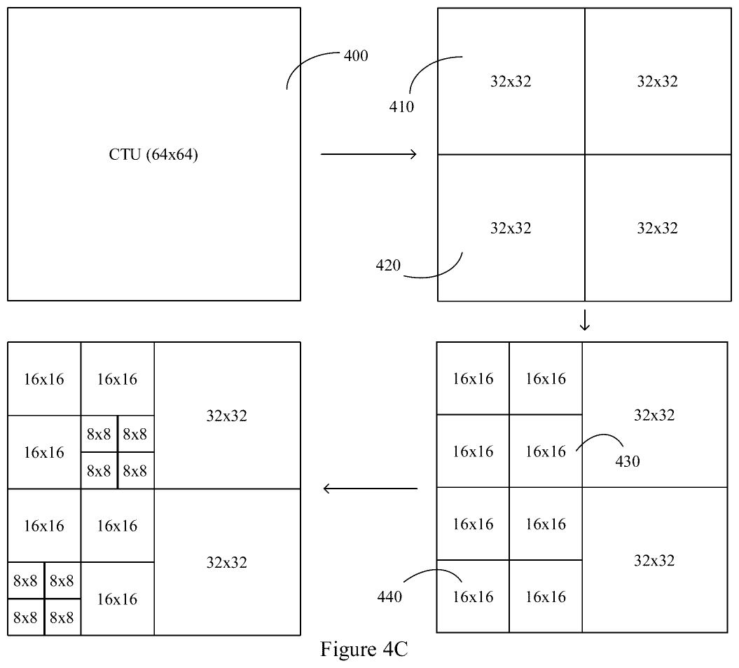

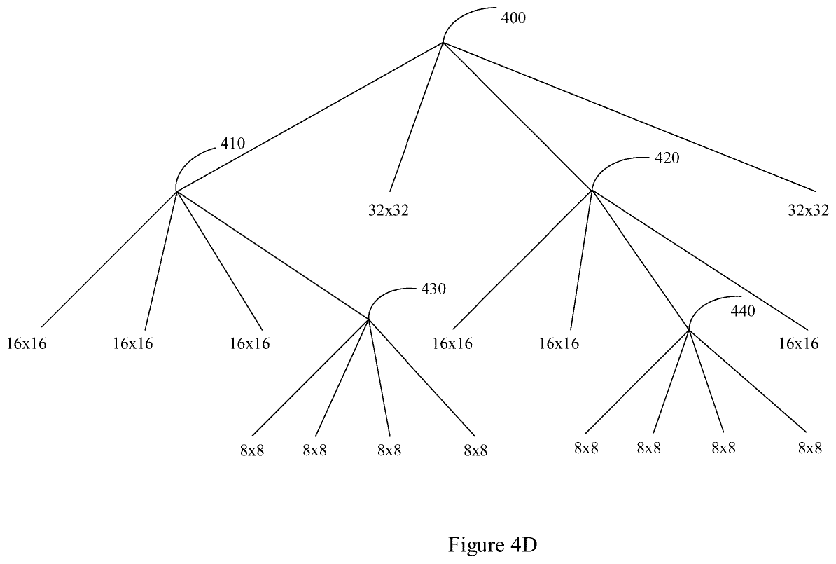

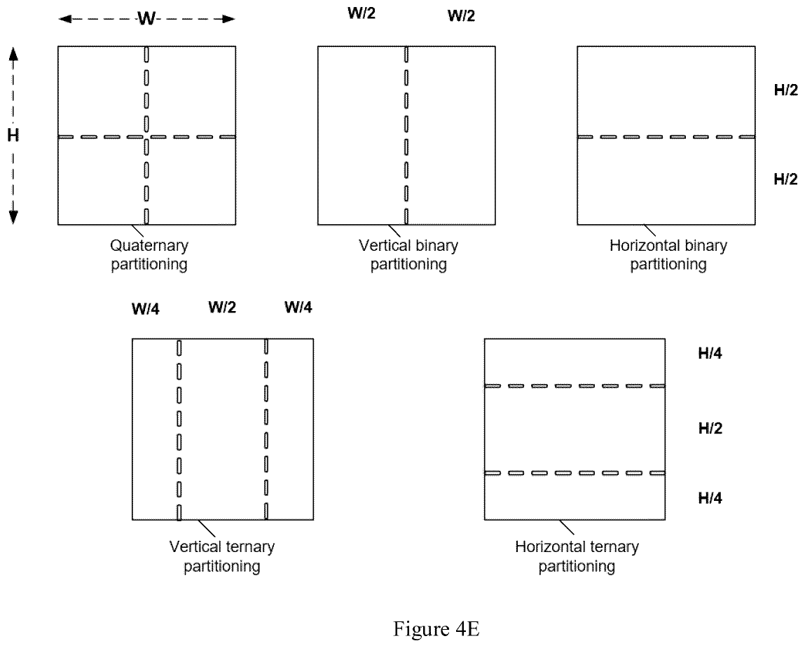

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

### INTRODUCTION

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VCEG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard can be integrated into the ECM platform, and tested using JVET common test conditions (CTCs).

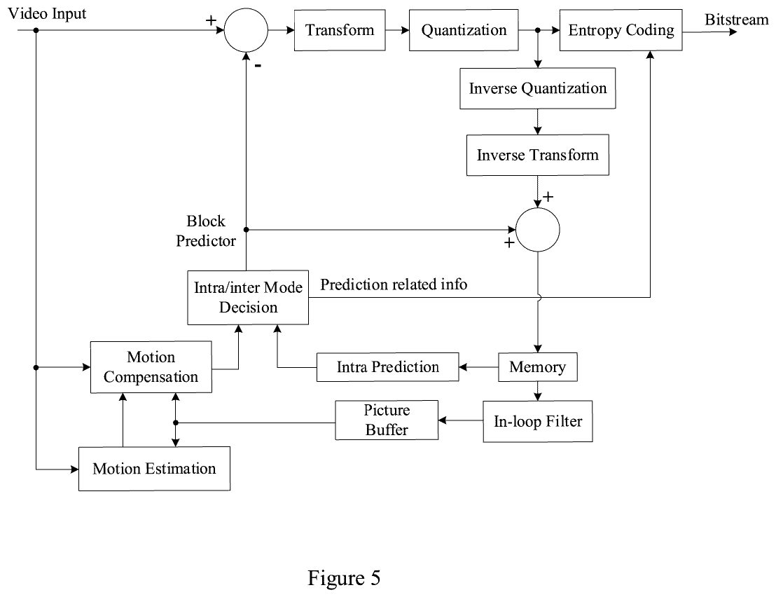

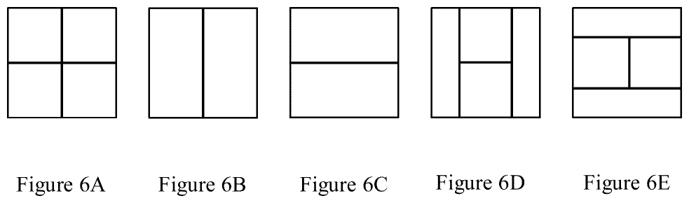

Similar to all the preceding video coding standards, the ECM is built upon the block-based hybrid video coding framework. FIG. 5 illustrates a block diagram of a generic block-based hybrid video encoding system. The input video signal is processed block by block (called coding units (CUs)). In ECM-1.0, a CU can be up to 128×128 pixels. However, same to the VVC, one coding tree unit (CTU) is split into CUs to adapt to varying local characteristics based on quad/binary/ternary-tree. In the multi-type tree structure, one CTU is firstly partitioned by a quad-tree structure. Then, each quad-tree leaf node can be further partitioned by a binary and ternary tree structure. As shown in FIGS. 6A, 6B, 6C, 6D, and 6E, there are five splitting types, quaternary partitioning, vertical binary partitioning, horizontal binary partitioning, vertical extended quaternary partitioning, and horizontal extended quaternary partitioning.

In FIG. 5, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

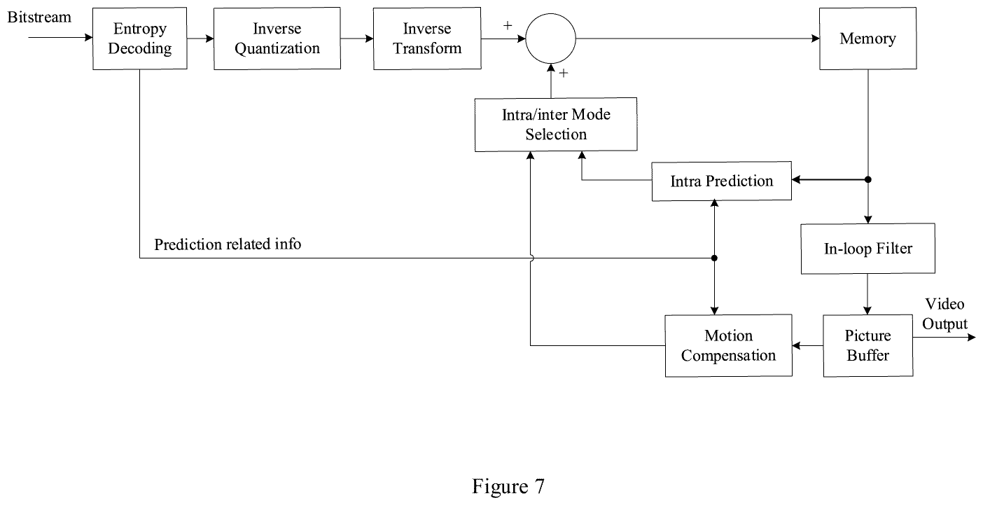

FIG. 7 illustrates a general block diagram of a block-based video decoder. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out to drive a display device, as well as used to predict future video blocks.

The main focus of this disclosure is to further enhance the coding efficiency of the coding tool of cross-component prediction, cross-component linear model (CCLM), that is applied in the ECM. In the following, some related coding tools in the ECM are briefly reviewed. After that, some deficiencies in the existing design of CCLM are discussed. Finally, the solutions are provided to improve the existing CCLM prediction design.

### Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU, and rec_{L}′(i, j) represents the down-sampled reconstructed luma samples of the same CU which are obtained by performing down-sampling on the reconstructed luma samples rec_{L}(i, j). The above α and β are linear model parameters which are derived from at most four neighboring chroma samples and their corresponding down-sampled luma samples, which may be referred to as neighboring luma-chroma sample pairs. Suppose that a current chroma block has a size of W×H, then W′ and H′ are obtained as follows:
W′=W, H′=H when LM mode is applied;
W′=W+H when LM-A mode is applied;
H′=H+W when LM-L mode is applied;
   where in the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above neighboring samples of a chroma block are denoted as S[0, −1] . . . . S[W′−1, −1] and locations of left neighboring samples of the chroma block are denoted as S[−1, 0] . . . . S[−1, H′−1], positions of four neighboring chroma samples are selected as follows:
S[W′/4, −1], S[3*W′/4, −1], S[−1, H′/4], S[−1, 3*H′/4] are selected as the positions of the four neighboring chroma samples when LM mode is applied and both above and left neighboring samples are available;
S[W′/8, −1], S[3*W′/8, −1], S[5*W′/8, −1], S[7*W′/8, −1] are selected as the positions of the four neighboring chroma samples when LM-A mode is applied or only the above neighboring samples are available;
S[−1, H′/8], S[−1, 3*H′/8], S[−1, 5*H′/8], S[−1, 7*H′/8] are selected as the positions of the four neighboring chroma samples when LM-L mode is applied or only the left neighboring samples are available.

The four neighboring luma samples corresponding to the selected locations are obtained by a down-sampling operation and the obtained four neighboring luma samples are compared four times to find two larger values: x⁰_{A} and x¹_{A}, and two smaller values: x⁰_{B} and x¹_{B}. Chroma sample values corresponding to the two larger values and the two smaller values are denoted as y⁰_{A}, y¹_{A}, y⁰_{B} and y¹_{B} respectively. Then Xₐ, X_{b}, Yₐ and Y_{b} are derived as:

$${X}_{a} = ( {x}_{A}^{0} + {x}_{A}^{1} + 1 ) ≫ 1 ; \qquad ( 2 )$$

$${X}_{b} = ( {x}_{B}^{0} + {x}_{B}^{1} + 1 ) ≫ 1 ;$$

$${Y}_{a} = ( {y}_{A}^{0} + {y}_{A}^{1} + 1 ) ≫ 1 ;$$

$${Y}_{b} = ( {y}_{B}^{0} + {y}_{B}^{1} + 1 ) ≫ 1$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

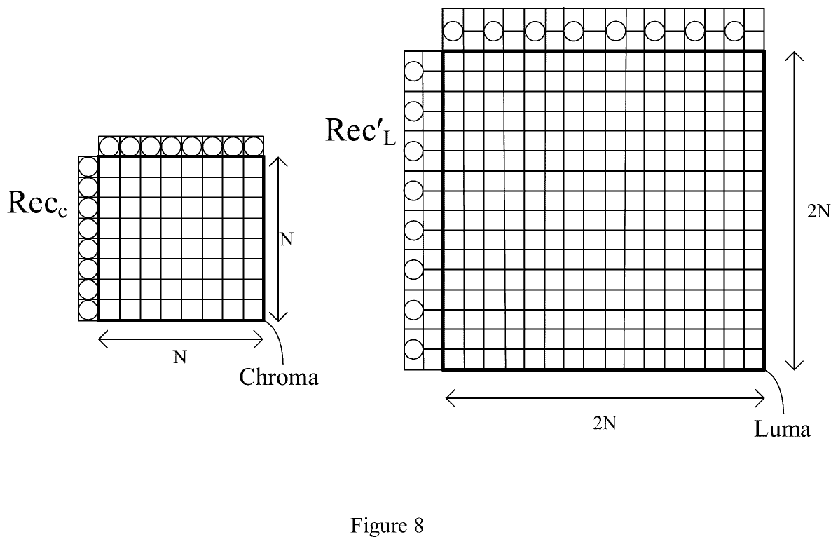

FIG. 8 illustrates an example of the locations of the left and above samples and the sample of the current block involved in the CCLM mode, including locations of left and above samples of an N×N chroma block in the CU and locations of left and above samples of an 2N×2N luma block in the CU.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called LM_A, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM_LT mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$$( 6 )$$

$${Rec}_{L}^{′} ( i , j ) = [ \text{} \begin{matrix}{rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 \qquad ( 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signaling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1
Derivation of chroma prediction mode
from luma mode when cclm is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

During the ECM development, the simplified derivation of α and β (min-max approximation) is removed. Instead, linear least square solution between causal reconstructed data of down-sampled luma samples and causal chroma samples to derive model parameters α and β.

$$α = \frac{I \times {\sum }_{i = 0}^{I} {Rec}_{C} ( i ) \times {Rec}_{L}^{′} ( i ) - {\sum }_{i = 0}^{I} {Rec}_{C} ( i ) \times {\sum }_{i = 0}^{I} {Rec}_{L}^{′} ( i )}{I \times {\sum }_{i = 0}^{I} {Rec}_{L}^{′} ( i ) \times {Rec}_{L}^{′} ( i ) - {( {\sum }_{i = 0}^{I} {Rec}_{L}^{′} ( i ) )}^{2}} = \frac{{A}_{1}}{{A}_{2}} \qquad ( 8 )$$

$$β = \frac{{\sum }_{i = 0}^{I} {Rec}_{C} ( i ) - α \times {\sum }_{i = 0}^{I} {Rec}_{L}^{′} ( i )}{I} \qquad ( 9 )$$

where Rec_{C}(i) and Rec′_{L}(i) indicate reconstructed chroma samples and down-sampled reconstructed luma samples around the target block, I indicates total samples number of neighboring data.

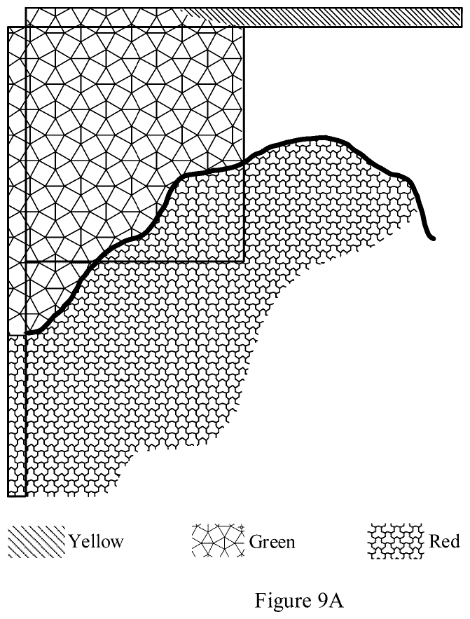

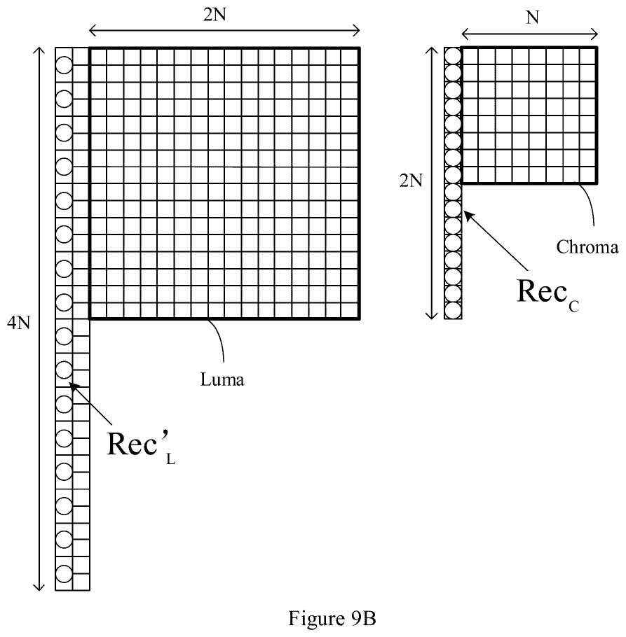

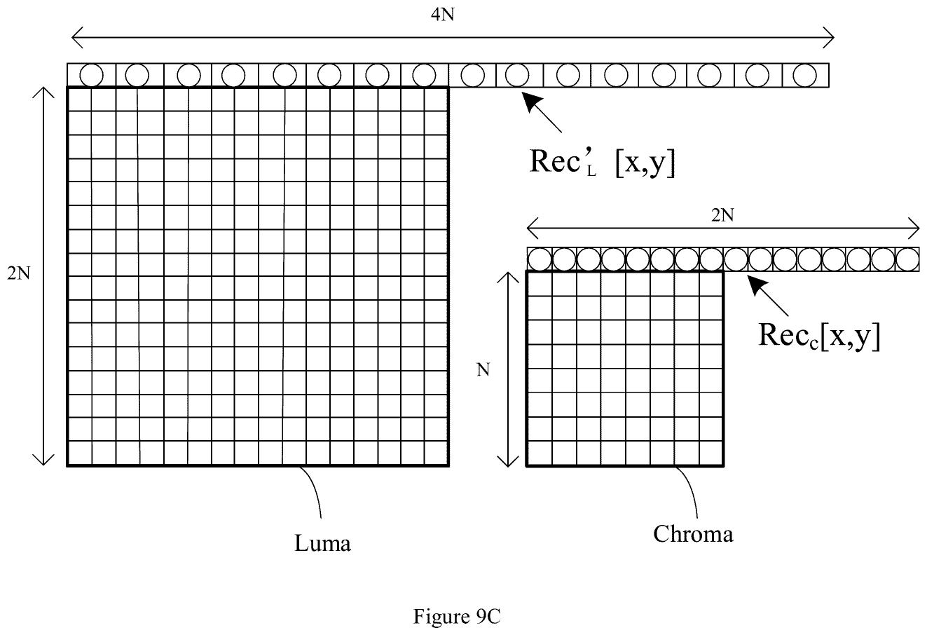

The LM_A, LM_L modes are also called Multi-Directional Linear Model (MDLM). FIG. 9A illustrates an example that MDLM works when the block content cannot be predicted from the L-shape reconstructed region. FIG. 9B illustrates MDLM_L which only uses left reconstructed samples to derive CCLM parameters. FIG. 9C illustrates MDLM_T which only uses top reconstructed samples to derive CCLM parameters.

### JCTVC-C206: Integerization

Integerization for the above discussed Least Mean Square (LMS) (please refer to equations (8)-(9)) has been proposed as improvements for CCLM. The initial integerization design of LMS CCLM was firstly proposed in JCTVC-C206. The method was then improved by a series of simplification, including JCTVC-F0233/10178 which reduces α precision n_{α} from 13 to 7, JCTVC-10151 which reduces the maximum multiplier bitwidth, and JCTVC-H0490/I0166 which reduces division LUT entries from 64 to 32, finally leads to the ECM LMS version.

### Basic Algorithm

As discussed in equation (1), the integerization design utilizes the linear relationship to modelize the correlation of luma signal and chroma signal. The chroma values are predicted from reconstructed luma values of collocated block.

Luma and chroma components have different sampling ratios in YUV420 sampling. The sampling ratio of chroma components is half of that of luma component and has 0.5 pixel phase difference in vertical direction. Reconstructed luma needs down-sampling in vertical direction and subsample in horizontal direction to match size of chroma signal. For example, the down-sampling may be implemented by:

$${Rec}_{L}^{′} ( i , j ) = ( {rec}_{L} ( 2 i , 2 j ) + {rec}_{L} ( 2 i , 2 j + 1 ) ) ≫ 1 \qquad ( 10 )$$

### Integer Implementation

Float point operation is necessary in equation (8) to calculate linear model parameters α to keep high data accuracy. And float point multiplication is involved in equation (1) when α is represented by float point value. In this section, the integer implementation of this algorithm is designed. Specifically, fractional part of parameter α is quantized with n_{α} bits data accuracy. Parameter α value is represented by an up-scaled and rounded integer value α′ and a′=a×(1<<n_{α}). Then the linear model of equation (1) is changed to:

$${pred}_{C} [ x , y ] = ( {α}^{′} \cdot {Rec}_{L}^{′} [ x , y ] ≫ {n}_{α} ) + {β}^{′} \qquad ( 11 )$$

Where β′ is the rounding value of float point β and α′ can be calculated as follows.

$${α}^{′} = a \cdot ( 1 ≪ {n}_{α} ) = \frac{{A}_{1}}{{A}_{2}} \cdot ( 1 ≪ {n}_{α} ) \qquad ( 12 )$$

It is proposed to replace division operation of equation (12) by table lookup and multiplication. A₂ is firstly de-scaled to reduce the table size. A₁ is also de-scaled to avoid product overflow. Then, in A₂ it is kept only most significant bits defined by n_{A}_{₂} value and others bits are put to zero. The approximate value A₂′ can be calculated as:

$${A}_{2}^{′} = [ {A}_{2} ≫ {r}_{{A}_{2}} ] \cdot {2}^{{r}_{{A}_{2}}} \qquad ( 13 )$$

Where [ . . . ] means rounding operation and r_{A}_{₂} can be calculated as:

$${r}_{{A}_{2}} = max ( bdepth ( {A}_{2} ) - {n}_{{A}_{2}} , 0 )$$

Where bdepth(A₂) means bit depth of value A₂.

Same operation is done for A₁, as follows:

$${A}_{1}^{′} = [ {A}_{1} ≫ {r}_{{A}_{1}} ] \cdot {2}^{{r}_{{A}_{1}}} \qquad ( 14 )$$

$${r}_{{A}_{1}} = max ( bdepth ( {A}_{1} ) - {n}_{{A}_{1}} , 0 )$$

Taking into account quantized representation of A₁ and A₂, equation (12) can be re-written as following.

$${α}^{′} \approx \frac{[ {A}_{1} ≫ {r}_{{A}_{1}} ] \cdot {2}^{{r}_{{A}_{1}}}}{[ {A}_{2} ≫ {r}_{{A}_{2}} ] \cdot {2}^{{r}_{{A}_{2}}}} \cdot {2}^{{n}_{α}} = \frac{{2}^{{n}_{table}} \cdot [ {A}_{1} ≫ {r}_{{A}_{1}} ] \cdot \text{?}}{[ {A}_{2} ≫ {r}_{{A}_{2}} ] \cdot {2}^{{r}_{{A}_{2}} + {n}_{table}}} \approx [ \frac{{2}^{{n}_{table}}}{{A}_{2} ≫ {r}_{{A}_{2}}} ] \cdot [ {A}_{1} ≫ {r}_{{A}_{1}} ] \cdot \text{?} \qquad ( 15 )$$

$$\text{?} \text{indicates text missing or illegible when filed}$$

### Where

$$[ \frac{{2}^{n} table}{{A}_{2} ≫ {r}_{{A}_{2}}} ]$$

is represented as lookup table with length of 2^{nA2} to avoid the division.

In the simulation, the constant parameters are set as:
n_{α} equals to 13, which value is tradeoff between data accuracy and computational cost.
n_{A}_{₂} equals to 6, results in lookup table size as 64, table size can be further reduced to 32 by up-scaling A₂ when bdepth(A₂)<6 (e.g. A₂<32).
n_{table} equals to 15, results in 16 bits data representation of table elements.
n_{A}_{₁} is set as 15, to avoid product overflow and keep 16 bits multiplication.

In final, α′ is clipped to [−2⁻¹⁵, 2¹⁵−1], to remain 16 bits multiplication in equation (11). With this clipping, the actual a value is limited to −4,4) when n_{α} equals to 13, which is useful to prevent the error amplification.

With calculated parameter α′, parameter β′ is calculated as follows:

$${β}^{′} = \frac{{\sum }_{i = 0}^{I} {Rec}_{C} ( i ) - ( {α}^{′} \cdot ( {\sum }_{i = 0}^{I} {Rec}_{L}^{′} ( i ) ) ≫ {n}_{α} )}{I} \qquad ( 16 )$$

Wherein the division of above equation can be simply replaced by shift, since value I is power of 2.

### JCTVC-10166: Simplified Parameter Calculation

Similar as discussed above with regard to equation (1), in HM6.0, an intra prediction mode called LM is applied to predict chroma PU based on a linear model using the reconstruction of the collocated luma PU. The parameters of the linear model consist of slope (a>>k) and y-intercept (b), which are derived from the neighboring luma and chroma pixels using the least mean square solution. The values of the prediction samples predSamples[x,y], with x,y=0 . . . nS−1, where nS specifies the block size of the current chroma PU, are derived as follows:

$$predSamples [ x , y ] = Clip {1}_{C} ( ( ( {p}_{Y}^{′} [ x , y ] * a ) ≫ k ) + b ) , \qquad ( 17 )$$

$$with x , y = 0 … nS - 1$$

where P_{Y}′[x,y] is the reconstructed pixels from the corresponding luma component. When the coordinates x and y are equal to or larger than 0, P_{Y}′ is the reconstructed pixel from the co-located luma PU. When x or y is less than 0, P_{Y}′ is the reconstructed neighboring pixel of the co-located luma PU.

Some intermediate variables in the derivation process, L, C, LL, LC, k2 and k3, are derived as:

$$L = ( {\sum }_{y = 0}^{nS - 1} {p}_{Y}^{′} [ - 1 , y ] + {\sum }_{y = 0}^{nS - 1} {p}_{Y}^{′} [ x , - 1 ] ) ≫ k 3 \qquad ( 18 - 1 )$$

$$C = ( {\sum }_{y = 0}^{nS - 1} p [ - 1 , y ] + {\sum }_{x = 0}^{nS - 1} p [ x , - 1 ] ) ≫ k 3 \qquad ( 18 - 2 )$$

$$LL = ( {\sum }_{y = 0}^{nS - 1} {{p}_{Y}^{′} [ - 1 , y ]}^{2} + {\sum }_{x = 0}^{nS - 1} {{p}_{Y}^{′} [ x , - 1 ]}^{2} ) ≫ k 3 \qquad ( 18 - 3 )$$

$$( 18 - 4 )$$

$$LC = ( {\sum }_{y = 0}^{nS - 1} {p}_{Y}^{′} [ - 1 , y ] * p [ - 1 , y ] + {\sum }_{y = 0}^{nS - 1} {p}_{Y}^{′} [ x , - 1 ] * p [ x , - 1 ] ) ≫ k 3$$

$$k 2 = Log 2 ( ( 2 * nS ) ≫ k 3 ) \qquad ( 18 - 5 )$$

$$k 3 = Max ( 0 , {BitDepth}_{C} + Log 2 ( nS ) - 14 ) \qquad ( 18 - 6 )$$

Therefore, variables a, b and k can be derived as:

$$a 1 = ( LC ≪ k 2 ) - L * C \qquad ( 19 - 1 )$$

$$a 2 = ( LL ≪ k 2 ) - L * L \qquad ( 19 - 2 )$$

$$k 1 = Max ( 0 , Log 2 ( abs ( a 2 ) ) - 5 ) - Max ( 0 , Log 2 ( abs ( a 1 ) ) - 14 ) + 2 \qquad ( 19 - 3 )$$

$$a 1 s = a 1 ≫ Max ( 0 , Log 2 ( abs ( a 1 ) ) - 14 ) \qquad ( 19 - 4 )$$

$$a 2 s = abs ( a 2 ≫ Max ( 0 , Log 2 ( abs ( a 2 ) ) - 5 ) ) \qquad ( 19 - 5 )$$

$$a 3 = a 2 s < 1 ? 0 : Clip 3 ( - {2}^{15} , {2}^{15} - 1 , a 1 s * lmDiv + ( 1 ≪ ( k 1 - 1 ) ) ≫ k 1 ) \qquad ( 19 - 6 )$$

$$a = a 3 ≫ Max ( 0 , Log 2 ( abs ( a 3 ) ) - 6 ) \qquad ( 19 - 7 )$$

$$k = 13 - Max ( 0 , Log 2 ( abs ( a ) ) - 6 ) \qquad ( 19 - 8 )$$

$$b = ( L - ( ( a * C ) ≫ k 1 ) + ( 1 ≪ ( k 2 - 1 ) ) ) k 2 , \qquad ( 19 - 9 )$$

where lmDiv is specified in a 63-entry look-up table, i.e. Table 3, which is online generated by:

$$lmDiv ( a 2 s ) = ( ( 1 ≪ 15 ) + a 2 s / 2 ) a 2 s . \qquad ( 20 )$$

TABLE 3
Specification of lmDiv

| a2s | 1 | 2 | 3 | 4 | 5 | 6 | 7 | 8 | 9 | 10 | 11 | 12 | 13 |
|---|---|---|---|---|---|---|---|---|---|---|---|---|---|
| lmDiv | 32768 | 16384 | 10923 | 8192 | 6554 | 5461 | 4681 | 4096 | 3641 | 3277 | 2979 | 2731 | 2521 |

| a2s | 14 | 15 | 16 | 17 | 18 | 19 | 20 | 21 | 22 | 23 | 24 | 25 | 26 |
|---|---|---|---|---|---|---|---|---|---|---|---|---|---|
| lmDiv | 2341 | 2185 | 2048 | 1928 | 1820 | 1725 | 1638 | 1560 | 1489 | 1425 | 1365 | 1311 | 1260 |
| a2s | 27 | 28 | 29 | 30 | 31 | 32 | 33 | 34 | 35 | 36 | 37 | 38 | 39 |
| lmDiv | 1214 | 1170 | 1130 | 1092 | 1057 | 1024 | 993 | 964 | 936 | 910 | 886 | 862 | 840 |
| a2s | 40 | 41 | 42 | 43 | 44 | 45 | 46 | 47 | 48 | 49 | 50 | 51 | 52 |
| lmDiv | 819 | 799 | 780 | 762 | 745 | 728 | 712 | 697 | 683 | 669 | 655 | 643 | 630 |

| a2s | 53 | 54 | 55 | 56 | 57 | 58 | 59 | 60 | 61 | 62 | 63 | 64 |
|---|---|---|---|---|---|---|---|---|---|---|---|---|
| lmDiv | 618 | 607 | 596 | 585 | 575 | 565 | 555 | 546 | 537 | 529 | 520 | 512 |

In Equation (19-6), a1s is a 16-bit signed integer and lmDiv is a 16-bit unsigned integer. Therefore, 16-bit multiplier and 16-bit storage are needed. It is proposed to reduce the bit depth of multipliers to the internal bit depth, as well as the size of the look-up table, as detailed below.

### Reduced Bit Depth of Multipliers

The bit depth of a1s is reduced to the internal bit depth by changing equation (19-4) as:

$$a 1 s = a 1 ≫ Max ( 0 , Log 2 ( abs ( a 1 ) ) - ( {BitDepth}_{C} - 2 ) ) . \qquad ( 21 )$$

The values of lmDiv with the internal bit depth are achieved with the following equation (22) and stored in the look-up table:

$$lmDiv ( a 2 s ) = ( ( 1 ≪ ( {BitDepth}_{C} - 1 ) ) + a 2 s / 2 ) / a 2 s . \qquad ( 22 )$$

Table 4 shows the example of internal bit depth 10.

TABLE 4
Specification of lmDiv with the internal bit depth equal to 10

| a2s | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| lmDiv | 512 | 256 | 171 | 128 | 102 | 85 | 73 | 64 | 57 | 51 | 47 | 43 | 39 | 37 | 34 | 32 |

| a2s | 17 | 18 | 19 | 20 | 21 | 22 | 23 | 24 | 25 | 26 | 27 | 28 | 29 | 30 | 31 | 32 |
|---|---|---|---|---|---|---|---|---|---|---|---|---|---|---|---|---|
| lmDiv | 30 | 28 | 27 | 26 | 24 | 23 | 22 | 21 | 20 | 20 | 19 | 18 | 18 | 17 | 17 | 16 |
| a2s | 33 | 34 | 35 | 36 | 37 | 38 | 39 | 40 | 41 | 42 | 43 | 44 | 45 | 46 | 47 | 48 |
| lmDiv | 16 | 15 | 15 | 14 | 14 | 13 | 13 | 13 | 12 | 12 | 12 | 12 | 11 | 11 | 11 | 11 |

| a2s | 49 | 50 | 51 | 52 | 53 | 54 | 55 | 56 | 57 | 58 | 59 | 60 | 61 | 62 | 63 |
|---|---|---|---|---|---|---|---|---|---|---|---|---|---|---|---|
| lmDiv | 10 | 10 | 10 | 10 | 10 | 9 | 9 | 9 | 9 | 9 | 9 | 9 | 8 | 8 | 8 |

Modifications are also made to Equation (19-3) and (19-8) as below:

$$k 1 = Max ( 0 , Log 2 ( abs ( a 2 ) ) - 5 ) - Max ( 0 , Log 2 ( abs ( a 1 ) ) - ( {BitDepth}_{C} - 2 ) ) , \qquad ( 23 - 1 )$$

$$k = {BitDepth}_{C} - 1 - Max ( 0 , Log 2 ( abs ( a ) ) - 6 ) . \qquad ( 23 - 2 )$$

### Reduced Entries of the Look-Up Table

It is also proposed to reduce the entries from 63 to 32, and the bits for each entry from 16 to 10, as shown in Table 5. By doing this, almost 70% memory saving can be achieved. The corresponding changes for equation (19-6), equation (20) and equation (19-8) are as follows:

$$a 3 = a 2 s < 32 ? 0 : Clip 3 ( - {2}^{15} , {2}^{15} - 1 , a 1 s * lmDiv + ( 1 ≪ ( k 1 - 1 ) ) ≫ k 1 ) \qquad ( 24 - 1 )$$

$$lmDiv ( a 2 s ) = ( ( 1 ≪ ( {BitDepth}_{C} + 4 ) ) + a 2 s / 2 ) a 2 s \qquad ( 24 - 2 )$$

$$k = {BitDepth}_{C} + 4 - Max ( 0 , Log 2 ( abs ( a ) ) - 6 ) . \qquad ( 24 - 3 )$$

TABLE 5
Specification of lmDiv with the internal bit depth equal to 10

| a2s | 32 | 33 | 34 | 35 | 36 | 37 | 38 | 39 | 40 | 41 | 42 | 43 | 44 | 45 | 46 | 47 |
|---|---|---|---|---|---|---|---|---|---|---|---|---|---|---|---|---|
| lmDiv | 512 | 496 | 482 | 468 | 455 | 443 | 431 | 420 | 410 | 400 | 390 | 381 | 372 | 364 | 356 | 349 |
| a2s | 48 | 49 | 50 | 51 | 52 | 53 | 54 | 55 | 56 | 57 | 58 | 59 | 60 | 61 | 62 | 63 |
| lmDiv | 341 | 334 | 328 | 321 | 315 | 309 | 303 | 298 | 293 | 287 | 282 | 278 | 273 | 269 | 264 | 260 |

### Multi-Model Linear Model Prediction

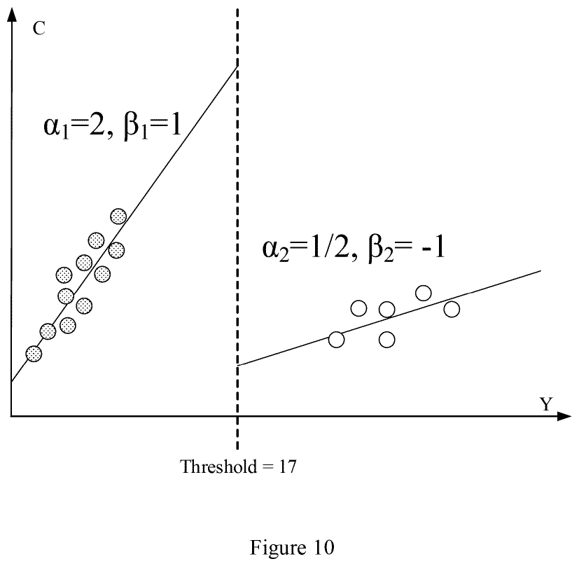

In ECM-1.0, Multi-model LM (MMLM) prediction mode is proposed, for which the chroma samples are predicted based on the reconstructed luma samples of the same CU by using two linear models as follows:

$$\{ \begin{matrix}{pred}_{C} ( i , j ) = {α}_{1} \cdot {rec}_{L}^{′} ( i , j ) + {β}_{1} if {rec}_{L}^{′} ( i , j ) \leq Threshold \\ {pred}_{C} ( i , j ) = {α}_{2} \cdot {rec}_{L}^{′} ( i , j ) + {β}_{2} if {rec}_{L}^{′} ( i , j ) > Threshold\end{matrix} \qquad ( 25 )$$

where pred_{C}(i, j) represents the predicted chroma samples in a CU and rec_{L}′(i, j) represents the down-sampled reconstructed luma samples of the same CU. Threshold is calculated as the average value of the neighboring reconstructed luma samples. FIG. 10 illustrates an example of classifying the neighboring samples into two groups based on the value Threshold. For each group, parameter αᵢ and βᵢ, with i equal to 1 and 2 respectively, are derived from the straight-line relationship between luma values and chroma values from two samples, which are minimum luma sample A (X_{A}, Y_{A}) and maximum luma sample B (X_{B}, Y_{B}) inside the group. Here X_{A}, Y_{A} are the x-coordinate (i.e., luma value) and y-coordinate (i.e., chroma value) value for sample A, and X_{B}, Y_{B} are the x-coordinate and y-coordinate value for sample B. The linear model parameters α and β are obtained according to the following equations.

$$α = \frac{{y}_{B} - {y}_{A}}{{x}_{B} - {x}_{A}} \qquad ( 26 )$$

$$β = {y}_{A} - α {x}_{A}$$

Such a method is also called min-max method. The division in the equation above could be avoided and replaced by a multiplication and a shift.

For a coding block with a square shape, the above two equations are applied directly. For a non-square coding block, the neighboring samples of the longer boundary are first subsampled to have the same number of samples as for the shorter boundary.

Besides the scenario wherein the above template and the left template are used together to calculate the linear model coefficients, the two templates also can be used alternatively in the other two MMLM modes, called MMLM_A, and MMLM_L modes.

In MMLM_A mode, only pixel samples in the above template are used to calculate the linear model coefficients. To get more samples, the above template is extended to the size of (W+W). In MMLM_L mode, only pixel samples in the left template are used to calculate the linear model coefficients. To get more samples, the left template is extended to the size of (H+H).

Note that when the upper reference line is at the CTU boundary, only one luma row (which is stored in line buffer for intra prediction) is used to make the down-sampled luma samples.

For chroma intra mode coding, a total of 11 intra modes are allowed for chroma intra mode coding. Those modes include five traditional intra modes and six cross-component linear model modes (CCLM, LM_A, LM_L, MMLM, MMLM_A and MMLM_L). Chroma mode signaling and derivation process are shown in Table 6. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 6
Derivation of chroma prediction mode
from luma mode when MMLM_is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 81 | 81 | 81 | 81 | 81 |
| 5 | 82 | 82 | 82 | 82 | 82 |
| 6 | 83 | 83 | 83 | 83 | 83 |
| 7 | 84 | 84 | 84 | 84 | 84 |
| 8 | 85 | 85 | 85 | 85 | 85 |
| 9 | 86 | 86 | 86 | 86 | 86 |
| 10 | 0 | 50 | 18 | 1 | X |

### Adaptive Enabling of LM and MMLM for Prediction

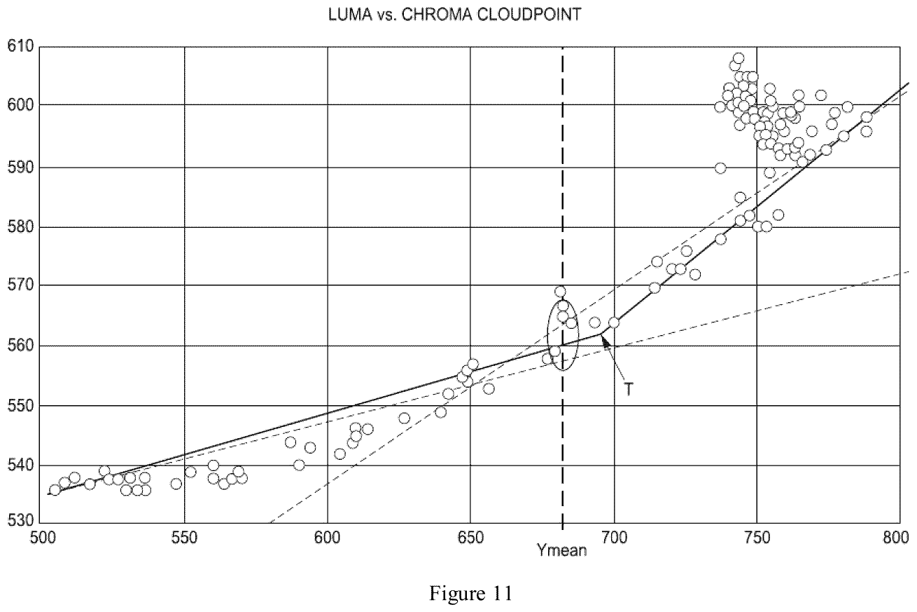

MMLM and LM modes may also be used together in an adaptive manner. For MMLM, two linear models are as follows:

$$\{ \begin{matrix}{pred}_{C} ( i , j ) = {α}_{1} \cdot {rec}_{L}^{′} ( i , j ) + {β}_{1} if {rec}_{L}^{′} ( i , j ) \leq Threshold \\ {pred}_{C} ( i , j ) = {α}_{2} \cdot {rec}_{L}^{′} ( i , j ) + {β}_{2} if {rec}_{L}^{′} ( i , j ) > Threshold\end{matrix} \qquad ( 27 )$$

where pred_{C}(i, j) represents the predicted chroma samples in a CU and rec_{L}′(i, j) represents the down-sampled reconstructed luma samples of the same CU. Threshold can be simply determined based on the luma and chroma average values together with their minimum and maximum values. FIG. 11 shows an example of classifying the neighboring samples into two groups based on the knee point, T, indicated by an arrow. Linear model parameter α₁ and β₁ are derived from the straight-line relationship between luma values and chroma values from two samples, which are minimum luma sample A (X_{A}, Y_{A}) and the Threshold (X_{T}, Y_{T}). Linear model parameter α₂ and β₂ are derived from the straight-line relationship between luma values and chroma values from two samples, which are maximum luma sample B (X_{B}, Y_{B}) and the Threshold (X_{T}, Y_{T}). Here X_{A}, Y_{A} are the x-coordinate (i.e., luma value) and y-coordinate (i.e., chroma value) value for sample A, and X_{B}, Y_{B} are the x-coordinate and y-coordinate value for sample B. The linear model parameters αᵢ and βᵢ for each group, with i equal to 1 and 2 respectively, are obtained according to the following equations.

$$\begin{matrix}{α}_{1} = \frac{{Y}_{T} - {Y}_{A}}{{X}_{T} - {X}_{A}} \\ {β}_{1} = {Y}_{A} - {α}_{1} {X}_{A} \\ {α}_{2} = \frac{{Y}_{B} - {Y}_{T}}{{X}_{B} - {X}_{T}} \\ {β}_{2} = {Y}_{T} - {α}_{2} {X}_{T}\end{matrix} \qquad ( 28 )$$

For a coding block with a square shape, the above equations are applied directly. For a non-square coding block, the neighboring samples of the longer boundary are first subsampled to have the same number of samples as for the shorter boundary.

Besides the scenario wherein the above template and the left template are used together to determine the linear model coefficients, the two templates also can be used alternatively in the other two MMLM modes, called MMLM_A, and MMLM_L modes respectively.

In MMLM_A mode, only pixel samples in the above template are used to calculate the linear model coefficients. To get more samples, the above template is extended to the size of (W+W). In MMLM_L mode, only pixel samples in the left template are used to calculate the linear model coefficients. To get more samples, the left template is extended to the size of (H+H).

Note that when the upper reference line is at the CTU boundary, only one luma row (which is stored in line buffer for intra prediction) is used to make the down-sampled luma samples.

For chroma intra mode coding, there is a condition check used to select LM modes (CCLM, LM_A, and LM_L) or multi-model LM modes (MMLM, MMLM_A, and MMLM_L). The condition check is as follows:

$$\{ \begin{matrix}LM modes if ( ( ( {Y}_{T} - {Y}_{A} ) \leq d ‖ ( {Y}_{B} - {Y}_{T} ) \leq d \& ( block area \geq {BlkSizeThres}_{LM} ) ) ) \\ MMLM modes if ( ( ( {Y}_{T} - {Y}_{A} ) > d \&\& ( {Y}_{B} - {Y}_{T} ) > d ) \& ( ( block area \geq {BloSizeThres}_{MM} ) ) )\end{matrix} \qquad ( 29 )$$

where BlkSizeThres_{LM} represents the smallest block size of LM modes and BlkSizeThres_{MM} represents the smallest block size of MMLM modes. The symbol d represents a pre-determined threshold value. In one example, d may take a value of 0. In another example, d may take a value of 8.

For chroma intra mode coding, a total of 8 intra modes are allowed for chroma intra mode coding. Those modes include five traditional intra modes and three cross-component linear model modes. Chroma mode signaling and derivation process are shown in Table 1. It is worth noting that for a given CU, if it is coded under linear model mode, whether it is a conventional single model LM mode or a MMLM mode is determined based on the condition check above. Unlike the case shown in Table 6, there are no separate MMLM modes to be signaled. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

### Slope Adjustment for CCLM

During ECM development, scale (slope) adjustment for CCLM are proposed as further improvements, for example, as described in JVET-Y0055/Z0049.

As discussed above, CCLM uses a model with 2 parameters to map luma values to chroma values. The scale parameter “a” and the bias parameter “b” define the mapping as follows:

$$chromaVal = a * lumaVal + b \qquad ( 30 )$$

It is proposed to signal an adjustment “u” to the scale parameter to update the model to the following form:

$$chromaVal = {a}^{′} * lumaVal + {b}^{′} \qquad ( 31 )$$

where a′=a+u, and b′=b−u*yᵣ.

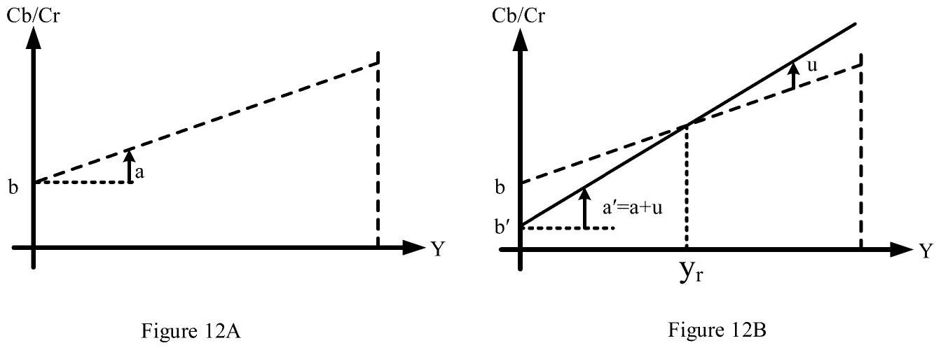

With this selection, the mapping function is tilted or rotated around the point with luminance value yᵣ. It is proposed to use the average of the reference luma samples used in the model creation as yᵣ in order to provide a meaningful modification to the model. FIGS. 12A to 12B illustrate the effect of the scale adjustment parameter “u”, wherein FIG. 12A illustrates the model created without the scale adjustment parameter “u”, and FIG. 12B illustrates the model created with the scale adjustment parameter “u”.

In one example, the scale adjustment parameter is provided as an integer between −4 and 4, inclusive, and signaled in the bitstream. The unit of the scale adjustment parameter is ⅛th of a chroma sample value per one luma sample value (for 10-bit content).

In one example, adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When scale adjustment is applied for a multimode CCLM model, both models can be adjusted and thus up to two scale updates are signaled for a single chroma block.

To enable the scale adjustment at the encoder, the encoder may perform an SATD based search for the best value of the scale update for Cr and a similar SATD based search for Cb. If either one results as a non-zero scale adjustment parameter, the combined scale adjustment pair (SATD based update for Cr, SATD based update for Cb) is included in the list of RD checks for the TU.

### The Fusion of Chroma Intra Prediction Modes

During ECM development, JVET-Y0092/Z0051 proposed fusion of chroma intra modes.

The intra prediction modes enabled for the chroma components in ECM-4.0 are six cross-component linear model (LM) modes including CCLM_LT, CCLM_L, CCLM_T, MMLM_LT, MMLM_L and MMLM_T modes, the direct mode (DM), and four default chroma intra prediction modes. The four default modes are given by the list {0, 50, 18, 1} and if the DM mode already belongs to that list, the mode in the list will be replaced with mode 66.

A decoder-side intra mode derivation (DIMD) method for luma intra prediction is included in ECM-4.0. First, a horizontal gradient and a vertical gradient are calculated for each reconstructed luma sample of the L-shaped template of the second neighboring row and column of the current block to build a Histogram of Gradients (HoG). Then, the two intra prediction modes with the largest and the second largest histogram amplitude values are blended with the Planar mode to generate the final predictor of the current luma block.

In order to improve the coding efficiency of chroma intra prediction, two methods are proposed, including a decoder-side derived chroma intra prediction mode (DIMD chroma) and a fusion of a non-LM mode and the MMLM_LT mode.

### Dimd Chroma Mode

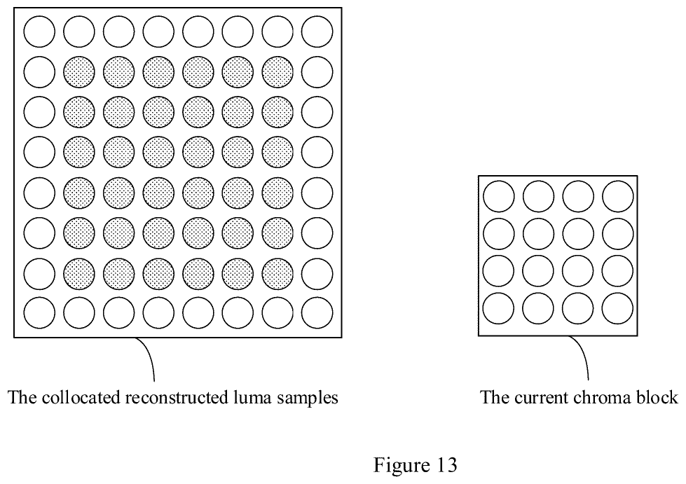

In a first embodiment, a DIMD chroma mode is proposed. The proposed DIMD chroma mode uses the DIMD derivation method to derive the chroma intra prediction mode of the current block based on the collocated reconstructed luma samples. Specifically, a horizontal gradient and a vertical gradient are calculated for each collocated reconstructed luma sample of the current chroma block to build a HoG, as shown in FIG. 13. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode.

A CU level flag is signaled to indicate whether the proposed DIMD chroma mode is applied as shown in Table 7.

TABLE 7
The binarization process for
intra_chroma_pred_mode in the proposed method

| intra_chroma_pred_mode | bin string | chroma intra mode |
|---|---|---|
| 0 | 1100 | list[0] |
| 1 | 1101 | list[1] |
| 2 | 1110 | list[2] |
| 3 | 1111 | list[3] |
| 4 | 10 | DIMD chroma |
| 5 | 0 | DM |

### Fusion of Chroma Intra Prediction Modes

In a second embodiment, a fusion of chroma intra prediction modes is proposed, wherein the DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. And the proposed fusion is only applied to I slices.

### Combination of DIMD Chroma Mode and Fusion of Chroma Intra Prediction Modes

In a third embodiment, the DIMD chroma mode and the fusion of chroma intra prediction modes are combined. Specifically, the DIMD chroma mode described in the first embodiment is applied, and for I slices, the DM mode, the four default modes and the DIMD chroma mode can be fused with the MMLM_LT mode using the weights described in the second embodiment, while for non-I slices, only the DIMD chroma mode can be fused with the MMLM_LT mode using equal weights.

Combination of DIMD Chroma Mode with Reduced Processing and Fusion of Chroma Intra Prediction Modes

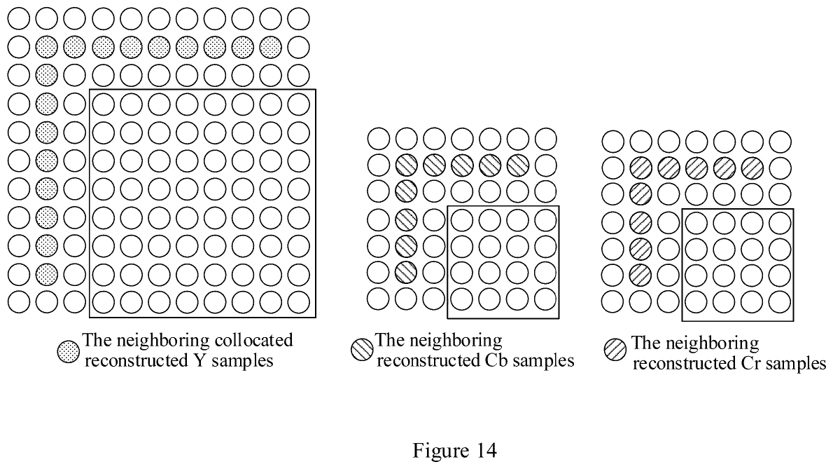

In a fourth embodiment, the DIMD chroma mode with reduced processing and the fusion of chroma intra prediction modes are combined. Specifically, the DIMD chroma mode with reduced processing derives the intra mode based on the neighboring reconstructed Y, Cb and Cr samples in the second neighboring row and column as shown in FIG. 14. Other parts are the same as the third embodiment.

### Decoder Side Intra Mode Derivation (DIMD)

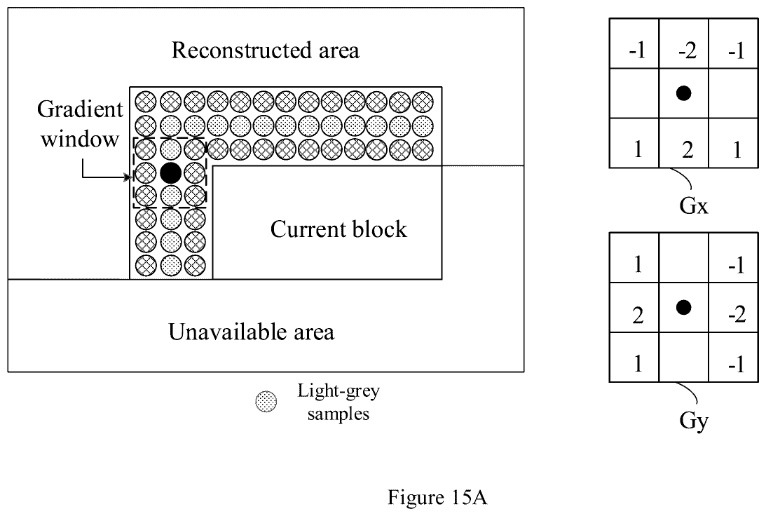

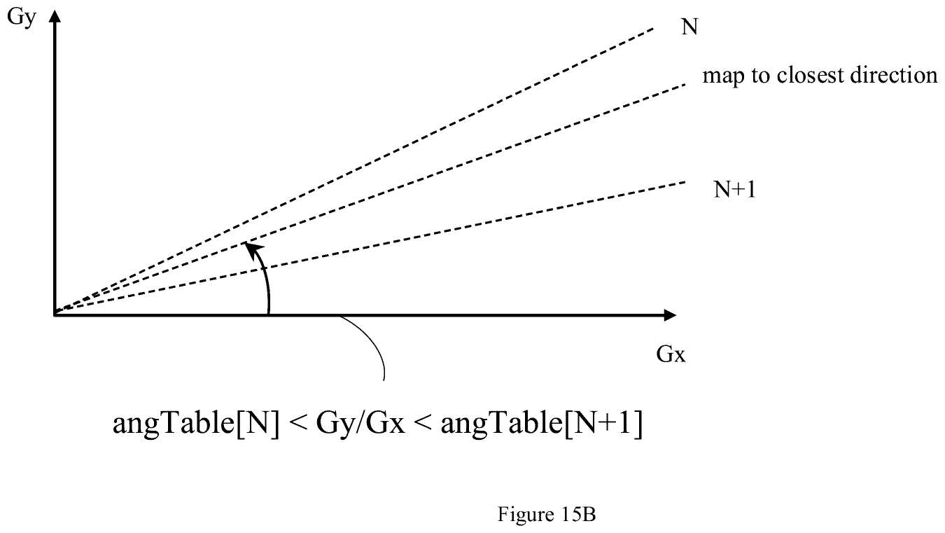

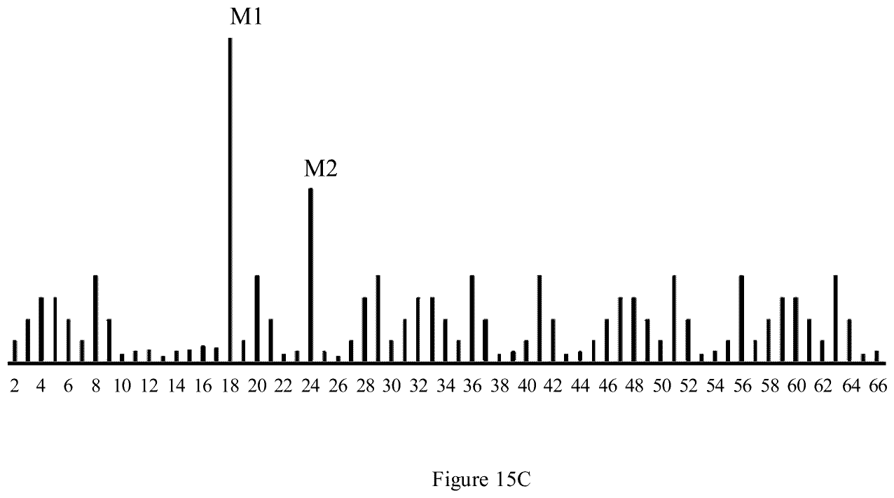

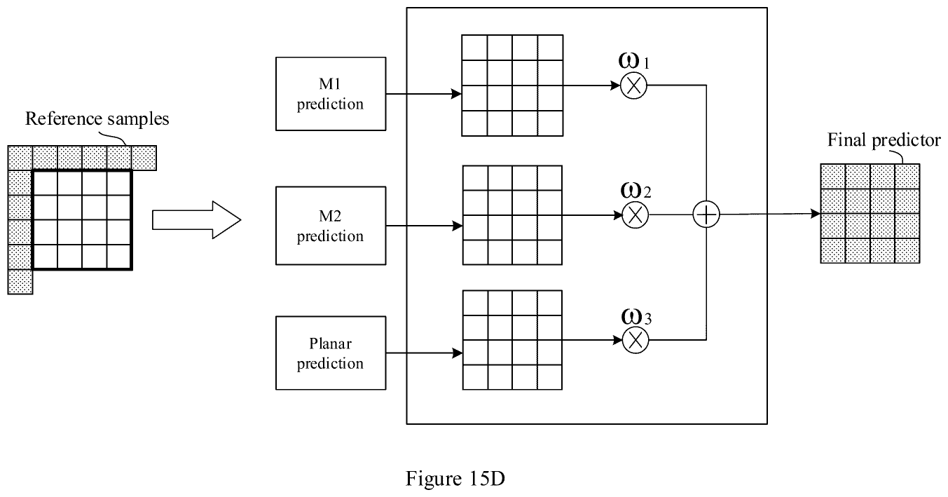

In one embodiment, when DIMD is applied, two intra modes are derived from the reconstructed neighbor samples, and those two predictors are combined with the planar mode predictor with the weights derived from the gradients as described in JVET-O0449, as shown in FIGS. 15A to 15D. The division operations in weight derivation is performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

FIGS. 15A to 15D illustrate the steps of decoder-side intra mode derivation, wherein intra prediction direction is estimated without intra mode signaling. The first step as shown in FIG. 15A includes estimating gradient per sample (for light-grey samples as illustrated in FIG. 15A). The second step as shown in FIG. 15B includes mapping gradient values to closest prediction direction within [2,66]. The third step as shown in FIG. 15C includes selecting 2 prediction directions, wherein for each prediction direction, all absolute gradients Gx and Gy of neighboring pixels with that direction are summed up, and top 2 directions are selected. The fourth step as shown in FIG. 15D includes enabling weighted intra prediction with the selected directions.

### Multiple Reference Line (MRL) Intra Prediction

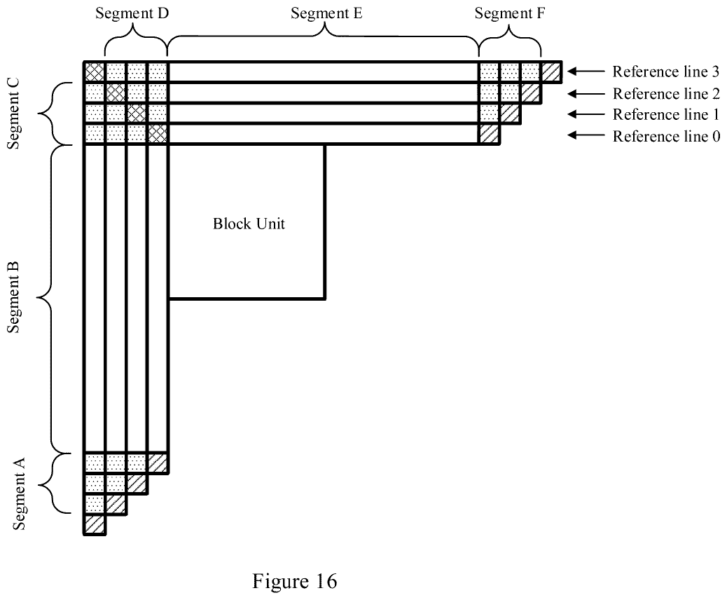

Multiple reference line (MRL) intra prediction uses more reference lines for intra prediction. In FIG. 16, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signaled and used to generate intra predictor. For reference line idx, which is greater than 0, only include additional reference line modes in MPM list and only signal mpm index without remaining mode. The reference line index is signaled before intra prediction modes, and Planar mode is excluded from intra prediction modes in case a nonzero reference line index is signaled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its down-sampling filters. The definition of MRL to use the same 3 lines is aligned as CCLM to reduce the storage requirements for decoders.

### Convolutional Cross-Component Model (CCCM) for Intra Prediction

During ECM development, a convolutional cross-component model (CCCM) of chroma intra modes is proposed.

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Convolutional Filter

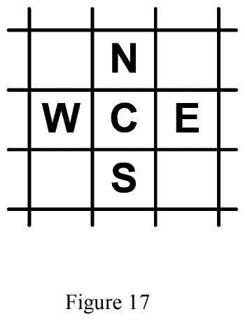

The proposed convolutional 7-tap filter consists of a 5-tap plus sign shape spatial component, a non-linear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 17.

The non-linear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

### Calculation of Filter Coefficients

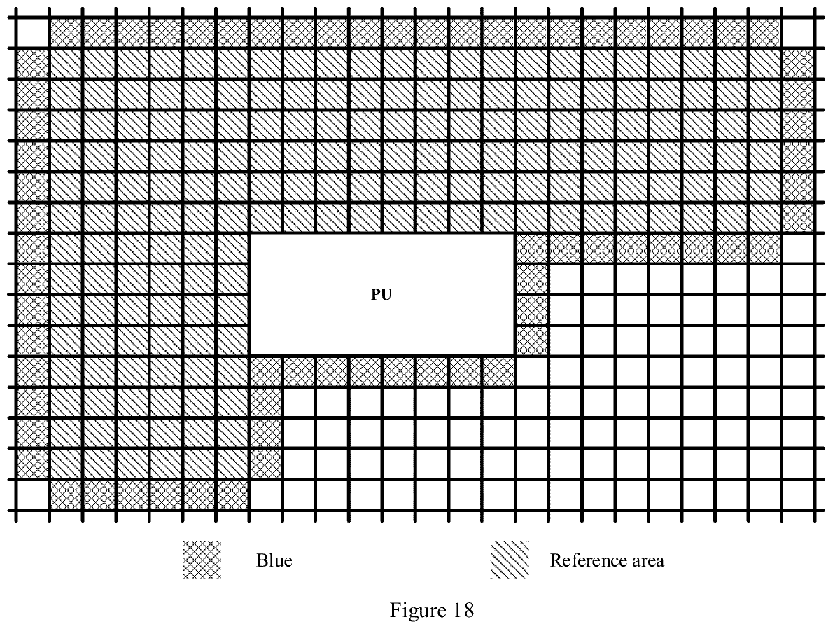

The filter coefficients cᵢ are calculated by minimizing MSE between predicted and reconstructed chroma samples in the reference area. FIG. 18 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

### Bitstream Signalling

Usage of the mode is signaled with a CABAC coded PU level flag. One new CABAC context was included to support this. When it comes to signaling, CCCM is considered a sub-mode of CCLM. That is, the CCCM flag is only signaled if intra prediction mode is LM_CHROMA_IDX (to enable single mode CCCM) or MMLM_CHROMA_IDX (to enable multi-model CCCM).

### Encoder Operation

The encoder performs two new RD checks in the chroma prediction mode loop, one for checking single model CCCM mode and one for checking multi-model CCCM mode.

### Division-Free Operation and Dynamic Range Reduction for Convolutional Cross-Component Model (CCCM)

### Removal of the Offset

In original CCCM, the autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values for the sample above and to the left of the top-left sample of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}{C}^{′} = C - offsetLuma ; \\ {N}^{′} = N - offsetLuma ; \\ {S}^{′} = S - offsetLuma ; \\ {E}^{′} = E - offsetLuma ; \\ {W}^{′} = W - offsetLuma ; \\ {P}^{′} = non - linear ( {C}^{′} ) ; \\ B = midValue = 1 ≪ ( bitDepth - 1 ) ;\end{matrix}$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset is added to the bias term of the convolutional model. With this selection the convolution operation also takes exactly the same amount of operations as the ECM6 implementation of CCCM.

### Removal of the Division Operations

The process of CCCM model parameter calculation requires division operations. In the original CCCM proposal integer division was used, but such division operations are not always considered implementation friendly. It is proposed to replace division operation with multiplication (with a scale factor) and shift operation, where the scale factor and number of shifts are calculated based on denominator. The general approach is similar to what is already used in ECM e.g. in calculation of the CCLM parameters, but as the range of numbers is larger in the case of the 7-parameter CCCM model, the ECM approximation was found to result in significant loss of coding efficiency.

The proposed process is as follows. First, the number of shifts is calculated using log 2 of denominator. Then denominator is normalized to a range of 1.0 and 2.0 by applying the shift operation. Then the fractional part (with 14-bit precision) of the normalized denominator is used to calculate the scale factor. The calculation of scale factor is performed by 8-piece polynomial (power of 2) model. The parameters of polynomial model in different pieces are selected to reduce the dynamic range of the calculation and minimize the truncation error of polynomial coefficients. For example, the coefficient of power of 1 term is always 0.5 which can be implemented by shift operation and there is no need to store the corresponding value in a table.

The proposed division free process can be summarized as below:

// result = num / denum = (num * scale) >> shift
// pow2W[8], pow2O[8], pow2B[8] = parameters of polynomial models

| | |
|---|---|
| shift | = floorLog2_uint64(denom) |
| normDenom | = ((denom << 14) >> shift) & ((1 << 14) − 1) |
| region | = normDenom >> (14 − 3) |

normDenom2 = normDenom − pow2O[region]

| | |
|---|---|
| scale | = (pow2W[region] * normDenom2\hat{ }2) − (normDenom2 >> 1) + |

pow2B[region]

| | |
|---|---|
| result | = (num * scale) >> shift |

In the existing CCLM or MMLM design, the neighboring reconstructed luma-chroma sample pairs are classified into one or more sample groups based on the value Threshold, which only considers the luma DC values. That is, a luma-chroma sample pair is classified by only considering the intensity of the luma sample. However, luma component usually preserves abundant textures, and the current luma sample may be highly correlated with neighboring luma samples, such inter-sample correlation (AC correlation) may benefit the classification of luma-chroma sample pairs and can bring additional coding efficiency.

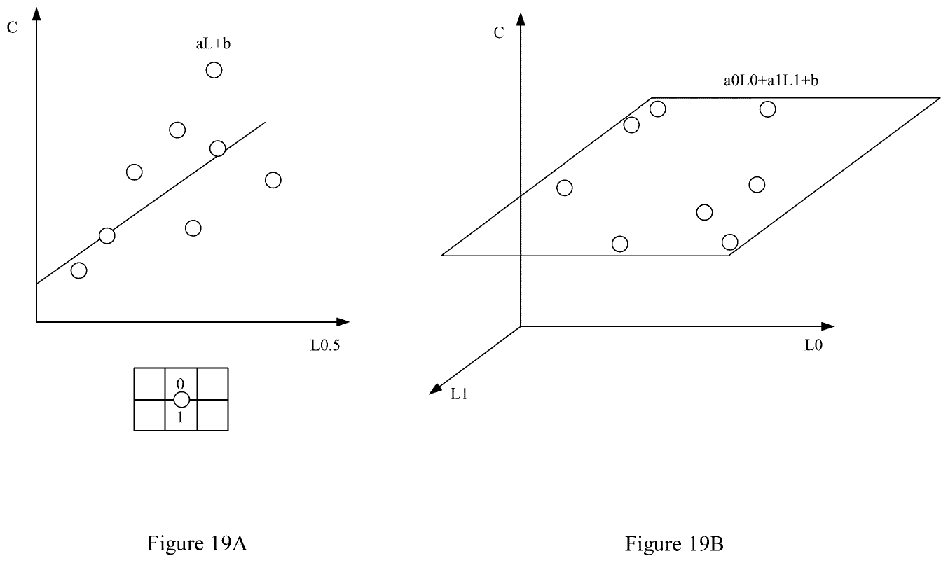

As shown in FIG. 19A, the CCLM assumes a given chroma sample only correlates to a corresponding luma sample (L0.5, which can be taken as the fractional luma sample position), and a simple linear regression (SLR) with ordinary least squares (OLS) estimation is used to predict the given chroma sample. However, as shown in FIG. 19B, in some video content, one chroma sample may simultaneously correlate to multiple luma samples (AC or DC correlation), so a multiple linear regression (MLR) model may further improve the prediction accuracy.

Although the CCCM mode can enhance the intra prediction efficiency, there is room to further improve its performance. Meanwhile, some parts of the existing CCCM mode also need to be simplified for efficient codec hardware implementations or improved for better coding efficiency. Furthermore, the tradeoff between its implementation complexity and its coding efficiency benefit needs to be further improved.

### Edge-Classified Linear Model (ELM)

To improve the coding efficiency of luma and chroma components, classifiers considering luma edge or AC information is introduced, in contrast to the above implementations wherein only luma DC values are considered. Besides the existing band-classified MMLM, the present disclosure provides exemplary classifiers. The process of generating linear prediction models for different sample groups may be similar as CCLM or MMLM (e.g., via a least square method, or a simplified min-max method, etc.), but with different metrices for classification. Different classifiers may be used to classify the neighboring luma samples (e.g., of the neighboring luma-chroma sample pairs) and/or the luma samples corresponding to chroma samples to be predicted. The luma samples corresponding to the chroma samples may be obtained by a down-sampling operation to match the locations of the corresponding chroma samples for 4:2:0 video sequences. For example, a luma sample corresponding to a chroma sample may be obtained by performing a down-sampling operation on more than one (e.g., 4) reconstructed luma samples corresponding to the chroma sample (e.g., located around the chroma sample). Alternatively, the luma samples may obtained directly from the reconstructed luma samples in a case of 4:4:4 video sequences, for example. Alternatively, the luma samples may be obtained from respective ones of the reconstructed luma samples that are at respective collocated positions for the corresponding chroma samples. For example, a luma sample to be classified may be obtained from one of four reconstructed luma samples corresponding to the chroma sample that is at a left-top position of the four reconstructed luma samples, which may be considered as a collocated position for the chroma sample.

A first classifier may classify luma samples according to their edge strengths. For example, one direction (e.g., 0-degree, 45-degree, or 90-degree, etc.) may be selected to calculate the edge strength. A direction may be formed by a current sample and a neighboring sample along the direction (e.g., a neighboring sample located at the right-top of the current sample for 45-degree). An edge strength may be calculated by subtracting the neighbor sample from the current sample. The edge strength may be quantized into one of M segments by M−1 thresholds, and the first classifier may use M classes to classify the current sample. Alternatively or additionally, N directions may be formed by a current sample and N neighboring samples along the N directions. N edge strengths may be calculated by subtracting N neighboring samples from the current sample, respectively. Similarly, if each of the N edge strengths may be quantized into one of M segments by M−1 thresholds, then the first classifier may use MN classes to classify the current sample.

A second classifier may be used to classify according to a local pattern. For example, a current luma sample Y0 may be compared with its neighboring N luma samples Yi. A score may be added by one if the value of Y0 is greater than that of Yi, otherwise, the score may be reduced by one. The score may be quantized to form K classes. The second classifier may classify a current sample into one of the K classes. For example, the neighboring luma samples may be obtained from four neighbors that are located above, left, right and below the current luma samples, i.e., without diagonal neighbors.

It may be contemplated that a plurality of the first classifier, the second classifier, or different instances of the first or second classifier or other classifiers described herein may be combined. For example, a first classifier may be combined with the existing MMLM threshold-based classifier. For another example, instance A of the first classifier may be combined with another instance B of the first classifier, where the instance A and B employ different directions (e.g., employing vertical and horizontal directions, respectively).

It will be appreciated by those skilled in the art that though the existing CCLM design in the VVC standard is used as the basic CCLM method in the description, the proposed cross-component method described in the disclosure can also be applied to other prediction coding tools with similar design spirits. For example, for the chroma from luma (CfL) in the AV1 standard, the proposed method can also be applied by dividing luma-chroma sample pairs into multiple sample groups.

It will be appreciated by those skilled that Y/Cb/Cr also can be denoted as Y/U/V in video coding area. If video data is of RGB format, the proposed method can also be applied by simply mapping YUV notation to GBR, for example.

### Filter-Based Linear Model (FLM)

A filter-based linear model (FLM) which utilizes the MLR model is introduced as follows, to take into account the possibilities that one chroma sample may simultaneously correlate to multiple luma samples.

For a to-be-predicted chroma sample, the reconstructed collocated and neighboring luma samples can be used to predict the chroma sample, to capture the inter-sample correlation among the collocated luma sample, neighboring luma samples, and the chroma sample. The reconstructed luma samples are linear weighted and combined with one “offset” to generate the predicted chroma sample (C: predicted chroma sample, Lt: i-th reconstructed collocated or neighboring luma samples, αᵢ: filter coefficients, β: offset, N: filter taps), as shown in the following equation (32-1). Note the linear weighted plus offset value directly forms the predicted chroma sample (can be low pass, high pass adaptively according to video content), and it is then added by the residual to form the reconstructed chroma sample.

$$C = {\sum }_{i = 0}^{N - 1} {α}_{i} \cdot {L}_{i} + β \qquad ( 32 - 1 )$$

In some implementation like CCCM, the offset term can also be implemented as middle chroma value B (512 for 10-bit content) multiplied by another coefficient, as shown in the following equation (32-2).

$$C = {\sum }_{i = 0}^{N - 1} {α}_{i} \cdot {L}_{i} + {α}_{N} \cdot B \qquad ( 32 - 2 )$$

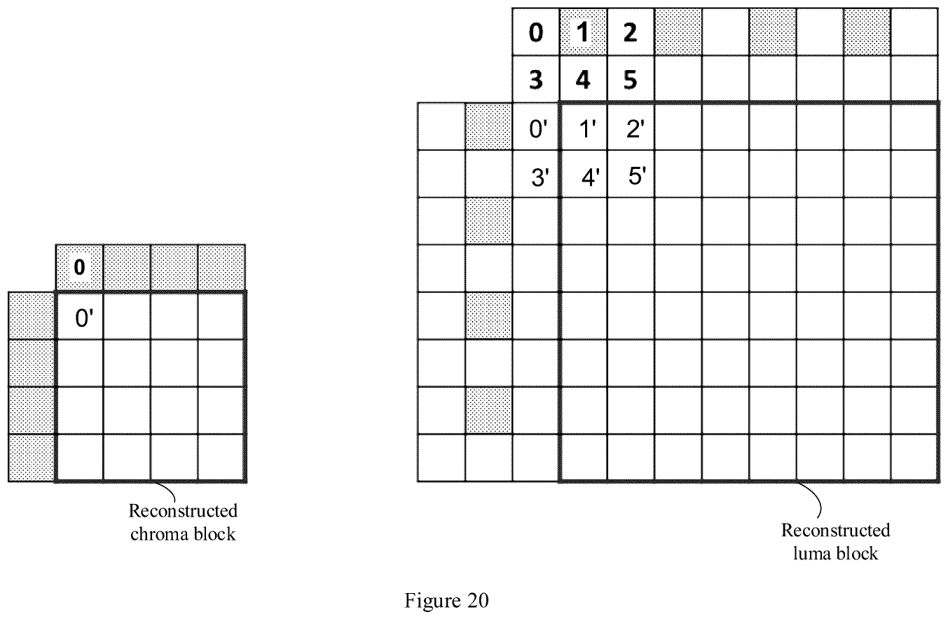

For a given CU, the top and left reconstructed luma and chroma samples can be used to derive or train the FLM parameters (αᵢ, β). Like CCLM, αᵢ and β can be derived via OLS. The top and left training samples are collected, and one pseudo inverse matrix is calculated at both encoder and decoder sides to derive the parameters, which are then used to predict the chroma samples in the given CU. Let N denotes the number of filter taps applied on luma samples, M denotes the total top and left reconstructed luma-chroma sample pairs used for training parameters, Lⱼⁱ denotes luma sample with the i-th sample pair and the j-th filter tap, Cⁱ denotes the chroma sample with the i-th sample pair, the following equations show the derivation of the pseudo inverse matrix A⁺, and also the parameters. FIG. 20 shows an example that N is 6 (6-tap), M is 8, top 2 rows and left 3 columns luma samples and top 1 row and left 1 column chroma samples are used to derive or train the parameters.

$$\begin{matrix}{C}^{0} = {α}_{0} \cdot {L}_{0}^{0} + {α}_{1} \cdot {L}_{1}^{0} + ⋯ + {α}_{N - 1} \cdot {L}_{N - 1}^{0} + β \\ {C}^{0} = {α}_{0} \cdot {L}_{0}^{1} + {α}_{1} \cdot {L}_{1}^{1} + ⋯ + {α}_{N - 1} \cdot {L}_{N - 1}^{1} + β \\ ⋮ \\ {C}^{M - 1} = {α}_{0} \cdot {L}_{0}^{M - 1} + {α}_{1} \cdot {L}_{1}^{M - 1} + ⋯ + {α}_{N - 1} \cdot {L}_{N - 1}^{M - 1} + β\end{matrix} \qquad ( 33 )$$

$$[ \begin{matrix}{C}^{0} \\ {C}^{1} \\ ⋮ \\ ⋮ \\ {C}^{M - 1}\end{matrix} ] = [ \begin{matrix}{L}_{0}^{0} & {L}_{1}^{0} & ⋯ & {L}_{N - 1}^{0} & 1 \\ {L}_{0}^{1} & {L}_{1}^{1} & ⋯ & {L}_{N - 1}^{1} & 1 \\ ⋮ & ⋮ & ⋯ & ⋮ & ⋮ \\ ⋮ & ⋮ & ⋯ & ⋮ & ⋮ \\ {L}_{0}^{M - 1} & {L}_{1}^{M - 1} & ⋯ & {L}_{N - 1}^{M - 1} & 1\end{matrix} ] [ \begin{matrix}{α}_{0} \\ {α}_{1} \\ ⋮ \\ {α}_{N - 1} \\ β\end{matrix} ]$$

$$\begin{matrix}b = Ax \\ x = {( {A}^{T} A )}^{- 1} {A}^{T} b = {A}^{+} b\end{matrix}$$

Please note that one can predict the chroma sample by only αᵢ without the offset β, which may be a subset of the proposed method.

Please note that though the existing CCLM design in the VVC standard is used as the basic CCLM method in the following description, to a person skilled in the art of video coding, the proposed cross-component method described in the disclosure can also be applied to other prediction coding tools with similar design spirits. For example, for the chroma from luma (CfL) in the AV1 standard, the proposed FLM can also be applied by including multiple luma samples to the MLR model.

The proposed ELM/FLM/GLM (as discussed below) can be extended straightforwardly to the CfL design in the AV1 standard, which transmits model parameters (α, β) explicitly. For example, (1-tap case) deriving α and/or β at encoder at SPS/DPS/VPS/SEI/APS/PPS/PH/SH/Region/CTU/CU/Subblock/Sample levels, and signaled to decoder for the CfL mode.

### Filter Shape

To further improve the coding performance, additional designs may be used in the FLM prediction. As shown in FIG. 20 and discussed above, a 6-tap luma filter is used for the FLM prediction. However, though a multiple tap filter can fit well on training data (e.g., top and left neighboring reconstructed luma and chroma samples), in some cases that training data do not capture full characteristics of testing data, it may result in overfitting and may not predict well on testing data (i.e., the to-be-predicted chroma block samples). Also, different filter shapes may adapt well to different video block content, leading to more accurate prediction.

To address this issue, the filter shape and number of filter taps can be predefined or signaled or switched in Sequence Parameter Set (SPS), Adaptation Parameter Set (APS), Picture Parameter Set (PPS), Picture Header (PH), Slice Header (SH), Region, CTU, CU, Subblock, or Sample level. A set of filter shape candidates can be predefined, and a selection on the set of filter shape candidates may be signaled or switched in SPS, APS, PPS, PH, SH, Region, CTU, CU, Subblock, or Sample level. Different components (e.g., U and V) may have different filter switch control. For example, a set of filter shape candidates (e.g., indicated by index 0˜5) may be predefined, and a filter shape (1, 2) may denote a 2-tap luma filter, a filter shape (1, 2, 4) may denote a 3-tap luma filter and the like, as shown in FIG. 20. The filter shape selection of U and V components can be switched in PH or in CU or CTU level. Note N-tap can represent N-tap with or without the offset β as described herein. One example is given as below in Table 8.

TABLE 8
Exemplary signaling and switching for different filter shapes

| predefined filter shape candidates: | | # of filter taps | filter shape |
|---|---|---|---|
| idx | 0 | 2 | (1, 2) |
| idx | 1 | 2 | (1, 4) |
| idx | 2 | 2 | (1, 5) |
| idx | 3 | 3 | (1, 2, 4) |
| idx | 4 | 4 | (1, 2, 4, 5) |
| idx | 5 | 6 | (0, 1, 2, 3, 4, 5) |

| POC | comp | selected filter shape idx | |
|---|---|---|---|
| 0 | U | 3 | PH switch |
| | V | 0~5 | CU switch |
| 1 | U | 4 | PH switch |
| | V | 0~2 | CTU |
| | | | switch |

The FLM or the CCCM filter shape may include a non-linear term. For example, for a CCCM filter, the chroma sample value may be predicted using the following equation:

$$predChromaVal = {c}_{0} C + {c}_{1} N + {c}_{2} S + {c}_{3} E + {c}_{4} W + {c}_{5} P + {c}_{6} B , P = ( C * C + midVal ) ≫ bitDepth$$

wherein the filter corresponds to weighting coefficients c₀, c₁, . . . c₆ for a center (C) luma sample value which is collocated with the chroma sample to be predicted, its above/north (N), below/south(S), right/east (E) and left/west (W) neighbors, a non-linear term P and a bias term B. The values used to derive the non-linear term P can be a combination of current and neighboring luma samples, but not limited to C*C. For example, P can be derived as following:

$$P = ( Q * R + midVal ) ≫ bitDepth$$

wherein Q and R denotes the value used to derive the non-linear term P.

Q and R can be linear combination of current and neighboring luma samples either in a down-sampled domain (for example, the Q and R being pre-operated luma samples obtained by weighted-average operation) or without any down-sampling process.

For example, each one of Q and R can be selected from one of N, S, E, W, and C luma sample values, for example Q*R=C*N, C*S, C*E, C*W, S*N or N*N etc.; or Q and R can both be equal to the average value of N, S, E, and W luma sample values, i.e., Q=R=(N+S+E+W)/4; or Q equals to C luma sample value while R equals to the average value of N, S, E, and W luma sample values, i.e., Q=C while R=(N+S+E+W)/4.

Different values (Q and R) used to derive the non-linear term are considered as different filter shapes and can be predefined or signaled/switched in SPS/DPS/VPS/SEI/APS/PPS/PH/SH/Region/CTU/CU/Subblock/Sample levels. A set of filter shape candidates can be or signaled/switched in predefined SPS/DPS/VPS/SEI/APS/PPS/PH/SH/Region/CTU/CU/Subblock/Sample levels.

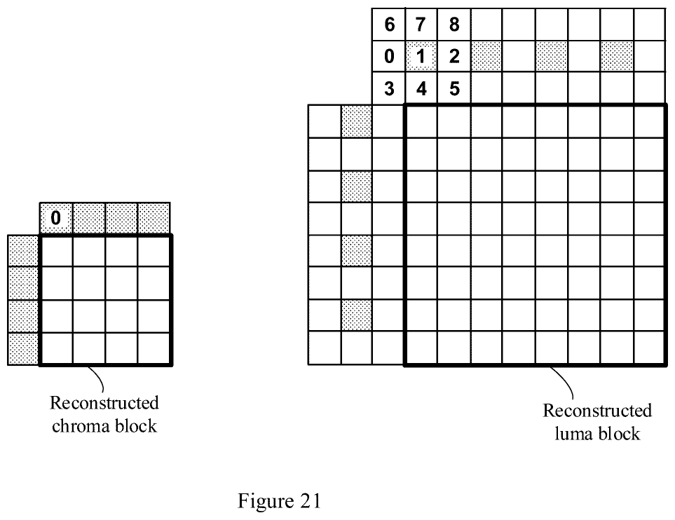

Different chroma types and/or color formats can have different predefined filter shapes and/or taps. For example, a predefined filter shape (1, 2, 4, 5) may be used for 4:2:0 type-0, a predefined filter shape (0, 1, 2, 4, 7) may be used for 4:2:0 type-2, and a predefined filter shape (1, 4) may be used for 4:2:2, and a predefined filter shape (0, 1, 2, 3, 4, 5) may be used for 4:4:4, as shown in FIG. 21.

In another aspect of the present disclosure, unavailable luma and chroma samples for deriving the MLR model can be padded from available reconstructed samples. For example, if using a 6-tap (0, 1, 2, 3, 4, 5) filter as in FIG. 21, for a CU located at the left picture boundary, the left columns including samples (0, 3) are not available (out of picture boundary), so samples (0, 3) are repetitive padding from samples (1, 4) to apply the 6-tap filter. Note that the padding process may be applied in both training data (top and left neighboring reconstructed luma and chroma samples) and testing data (the luma and chroma samples in the CU(s)).

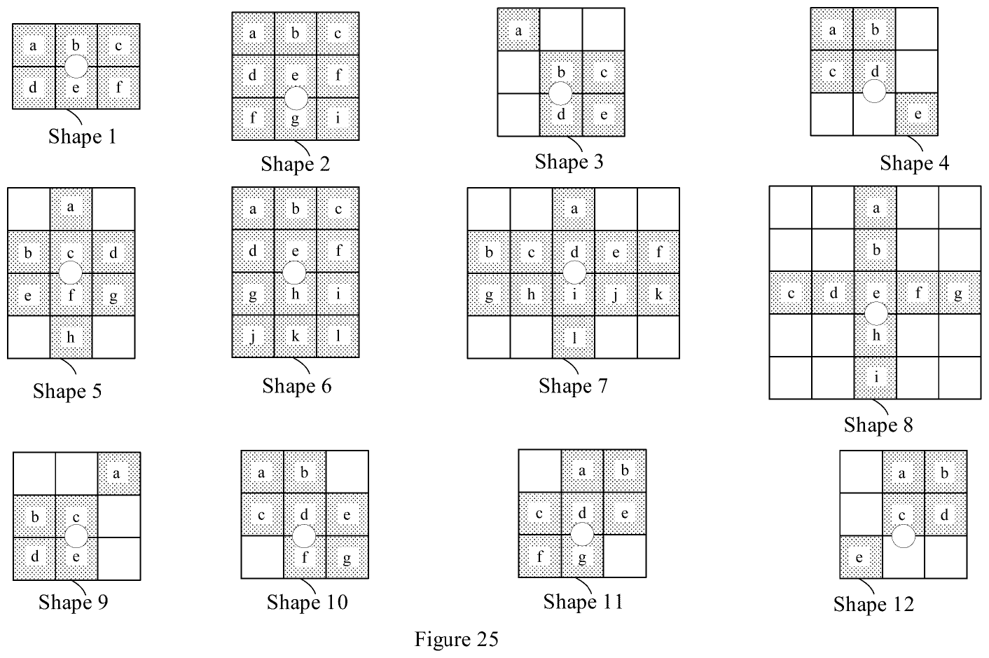

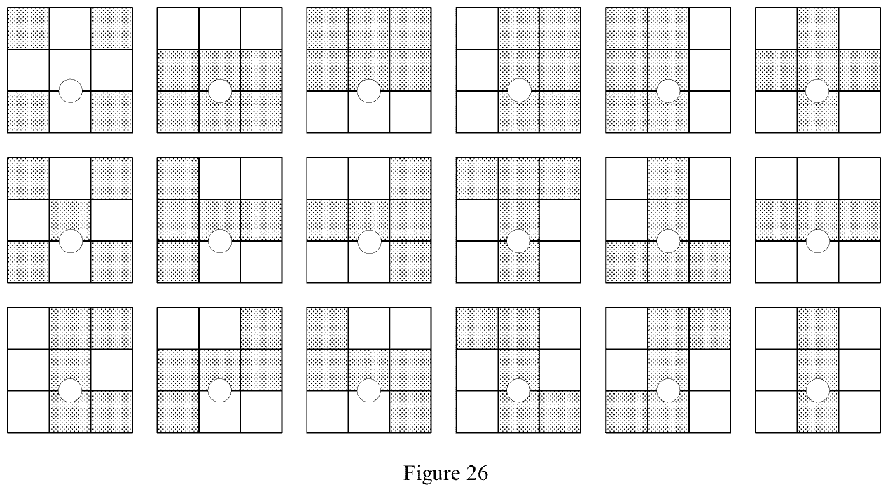

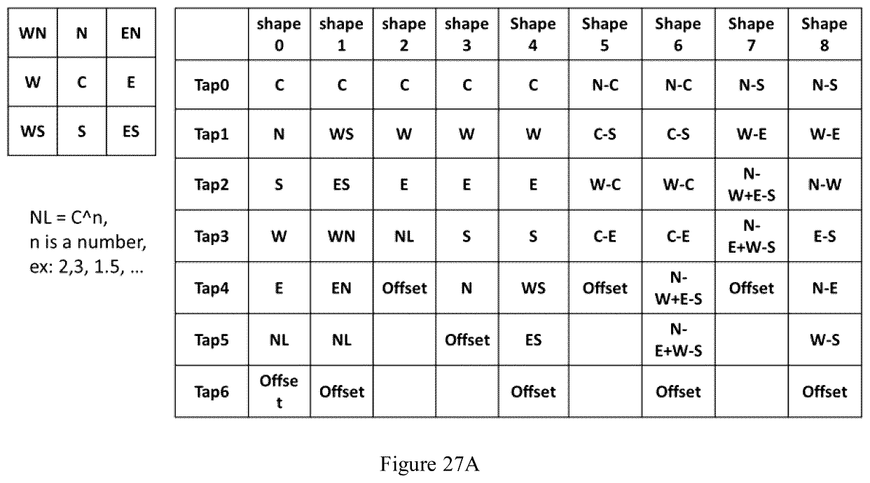

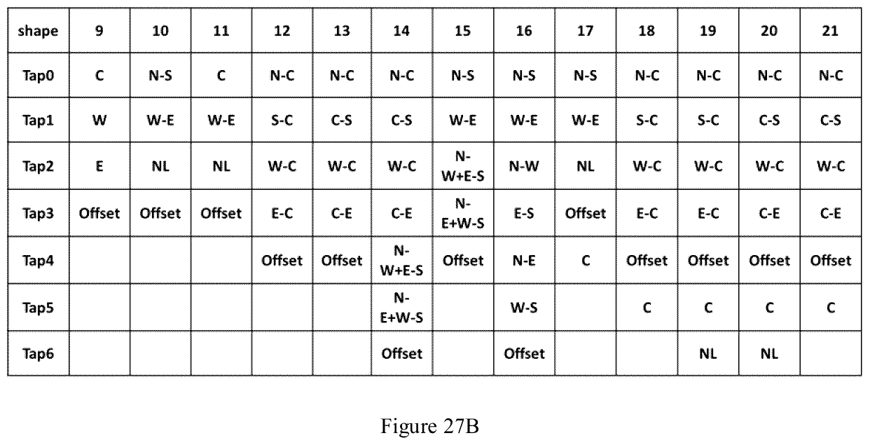

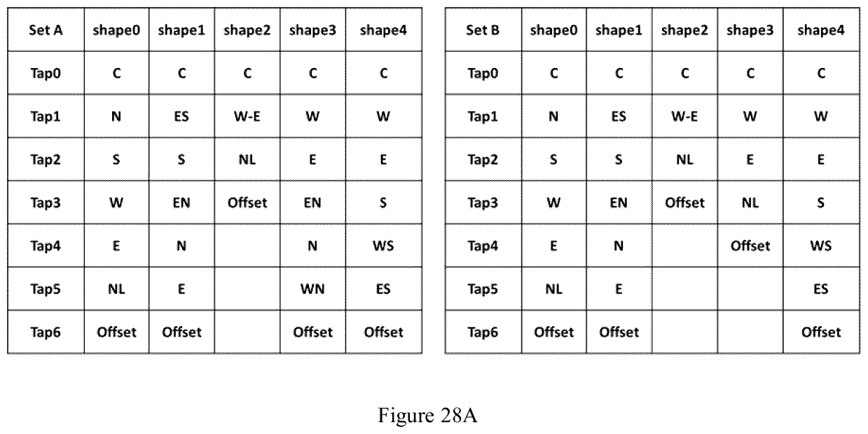

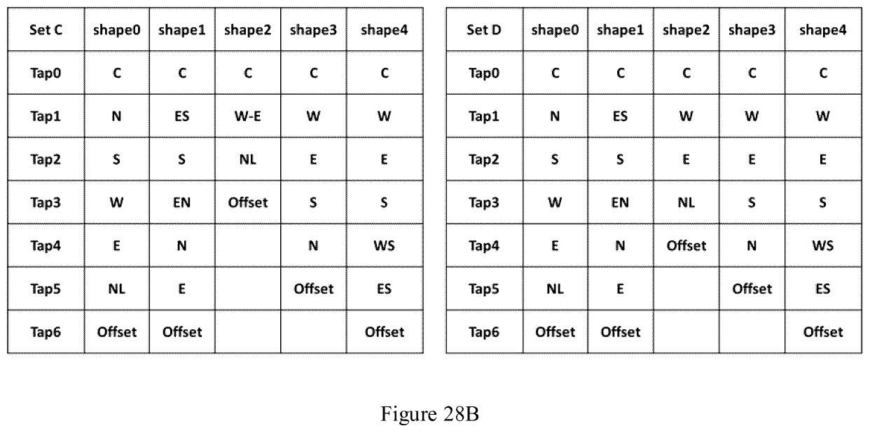

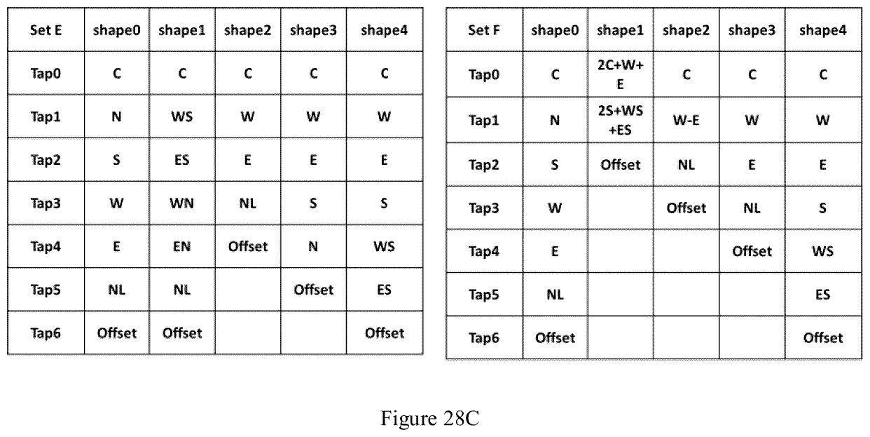

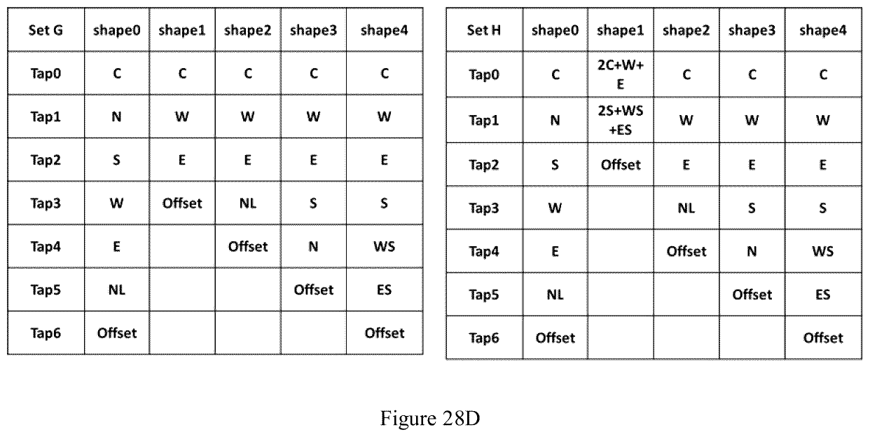

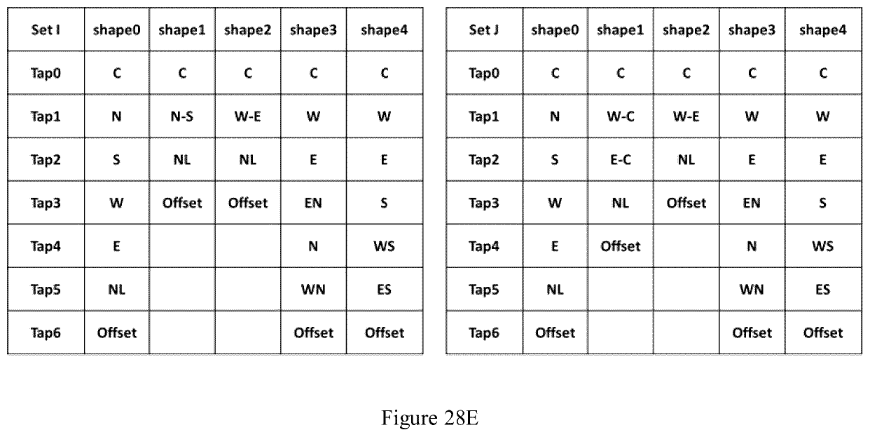

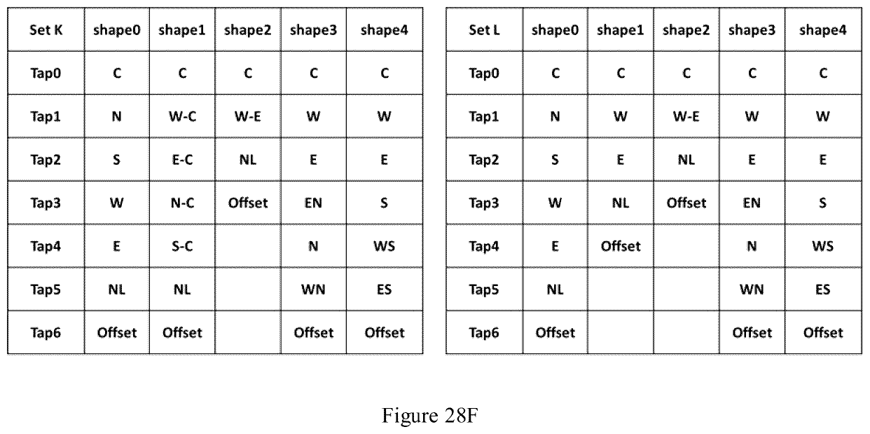

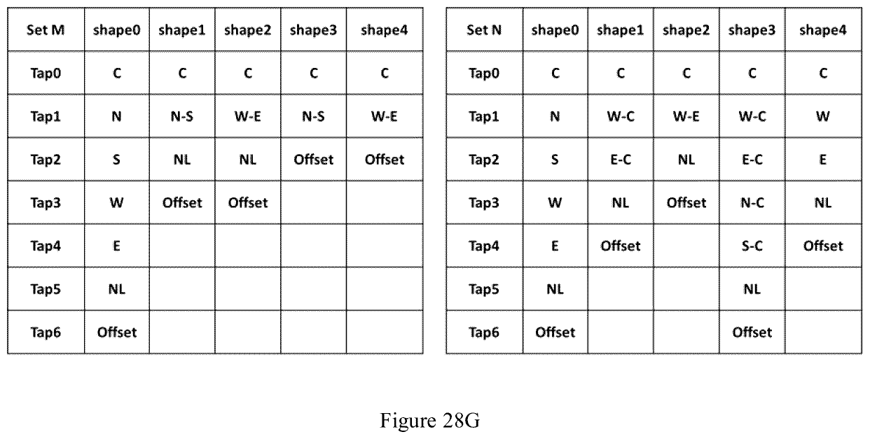

One or more shape/number of filter taps may be used for FLM prediction, examples being shown in FIG. 25, FIG. 26, and FIGS. 27A to 27B. One or more sets of filter taps may be used for FLM prediction, examples being shown in FIGS. 28A to 28G.

### Implicit Filter Shape Derivation

The filter shape candidates can be implicitly derived without explicitly signaling bits. For example, the filter shape candidates can be the filter shape candidates for FLM or GLM (as discussed below). In another example, the filter shape candidates can be the cross shape filter for CCCM, any of the filters shown in FIG. 25, FIG. 26, FIG. 27A, FIG. 27B, and FIGS. 28A to 28G, or other filters mentioned in this disclosure. As longer filter taps theoretically always fit better in training data (template area) but may be overfitting, the well-known “N-fold cross-validation” technique in machine learning area can be used for training filter coefficients. The technique divides the available training data into N sets, and use partial sets for training, others for validation.

The following example involves implicit filter shape derivation for FLM prediction:
Step 1: determining M filter shape candidates for predicting the chroma sample values of the current CU;
Step 2: dividing the available L-shaped template area external to the CU into N regions, denoted as R₀, R₁, . . . R_{N-1}, i.e., dividing the training data into N sets for N-fold training, wherein the luma sample values and the chroma sample values of the available template area are known values;
Step 3: applying each of the M filter shape candidates respectively to a part of the available template area, i.e., one or more regions among all the N regions R₀, R₁, . . . R_{N-1};
Step 4: deriving M filter coefficient sets corresponding to the M filter shape candidates, denoted as F₀, F₁, . . . F_{M-1};
Step 5: applying the derived F₀, F₁, . . . F_{M-1} filter coefficient sets to another part of the available template area to predict the chroma sample values based on corresponding luma sample values, wherein the another part of the available template area is different from the part of the available template area mentioned in Step 3;
Step 6: accumulating, for each of the M filter shapes respectively, the errors between the predicted chroma sample values and the known chroma sample values in the another part of the available template area by Sum of Absolute Difference (SAD), Sum of Squared Difference (SSD), or Sum of Absolute Transformed Difference (SATD), denoted as E₀, E₁, . . . E_{M-1};
Step 7: sorting and selecting K smallest errors, denoted as E′₀, E′₁, . . . E′_{K-1}, which correspond to K filter shapes and K filter coefficient sets; and
Step 8: selecting one filter shape candidate from the K filter shape candidates, to apply to the current CU for chroma prediction. If K is more than 1, then the decoder may still receive signal from the encoder indicating the applied filter. However, if K is 1, then the signaling can be omitted and the filter with the smallest accumulated error is determined to be the applied filter.

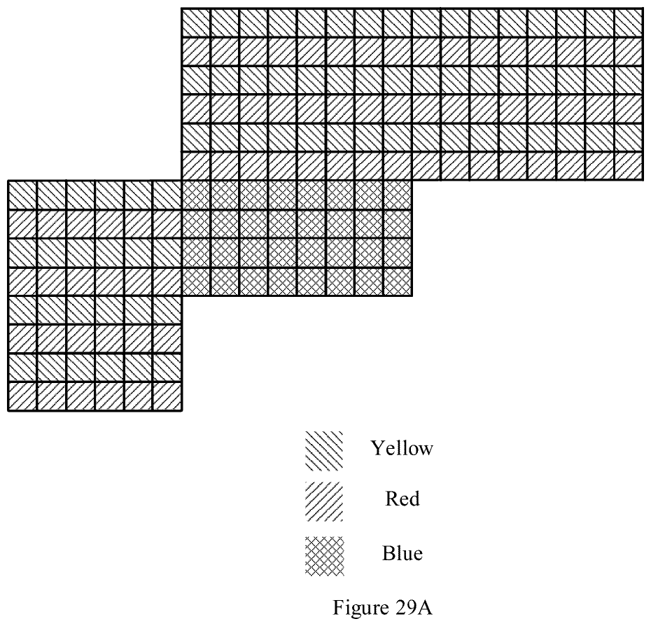

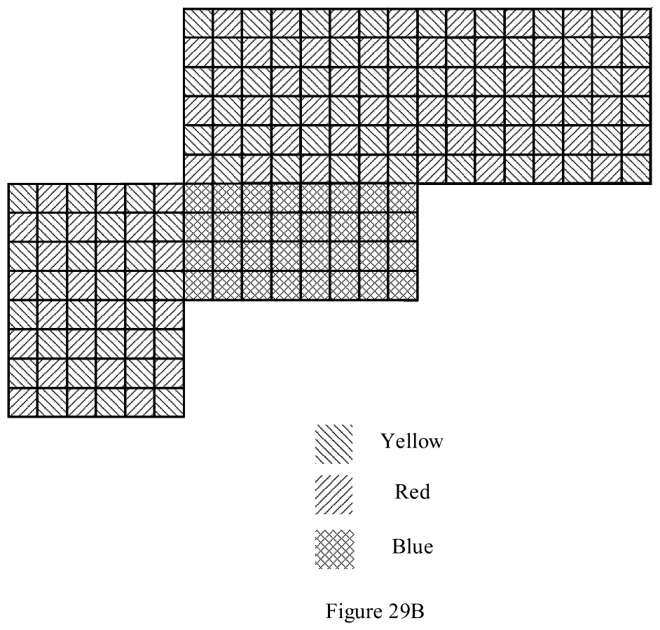

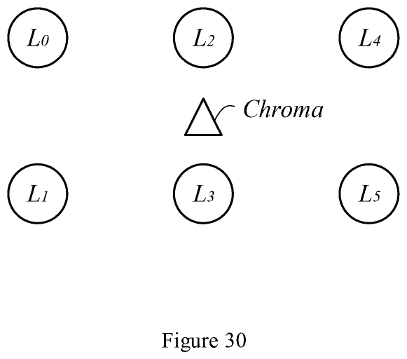

FIG. 29A and FIG. 29B illustrate examples of 2-fold training for implicitly filter shape derivation. For current chroma CU prediction (blue area), FIG. 29A shows that in template area, even-row region R₀ (yellow) is used for training/deriving 4 filter coefficient sets, and odd-row region R₁ (red) is used for validation/comparing and sorting costs of 4 filter coefficient sets; FIG. 29B shows that in template area, R₀ (yellow) and R₁ (red) are interleaved. It should be understood that R₀ and R₁ can be exchanged in these examples.

In one example, one of 4 filter shape candidates is to be selected as the applied filter, while the L-shaped template area is divided into even-numbered and odd-numbered rows or columns. The steps include:
predefining 4 filter shape candidates for the current CU (for example, 4 filter shape candidates from FIG. 25);
dividing the available L-shaped template area (for example, 6 chroma rows and columns for CCCM, note that in CCCM design, each chroma sample involves 6 luma samples for down-sampling) into 2 regions denoted as R₀, R₁, wherein, for example, R₀ is composed of the even rows or columns, and R₁ is composed of the odd rows or columns (FIG. 29A shows the example that in template area, even-row region R₀ is used for training/deriving 4 filter coefficient sets, and odd-row region R₁ is used for validation/comparing and sorting costs of 4 filter coefficient sets);
applying 4 filter shape candidates independently to a part of the available template area (for example, region R₀);
deriving 4 filter coefficient sets for the 4 filter shapes respectively, denoted as F₀, F₁, F₃;
applying the derived F₀, F₁, . . . F₃ filter coefficient sets to the other part of the available template area (for example, region R₁) respectively, to predict the corresponding chroma sample values;
accumulating, for each of the 4 filters respectively, the errors between the predicted chroma sample values and the known chroma sample values in the other part of the available template area (for example, region R₁) by SAD, SSD, or SATD, denoted as E₀, E₁, . . . E₃; and selecting one of the 4 filter shape candidates with the smallest accumulated error in E₀, E₁, . . . E₃, denoted as E′₀, which corresponds to one filter shape and one filter coefficient set. In this example, only the filter shape candidate with the smallest accumulated error will be determined as the applied filter, then the decoder does not need to receive signal indicative of the applied filter.

In one example, the L-shaped template area can be divided into interleaved parts, while K=2. The steps include:
determining 4 filter shape candidates for the current CU;
dividing the available L-shaped template area (for example, 6 chroma rows or columns for CCCM) into 2 regions denoted as R₀, R₁, wherein the luma samples in R₀ and R₁ are for example interleaved as shown in the following tables:

| | |
|---|---|
| R₀ | R₁ |
| R₁ | R₀ |

or

| | |
|---|---|
| R₁ | R₀ |
| R₀ | R₁ |

and FIG. 29B shows the example that in template area, R₀ and R₁ are interleaved;
applying 4 filter shape candidates independently to a part of the available template area (for example, region R₀);
deriving 4 filter coefficient sets for the 4 filter shapes respectively, denoted as F₀, F₁, F₃;
applying the derived F₀, F₁, . . . F₃ filter coefficient sets to the other part of the available template area (for example, region R₁) respectively, to predict the corresponding chroma sample values;
accumulating, for each of the 4 filter shapes respectively, the errors between the predicted chroma sample values and the known chroma sample values in the other part of the available template area (for example, region R₁) by SAD, SSD, or SATD, denoted as E₀, E₁, E₃;
sorting and selecting 2 smallest accumulated errors in E₀, E₁, . . . E₃, denoted as E′₀, E′₁, which correspond to 2 filter shapes and 2 filter coefficient sets; and
based on the received signal from the encoder, selecting one filter shape candidate in the 2 filter shape candidates, to apply to the current CU for chroma prediction.

Note the method of implicit filter shape derivation can also be used to determine whether to introduce non-linear term in CCCM filter coefficients (treating with/without non-linear term as different filter shapes).

Although examples are illustrated above for CCCM filter, it should be understood that the non-linear term P may also be included in FLM filters (e.g., a 3*2 filter as shown in FIG. 20) and derived in a similar way as discussed above.

In one example, the steps of dividing the available L-shaped template area may be omitted. In this example, the M filter coefficient sets may be derived based on the sample values from the available template area and then applied back to the available template area respectively, to predict the corresponding chroma sample values for accumulating the errors.

### Matrix Derivation

As mentioned above, an MLR model (linear equations) must be derived at both the encoder and the decoder. According to one or more aspects of the present disclosure, several methods are proposed to derive the pseudo inverse matrix A⁺, or to directly solve the linear equations. Other known methods like Newton's method, Cayley-Hamilton method, and Eigendecomposition as mentioned in en.wikipedia.org/wiki/Invertible_matrix can also be applied.

In the present disclosure, A⁺ can be denoted as A⁻¹ for simplification. The linear equations may be solved as follows

1. Solving A⁻¹ by Adjugate Matrix (adjA), Closed Form, Analytic Solution:

Below shows one n×n general form, one 2×2 and one 3×3 cases. If FLM uses 3×3, 2 scalers plus one offset need be solved.

$$b = Ax , x = {( {A}^{T} A )}^{- 1} {A}^{T} b = {A}^{+} b , denoted as {A}^{- 1} b {A}^{- 1} = \frac{1}{det A} adj A$$

$${( adj A )}_{ij} = {( - 1 )}^{i + j} det {\tilde{A}}_{ji}$$

Ãⱼᵢ: (n−1)×(n−1) submatrix by removing j-th row and i-th column

$${A}^{- 1} = {[ \begin{matrix}a & b \\ c & d\end{matrix} ]}^{- 1} = \frac{1}{det A} [ \begin{matrix}{\tilde{A}}_{11} & - {\tilde{A}}_{21} \\ - {\tilde{A}}_{12} & {\tilde{A}}_{22}\end{matrix} ] = \frac{1}{det A} [ \begin{matrix}d & - b \\ - c & a\end{matrix} ] ,$$

$${A}^{- 1} = {[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]}^{- 1} = \frac{1}{det A} [ \begin{matrix}\vert \begin{matrix}{a}_{22} & {a}_{23} \\ {a}_{32} & {a}_{33}\end{matrix} \vert & - \vert \begin{matrix}{a}_{12} & {a}_{13} \\ {a}_{32} & {a}_{33}\end{matrix} \vert & \vert \begin{matrix}{a}_{12} & {a}_{13} \\ {a}_{22} & {a}_{23}\end{matrix} \vert \\ - \vert \begin{matrix}{a}_{21} & {a}_{23} \\ {a}_{31} & {a}_{33}\end{matrix} \vert & \vert \begin{matrix}{a}_{11} & {a}_{13} \\ {a}_{31} & {a}_{33}\end{matrix} \vert & - \vert \begin{matrix}{a}_{11} & {a}_{13} \\ {a}_{21} & {a}_{23}\end{matrix} \vert \\ \vert \begin{matrix}{a}_{21} & {a}_{22} \\ {a}_{31} & {a}_{32}\end{matrix} \vert & - \vert \begin{matrix}{a}_{11} & {a}_{12} \\ {a}_{31} & {a}_{32}\end{matrix} \vert & \vert \begin{matrix}{a}_{11} & {a}_{12} \\ {a}_{21} & {a}_{22}\end{matrix} \vert\end{matrix} ]$$

### 2. Gauss-Jordan Elimination

The linear equations can be solved using Gauss-Jordan elimination, by an augmented matrix [A Iₙ] and a series of elementary row operation to obtain the reduced row echelon form [I|X]. Below shows 2×2 and 3×3 examples.

$$[ \begin{matrix}a & b \\ c & d\end{matrix} \vert \begin{matrix}1 & 0 \\ 0 & 1\end{matrix} ] \to [ \begin{matrix}a & b \\ 0 & ad - bc\end{matrix} \vert \begin{matrix}1 & 0 \\ - c & a\end{matrix} ] \to [ \begin{matrix}a & b \\ 0 & 1\end{matrix} \vert \begin{matrix}1 & 0 \\ \frac{- c}{ad - bc} & \frac{a}{ad - bc}\end{matrix} ] \to [ \begin{matrix}a & b \\ 0 & 1\end{matrix} \vert \begin{matrix}\frac{ad}{ad - bc} & \frac{- ab}{ad - bc} \\ \frac{- c}{ad - bc} & \frac{a}{ad - bc}\end{matrix} ] \to [ \begin{matrix}1 & 0 \\ 0 & 1\end{matrix} \vert \begin{matrix}\frac{d}{ad - bc} & \frac{- b}{ad - bc} \\ \frac{- c}{ad - bc} & \frac{a}{ad - bc}\end{matrix} ] \to [ \begin{matrix}2 & 2 & 5 \\ - 2 & 1 & 2 \\ 6 & 3 & 9\end{matrix} \vert \begin{matrix}1 & 0 & 0 \\ 0 & 1 & 0 \\ 0 & 0 & 1\end{matrix} ] \to [ \begin{matrix}2 & 2 & 5 \\ 0 & 3 & 7 \\ 0 & - 3 & - 6\end{matrix} \vert \begin{matrix}1 & 0 & 0 \\ 1 & 1 & 0 \\ - 3 & 0 & 1\end{matrix} ] \to [ \begin{matrix}2 & 2 & 5 \\ 0 & 3 & 7 \\ 0 & 0 & 1\end{matrix} \vert \begin{matrix}1 & 0 & 0 \\ 1 & 1 & 0 \\ - 2 & 1 & 1\end{matrix} ] \to [ \begin{matrix}2 & 2 & 0 \\ 0 & 3 & 0 \\ 0 & 0 & 1\end{matrix} \vert \begin{matrix}11 & - 5 & - 5 \\ 15 & - 6 & - 7 \\ - 2 & 1 & 1\end{matrix} ] \to [ \begin{matrix}2 & 2 & 0 \\ 0 & 1 & 0 \\ 0 & 0 & 1\end{matrix} \vert \begin{matrix}11 & - 5 & - 5 \\ 5 & - 2 & - \frac{7}{3} \\ - 2 & 1 & 1\end{matrix} ] \to [ \begin{matrix}2 & 0 & 0 \\ 0 & 1 & 0 \\ 0 & 0 & 1\end{matrix} \vert \begin{matrix}1 & - 1 & - \frac{1}{3} \\ 5 & - 2 & - \frac{7}{3} \\ - 2 & 1 & 1\end{matrix} ] \to [ \begin{matrix}1 & 0 & 0 \\ 0 & 1 & 0 \\ 0 & 0 & 1\end{matrix} \vert \begin{matrix}\frac{1}{2} & - \frac{1}{2} & - \frac{1}{6} \\ 5 & - 2 & - \frac{7}{3} \\ - 2 & 1 & 1\end{matrix} ]$$

### 3. Cholesky Decomposition

To solve Ax=b, A can be firstly decomposed by Cholesky-Crout algorithm, leading to one upper triangular and one lower triangular matrices, and one forward substitution plus one backward substitution can be applied in serial to obtain the solution. Below shows a 3×3 example.

$$\begin{matrix}A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] = {GG}^{T} \\ = [ \begin{matrix}{g}_{11} & 0 & 0 \\ {g}_{21} & {g}_{22} & 0 \\ {g}_{31} & {g}_{32} & {g}_{33}\end{matrix} ] [ \begin{matrix}{g}_{11} & {g}_{21} & {g}_{31} \\ 0 & {g}_{22} & {g}_{32} \\ 0 & 0 & {g}_{33}\end{matrix} ] \\ = [ \begin{matrix}{g}_{11}^{2} & {g}_{21} {g}_{11} & {g}_{31} {g}_{11} \\ {g}_{21} {g}_{11} & {g}_{21}^{2} + {g}_{22}^{2} & {g}_{31} {g}_{21} + {g}_{32} {g}_{22} \\ {g}_{31} {g}_{11} & {g}_{31} {g}_{21} + {g}_{32} {g}_{22} & {g}_{31}^{2} + {g}_{32}^{2} + {g}_{33}^{2}\end{matrix} ]\end{matrix}$$

$${g}_{11} = \sqrt{{a}_{11}}$$

$${g}_{21} = \frac{{a}_{21}}{{g}_{11}}$$

$${g}_{31} = \frac{{a}_{31}}{{g}_{11}}$$

$${g}_{22} = \sqrt{{a}_{22} - {g}_{21}^{2}}$$

$${g}_{32} = \frac{1}{{g}_{22}} ( {a}_{32} - {g}_{31} {g}_{21} )$$

$${g}_{33} = \sqrt{{a}_{33} - {g}_{31}^{2} - {g}_{32}^{2}} .$$

$${g}_{jj} = \sqrt{{a}_{jj} - {\sum }_{k = 1}^{j - 1} {g}_{jk}^{2}}$$

$${g}_{ij} = \frac{1}{{g}_{ij}} ( {a}_{ij} - {\sum }_{k = 1}^{j - 1} {g}_{ik} {g}_{jk} ) , i = j + 1 , j + 2 , … , n$$

Apart from the above examples, some conditions need special handling. For example, if some conditions result in that the linear equations cannot be solved, default values can be used to fill the chroma prediction values. The default values can be predefined or signaled or switched in SPS/DPS/VPS/SEI/APS/PPS/PH/SH/Region/CTU/CU/Subblock/Sample levels, for example, when predefined 1<< (bitDepth−1), meanC, meanL, or meanC-meanL (mean current chroma or other chroma, luma values from available, or subset of FLM reconstructed neighboring region).

The following examples represent situations when the matrix A cannot be solved, where default prediction values may be assigned to the whole current block:
1. Solving by closed form (analytic, adjugate matrix), but A is singular, (i.e., detA=0);
2. Solving by Cholesky decomposition, but A cannot be Cholesky decomposed, gⱼⱼ<REG_SQR, where REG_SQR is one small value, can be predefined or signaled or switched in SPS/DPS/VPS/SEI/APS/PPS/PH/SH/Region/CTU/CU/Subblock/Sample levels.

### Applied Region

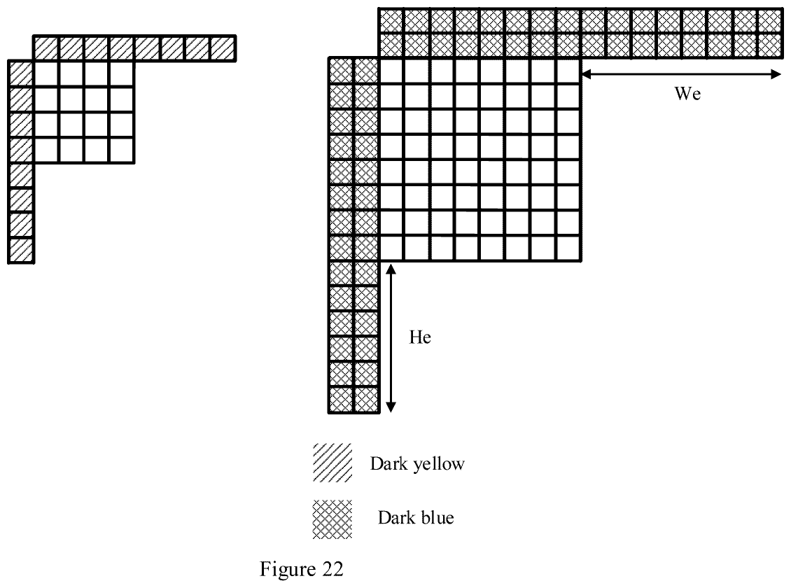

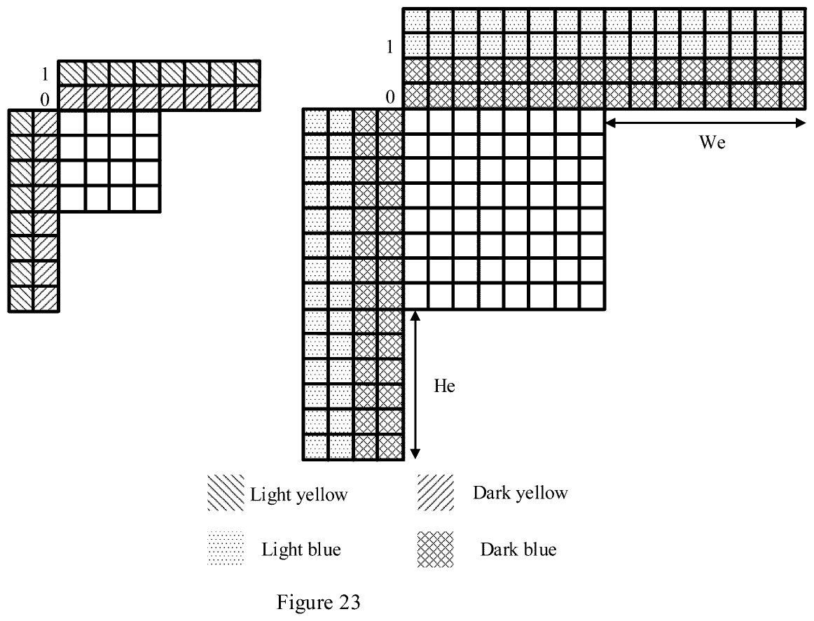

FIG. 20 shows a typical case that the FLM parameters are derived using top 2 and/or left 3 luma lines and top 1 and/or left 1 chroma lines. However, using different region for parameter derivation may bring coding benefit because of different block content and the reconstructive quality of different neighboring samples, as mentioned above. Several ways to choose the applied region for parameter derivation are proposed below:
1. Similar to MDLM, the FLM derivation can only use top or left luma and/or chroma samples to derive the parameters. Whether to use FLM, FLM_L, or FLM_T can be predefined or signaled or switched in SPS/DPS/VPS/SEI/APS/PPS/PH/SH/Region/CTU/CU/Subblock/Sample levels. Suppose that a current chroma block has a size of W×H, then W′ and H′ are obtained as follows:
   W′=W, H′=H when FLM mode is applied;
   W′=W+We when FLM_T mode is applied; where We denotes extended top luma/chroma samples;
   H′=H+He when FLM_L mode is applied; where He denotes extended left luma/chroma samples.
The number of extended luma/chroma samples (We, He) can be predefined, or signaled or switched in SPS/DPS/VPS/SEI/APS/PPS/PH/SH/Region/CTU/CU/Subblock/Sample levels.
For example, predefine (We, He)=(H, W) as the VVC CCLM, or (W, H) as the ECM CCLM. The unavailable (We, He) luma/chroma samples can be repetitive padded from the nearest (horizontal, vertical) luma/chroma samples.
FIG. 22 shows an illustration of FLM_L and FLM_T (e.g., under 4 tap). When FLM_L or FLM_T is applied, only H′ or W′ luma/chroma samples are used for parameter derivation, respectively.
2. Similar to MRL, different line index can be predefined, or signaled or switched in SPS/DPS/VPS/SEI/APS/PPS/PH/SH/Region/CTU/CU/Subblock/Sample levels, to indicate the selected luma-chroma sample pair line. This may benefit from different reconstructive quality of different line samples.
FIG. 23 shows that similar to MRL, FLM can use different lines for parameter derivation (e.g., under 4 tap). For example, FLM can use light blue/yellow luma and/or chroma samples in index 1.
3. Extend CCLM region and take full top N and/or left M lines for parameter derivation. FIG. 23 shows all dark and light blue and yellow region can be used at one time. Training using larger region (data) may lead to a more robust MLR model.

It should be understood that the luma sample values of an external region of the video block to be decoded may be referred to as “the external luma sample values”, and the chroma sample values of the external region may be referred to as “the external chroma sample values” throughout the disclosure.

### Syntax

Corresponding syntax may be defined as below in Table 9 for the FLM prediction. Wherein FLC represents fixed length code, TU represents truncated unary code, EGk represents exponential-golomb code with order k, where k can be fixed or signaled/switched in SPS/DPS/VPS/SEI/APS/PPS/PH/SH/Region/CTU/CU/Subblock/Sample levels, SVLC represents signed EGO, and UVLC represents unsigned EGO.

TABLE 9
An example of FLM syntax

| Level | Syntax element | Binarization | Meaning |
|---|---|---|---|
| SPS | flm_enabled_flag | FLC | whether FLM is enabled in the |
| | | | sequence, can be inferred off when |
| | | | chromaFormat == CHROMA_400, or |
| | | | CCLM is off |
| PH/SH | ph_flm_cb_flag | FLC | whether FLM is enabled in this |
| | ph_flm_cr_flag | | picture/slice for Cb/Cr, can be inferred |
| | | | off when chromaFormat == |
| | | | CHROMA_400, or CCLM is off |
| PH/SH | ph_flm_cb_ctb_control_flag | FLC | whether to enable Cb/Cr on/off control |
| | ph_flm_cr_ctb_control_flag | | at CTB level |
| CTU | ctb_flm_cb_flag | CABAC | whether FLM is enabled for the current |
| | ctb_flm_cr_flag | | Cb or Cr CTB, can be CABAC bypass |
| | | | coded or with N contexts (2: up/left, or |
| | | | N neighboring CTBs) |
| CU | cu_flm_cb_flag | CABAC, TU | whether FLM is enabled for the current |
| | cu_flm_cr_flag | | Cb or Cr CU, can be CABAC bypass |
| | | | coded or with N contexts (2: up/left, or |
| | | | N neighboring CUs) |
| CU | flm_cb_filter_idx | CABAC, TU | which filter shape idx (in the |
| | flm_cr_filter_idx | | predefined set) is used for the CU, can |
| | | | be CABAC bypass coded or with N |
| | | | contexts (2: up/left, or N neighboring |
| | | | CUs) |
| CU | flm_cb_mdlm_idx | CABAC, TU | which MDLM idx (FLM, FLM_L, |
| | flm_cr_mdlm_idx | | FLM_T) is used for the CU, can be |
| | | | CABAC bypass coded or with N |
| | | | contexts (2: up/left, or N neighboring |
| | | | CUs) |
| CU | flm_cb_mrl_idx | CABAC, TU | which FLM MRL idx (e.g., 0, 1) is |
| | flm_cr_mrl_idx | | used for the CU, can be CABAC |
| | | | bypass coded or with N contexts (2: |
| | | | up/left, or N neighboring CUs) |

Note that the binarization of each syntax element can be changed.

### Gradient Linear Model (GLM)

A new method for cross-component prediction is proposed on the basis of the existing linear model designs, in order to further improve coding accuracy and efficiency. Main aspects of the proposed method are detailed as follows.

Though the above discussed FLM provides the best flexibility (leading to the best performance), it requires to solve many unknown parameters if the number of filter taps goes up. When the inverse matrix is larger than 3×3, the closed form derivation is not suitable (too many multipliers), and iterative methods like Cholesky are needed, which burden decoder processing cycles. In this section, pre-operations before applying the linear model are proposed, including utilizing the sample gradients to exploit the correlation between luma AC information and chroma intensities. With the help of gradients, the number of filter taps can be efficiently reduced.

Please note that methods/examples in this section can be combined/reused from any of the designs discussed above, including but not limited to classification, filter shape, matrix derivation (with special handling), applied region, syntax. Moreover, methods/examples listed in this section can also be applied in any of the designs discussed above, to have a better performance with certain complexity trade-off.

Please note that reference samples/training template/reconstructed neighboring region as used herein usually refers to the luma samples used for deriving the MLR model parameters, which are then applied to the inner luma samples in one CU, to predict the chroma samples in the CU.

### Filter Shape

According to the proposed method, instead of directly using luma sample intensity values as the input of the linear model, pre-operations (e.g., pre-linear weighted, sign, scale/abs, thresholding, ReLU) can be applied to downgrade the dimension of unknown parameters. In one example, the pre-operations may comprise calculating sample differences based on the luma sample values. As understood by one skilled in the art, the sample differences may be characterized as gradients, and thus this new method is also referred to as gradient linear model (GLM) in certain embodiments.

Please note that the following detailed description discuss scenarios wherein the proposed pre-operations may be reused for/combined with the SLR model (also referred to as 1-tap case), and reused for/combined with the MLR model (also referred to as multi-tap case, for example, 2-tap).

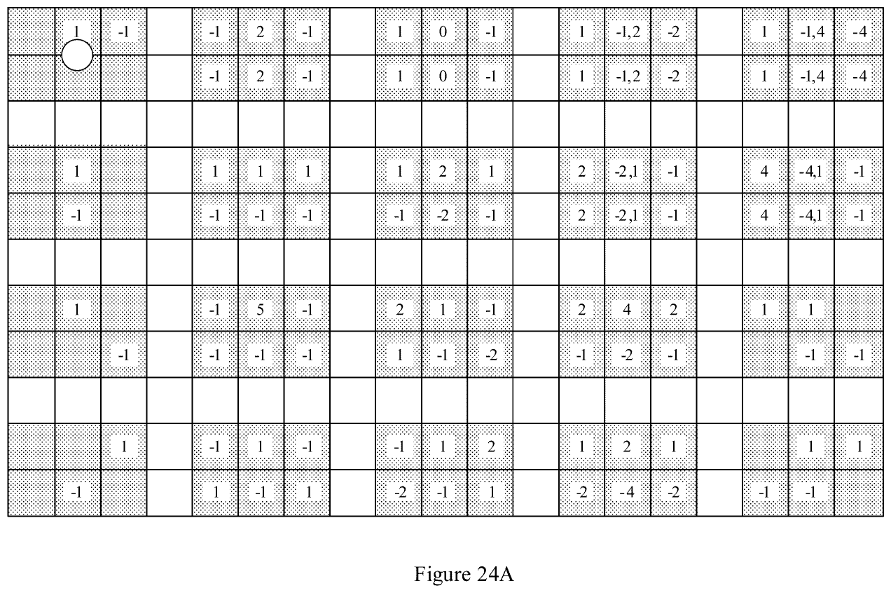

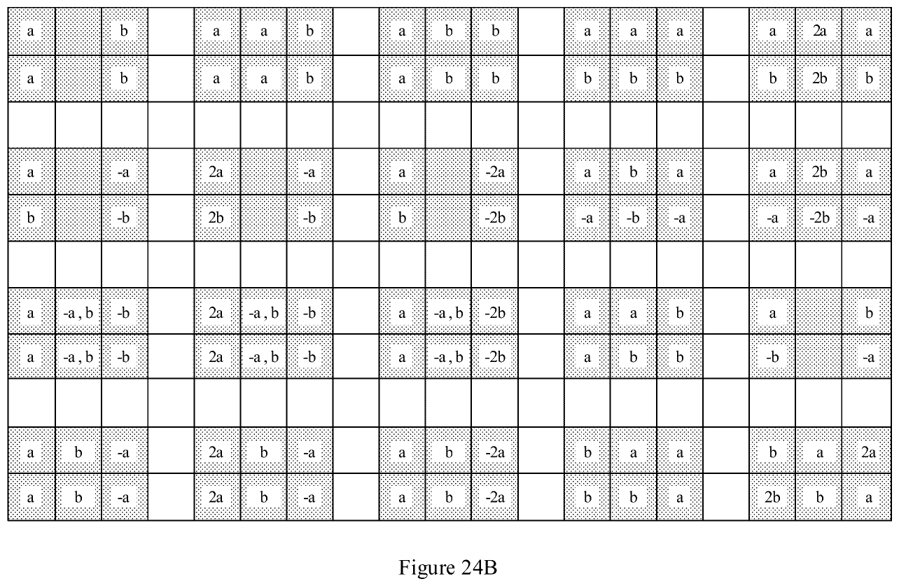

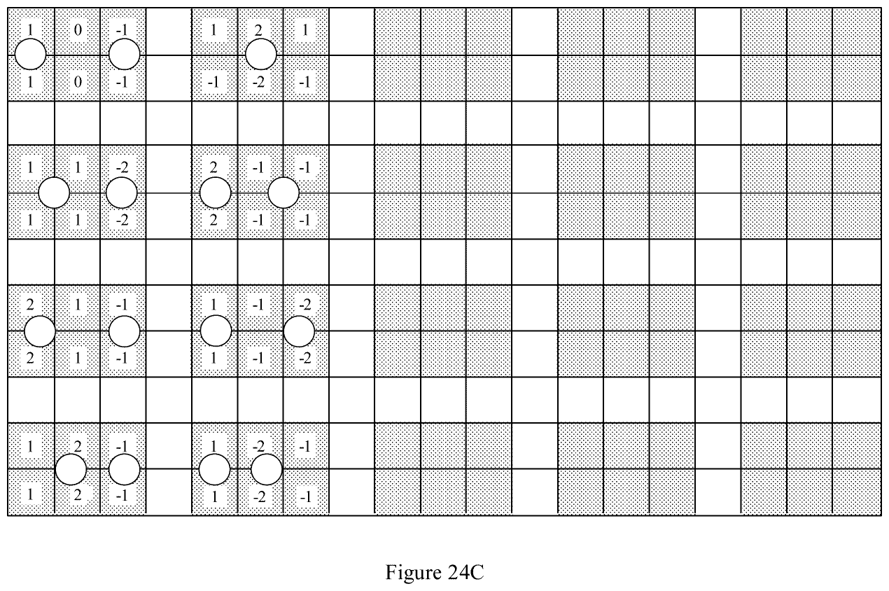

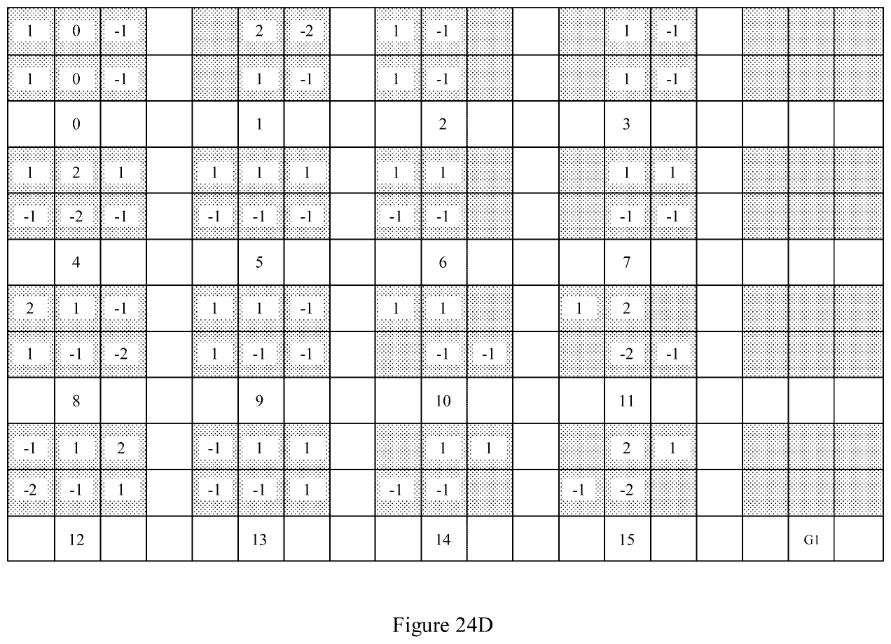

For example, instead of applying 2-tap on 2 luma samples, the 2 luma samples can be pre-operated, then a simpler 1-tap can be applied to reduce complexity. FIGS. 24A to 24D show some examples for 1-tap/2-tap (with offset) pre-operations, where 2-tap coefficients are denoted as (a, b). please note that each circle as illustrated in FIGS. 24A to 24D represent an illustrative chroma position in the YUV 4:2:0 format. As discussed above, in the YUV 4:2:0 format, a luma sample corresponding to a chroma sample may be obtained by performing a down-sampling operation on more than one (e.g., 4) reconstructed luma samples corresponding to the chroma sample (e.g., located around the chroma sample). In other words, the chroma position may correspond to one or more luma samples comprising a collocated luma sample. The different 1-tap patterns are designed for different gradient directions and using different “interpolated” luma samples (weighting to different luma location) for gradient calculation. For example, one typical filter [1, 0, −1; 1, 0, −1] is shown in FIGS. 24A, 24C and 24D, which represents the following operations:

$${Rec}_{L}^{″} ( i , j ) = [ {rec}_{L} ( 2 i - 1 , 2 j - 1 ) - {rec}_{L} ( 2 i + 1 , 2 j - 1 ) + {rec}_{L} ( 2 i - 1 , 2 j ) - {rec}_{L} ( 2 i + 1 , 2 j ) ] \qquad ( 34 )$$

Wherein rec_{L} represents the reconstructed luma sample values and Rec_{L}″(i, j) represents the pre-operated luma sample values. Please also note that the 1-tap filters as shown in FIGS. 24A, 24C and 24D may be understood as alternatives for the down-sampling filters as used in CCLM (please refer to equations (6)-(7)), with changed filter coefficients.

Pre-operations can be according to gradients, edge direction (detection), pixel intensity, pixel variation, pixel variance, Roberts/Prewitt/compass/Sobel/Laplacian operator, high-pass filter (by calculating gradients or other relevant operators), low-pass filter (by performing weighted-average operations) . . . , etc. The edge direction detectors listed in the examples can be extended to different edge directions. For example, 1-tap (1, −1) or 2-tap (a, b) applied along different directions to detect different edge gradients. The filter shape/coeff can be symmetric with respect to the chroma position, as the FIGS. 24A to 24D examples (420 type-0 case).

The pre-operation parameters (coefficients, sign, scale/abs, thresholding, ReLU) can be fixed or signaled/switched in SPS/DPS/VPS/SEI/APS/PPS/PH/SH/Region/CTU/CU/Subblock/Sample levels. Note in the examples, if multiple coefficients apply on one sample (e.g., −1, 4), then they can be merged (e.g., 3) to reduce operations.

In one example, the pre-operations may relate to calculating sample differences of the luma sample values. Alternatively, the pre-operations may comprise performing down-sampling by weighted-average operations. In certain cases, the pre-operations can be applied repeatedly. For example, one may apply one template filtering to template to remove outliers using the low-pass smoothing FIR filter [1, 2, 1]/4, or [1, 2, 1; 1, 2, 1]/8 (i.e., down-sampling) and then apply 1-tap GLM filter to calculate the sample differences to derive the linear model. It may be contemplated that one may also calculate the sample differences and then enabling down-sampling.

In one example, the pre-operation coefficients (finally applied (e.g., 3), or middle applied (e.g., −1, 4) to per luma sample) can be limited to power-of-2 values to save multipliers.

In one aspect of the present disclosure, the proposed new method may be reused for/combined with the above discussed CCLM, which utilizing a simple linear regression (SLR) model and using one corresponding luma sample value to predict the chroma sample value. This is also referred to as a 1-tap case. In this case, deriving the linear model further comprises deriving a scale parameter α and an offset parameter β by using the pre-operated neighboring luma sample values and the neighboring chroma sample values. Or, the linear model may be re-written as:

$$C = α \cdot L + β \qquad ( 35 )$$

Wherein L here represents “pre-operated” luma samples. The parameter derivation of 1-tap GLM can reuse CCLM design, but taking directional gradient into consideration (may be with high-pass filter). In one example, the scale parameter α may be derived by utilizing a division look-up table, as detailed below, to enable simplification.

In one example, when combining GLM with the SLR model, the scale parameter α and the offset parameter β may be derived by utilizing the above-discussed min-max method. Specifically, the scale parameter α and the offset parameter β may be derived by: comparing the pre-operated neighboring luma sample values to determine a minimum luma sample value Y_{A} and a maximum luma sample value Y_{B}; determining corresponding chroma samples values X_{A} and X_{B} for the minimum luma sample value Y_{A} and the maximum luma sample value Y_{B}, respectively; and deriving the scale parameter α and the offset parameter based on the minimum luma sample value Y_{A}, the maximum luma sample value Y_{B}, and the corresponding chroma samples values X_{A} and X_{B} according to the following equations:

$$\begin{matrix}α = \frac{{Y}_{A} - {Y}_{B}}{{X}_{A} - {X}_{B}} ; \\ β = {Y}_{A} - α {X}_{A} .\end{matrix} \qquad ( 36 )$$

In one example, when combining GLM with the SLR model, the above discussed scale adjustment may be reused. In this case, the encoder may determine a scale adjustment value (for example, “u”) to be signaled in the bitstream and add the scale adjustment value to the derived scale parameter α. The decoder may determine the scale adjustment value (for example, “u”) from the bitstream and add the scale adjustment value to the derived scale parameter α. The added value are finally used to predict the internal chroma sample values.

In one aspect of the present disclosure, the proposed new method may be reused for/combined with FLM, which utilizing a multiple linear regression (MLR) model and using multiple luma sample values to predict the chroma sample value. This is also referred to as a multi-tap case, for example, 2-tap. In this case, the linear model may be re-written as:

$$\begin{matrix}{C}^{0} = α \cdot {L}^{0} + β \\ {C}^{1} = α \cdot {L}^{1} + β \\ ⋮ \\ {C}^{M - 1} = α \cdot {L}^{M - 1} + β \\ [ \begin{matrix}{C}^{0} \\ {C}^{1} \\ ⋮ \\ {C}^{M - 1}\end{matrix} ] = [ \begin{matrix}{L}^{0} & 1 \\ {L}_{1} & 1 \\ ⋮ & ⋮ \\ {L}^{M - 1} & 1\end{matrix} ] [ \begin{matrix}α \\ β\end{matrix} ] \\ b = Ax\end{matrix} \qquad ( 37 )$$

$$\begin{matrix}x = {( {A}^{T} A )}^{- 1} {A}^{T} b = {A}^{+} b \\ α = \frac{n \sum {x}_{k} {y}_{k} - \sum {x}_{k} {y}_{k}}{n \sum {{x}_{k}}^{2} - {( \sum {x}_{k} )}^{2}} = \frac{{A}_{1}}{{A}_{2}} \\ β = \frac{\sum {y}_{k} - α \sum {x}_{k}}{n} = \overline{y} - α \overline{x}\end{matrix}$$

In this case, multiple scale parameters α and an offset parameter β may be derived by using the pre-operated neighboring luma sample values and the neighboring chroma sample values. In one example, the offset parameter β is optional. In one example, at least one of the multiple scale parameters α may be derived by utilizing the sample differences. Moreover, another of the multiple scale parameters α may be derived by utilizing the down-sampled luma sample value. In one example, at least one of the multiple scale parameters α may be derived by utilizing horizontal or vertical sample differences calculated on the basis of down-sampled neighboring luma sample values. In other words, the linear model may combine multiple scale parameters α associated with different pre-operations.

### Implicit Filter Shape Derivation

In one example, instead of explicitly signaling the selected filter shape index, the used direction oriented filter shape can be derived at decoder to save bit overhead. For example, at the decoder, a number of directional gradient filters may be applied for each reconstructed luma sample of the L-shaped template of the i-th neighboring row and column of the current block. Then the filtered values (gradients) may be accumulated for each direction of the number of directional gradient filters respectively. In an example, the accumulated value is an accumulated value of absolute values of corresponding filtered values. After the accumulation, the direction of the directional gradient filter for which the accumulated value is the largest may be determined as the derived (luma) gradient direction. For example, a Histogram of Gradients (HoG) may be built to determine the largest value. The derived direction can be further applied as the direction for predicting chroma samples in the current block.

The following example involves reusing the decoder-side intra mode derivation (DIMD) method for luma intra prediction included in ECM-4.0:
Step 1: applying 2 kinds of directional gradient filters (3×3 hor/ver Sobel) for each reconstructed luma sample of the L-shaped template of the 2^{nd} neighboring row and column of the current block;
Step 2: accumulating filtered values (gradients) by SAD (sum of absolute differences) for each of the directional gradient filters;
Step 3: Build a Histogram of Gradients (HoG) based on the accumulating filtered values; and
Step 4: The largest value in HoG is determined to be the derived (luma) gradient direction, based on which the GLM filter may be determined.

In one example, if the shape candidates are [−1, 0, 1; −1, 0, 1] (horizontal) and [1, 2, 1; −1, −2, −1] (vertical), when the largest value is associated with the horizontal shape, then use shape [−1, 0, 1; −1, 0, 1] for GLM based chroma prediction.

The gradient filter used for deriving the gradient direction can be the same or different with the GLM filter in shape. For example, both of the filters may be horizontal [−1, 0, 1; −1, 0, 1], or the two filters may have different shapes, while the GLM filter may be determined based on the gradient filter.

### Classification

The proposed GLM can be combined with above discussed MMLM or ELM. When combined with classification, each group can share or have its own filter shape, with syntaxes indicating shape for each group. For example, as a exemplary classifier, horizontal gradients grad_hor may be classified into a first group, which correspond to a first linear model, and vertical gradients grad_ver may be classified into a second group, which correspond to a second linear model. In one example, the horizontal luma patterns may be generated only once.

Further possible classifiers are also provided as follows. With the classifiers, the neighboring and internal luma-chroma sample pairs of the current video block may be classified into multiple groups based on one or more thresholds. Please note that, as discussed above, each neighboring/internal chroma sample and its corresponding luma sample may be referred to as a luma-chroma sample pair. The one or more thresholds are associated with intensities of neighboring/internal luma samples. In this case, each of the multiple groups corresponds to a respective one of the plurality of linear models.

When combining with MMLM classifier, the following operations may be performed: classifying neighboring reconstructed luma-chroma sample pairs of the current video block into 2 groups based on Threshold; deriving different linear models for different groups, wherein the deriving process may be GLM simplified, i.e., with the above pre-operations to reduce the number of taps; classifying luma-chroma sample pairs inside the CU (internal luma-chroma sample pairs, wherein each of the internal luma-chroma sample pairs comprises an internal chroma sample value to be predicted with the derived linear model) into 2 groups similarly based on Threshold; applying different linear models to the reconstructed luma samples in different groups; and predicting chroma samples in the CU based on different classified linear models.

$$\{ \begin{matrix}{pred}_{C} ( i , j ) = {α}_{1} \cdot {rec}_{L}^{′} ( i , j ) + {β}_{1} if {rec}_{L}^{′} ( i , j ) \leq Threshold \\ {pred}_{C} ( i , j ) = {α}_{2} \cdot {rec}_{L}^{′} ( i , j ) + {β}_{2} if {rec}_{L}^{′} ( i , j ) > Threshold\end{matrix}$$

wherein rec_{L}′(i, j) may be down-sampled reconstructed luma samples; rec_{C}(i, j) may be reconstructed chroma samples (note only neighbours are available); Threshold may be average value of the neighboring reconstructed luma samples. Note the number of classes (2) can be extended to multiple classes by increasing the number of Threshold (e.g., equally divided based on min/max of neighboring reconstructed (down-sampled) luma samples, fixed or signaled/switched in SPS/DPS/VPS/SEI/APS/PPS/PH/SH/Region/CTU/CU/Subblock/Sample levels).

In one example, instead of MMLM luma DC intensity, the filtered values of FLM/GLM apply on neighboring luma samples are used for classification. For example, if 1-tap (1, −1) GLM is applied, average AC values are used (physical meaning). The processing can be: classifying neighboring reconstructed luma-chroma sample pairs into K groups based on one or more filter shapes, one or more filtered values, and K−1 Threshold Ti; deriving different MLR models for different groups, wherein the deriving process may be GLM simplified, i.e., with the above pre-operations to reduce the number of taps; classifying luma-chroma sample pairs inside the CU (internal luma-chroma sample pairs, wherein each of the internal luma-chroma sample pairs comprises an internal chroma sample value to be predicted with the derived linear model) into K groups similarly based on one or more filter shapes, one or more filtered values, and K−1 Threshold Ti; applying different linear models to the reconstructed luma samples in different groups; predicting chroma samples in the CU based on different classified linear models. Wherein Threshold can be predefined (e.g., 0, or can be a table) or signaled/switched in SPS/DPS/VPS/SEI/APS/PPS/PH/SH/Region/CTU/CU/Subblock/Sample levels). For example, Threshold can be the average AC value (filtered value) (2 groups), or equally divided based on min/max AC (K groups), of neighboring reconstructed (can be down-sampled) luma samples.

It is also proposed to combine GLM with ELM classifier. As shown in FIGS. 24A to 24D, one filter shape (e.g., 1-tap) may be selected to calculate edge strengths. The direction is determined as a direction along which a sample difference between samples of the current and N neighboring samples (e.g., all 6 luma samples) is calculated. For example, the filter (shape [1, 0, −1; 1, 0, −1]) at the upper middle in FIG. 24A indicates a horizontal direction since a sample difference may be calculated between samples in the horizontal direction, while the filter below it (shape [1, 2, 1; −1, −2, −1]) indicates a vertical direction since a sample difference may be calculated between samples in the vertical direction. The positive and negative coefficients in each of the filters enable the calculation of the sample differences. The processing may then comprise: calculating one edge strength by the filtered value (e.g., equivalent); quantizing the edge strength into M segments by M−1 thresholds Ti; using K classes to classify the current sample. (e.g., K==M); deriving different MLR models for different groups, wherein the deriving process may be GLM simplified, i.e., with the above pre-operations to reduce the number of taps; classifying luma-chroma sample pairs inside the CU into K groups; applying different MLR models to the reconstructed luma samples in different groups; and predicting chroma samples in the CU based on different classified MLR models. Please note that the filter shape used for classification can be the same or different with the filter shape used for MLR prediction. Both and the number of thresholds M−1, the thresholds values Ti, can be fixed or signaled/switched in SPS/DPS/VPS/SEI/APS/PPS/PH/SH/Region/CTU/CU/Subblock/Sample levels. Moreover, other classifiers/combined-classifiers as discussed in ELM can also be used for FLM and/or GLM.

If classified samples in one group are less than a number (e.g., predefined 4), default values mentioned when discussing the matrix derivation for the MLR model can be applied for the group parameters (αᵢ, β). If the corresponding neighboring reconstructed samples are not available with respect to the selected LM modes, default values can be applied. For example, when MMLM_L mode is selected but left samples are not valid.

### Simplification and Unification

Several methods relate to simplification for GLM are introduced as follows for further improving coding efficiency.

The matrix/parameter derivation in FLM requires floating-point operation (e.g., division in closed-form), which is expensive for decoder hardware, so a fixed-point design is required. For 1-tap GLM case, it can be taken as modified luma reconstructed sample generation of CCLM (e.g., horizontal gradient direction, from CCLM [1, 2, 1; 1, 2, 1]/8 to GLM [−1, 0, 1; −1, 0, 1]), the original CCLM process can be reused for GLM, including fixed-point operation, MDLM down-sampling, division table, applied size restriction, min-max approximation, and scale adjustment. For all items, 1-tap GLM can have its own configurations or share the same design as CCLM. For example, using simplified min-max method to derive the parameters (instead of LMS), and combined with scale adjustment after GLM model is derived. In this case, the center point (luminance value yᵣ) used to rotate the slope becomes the average of the reference luma samples “gradient”. Another example, when GLM is on for this CU, CCLM slope adjustment is inferred off and don't need to signal slope adjustment related syntaxes.

This section takes typical case reference samples (up 1 row and left 1 column) for example. Note as in FIG. 23, extended reconstructed region can also use the simplification with the same spirit, and may be with syntax indicating the specific region (like MDLM, MRL).

Please note that the following aspects can be combined and applied jointly. For example, combining reference sample down-sampling and division table to perform the division process.

When classification (MMLM/ELM) is applied, each group can apply the same or different simplification operation. For example, samples for each group are padded respectively to the target sample number before applying right shift, and then apply the same derivation process, same division table.

Please note that the method of implicit filter shape derivation can also be used to determine whether to disable down-sampled process in CCCM filter coefficients (treat with/without down-sampled process as different filter shapes).

### Fixed-Point Implementation

The 1-tap case can reuse the CCLM design, dividing by n may be implemented by right shift, dividing by A₂ may be implemented by a LUT. The integerization parameters, including n_{α}, N_{A}_{₁}, N_{A}_{₂}, r_{A}_{₁}, r_{A}_{₂} n_{table} involved in the integerization design of LMS CCLM and intermediate parameters for deriving the linear model (equations (19)-(20)) can be the same as CCLM or have different values, to have more precision. The integerization parameters can be predefined or signaled/switched in SPS/DPS/VPS/SEI/APS/PPS/PH/SH/Region/CTU/CU/Subblock/Sample levels, can be conditioned on sequence bitdepth. For example, n_{table}=bitdepth+4.

### Mdlm Down-Sample

When GLM is combined with MDLM, the existed total samples used for parameter derivation may not be power-of-2 values, and need padding to power-of-2 to replace division with right shift operation. For example, for an 8×4 chroma CU, MDLM needs W+H=12 samples, with MDLM_T only 8 samples are available (reconstructed), then down-sampled 4 samples (0, 2, 4, 6) may be padded equally. Codes for implementing such operations are shown as follows:

```
int targetSampNum = 1 << ( floorLog2( existSampNum − 1 ) + 1 );
if (targetSampNum != existSampNum)//if existSampNum not a value of power of 2
{
  xPadMdlmTemplateSample;
}
int step = (int)(existSampNum / sampNumToBeAdd);
for (int i = 0; i < sampNumToBeAdd; i++)
{
  pTempSrc[i] = pSrc[i * step];
  pTempCur[i] = pCur[i * step];
}
```

Other padding method like repetitive/mirror padding with respect to last neighboring samples (rightmost/lowermost) can also be applied.

The padding method for GLM can be the same or different with that of CCLM.

Note in ECM version, an 8×4 chroma CU MDLM_T/MDLM_L needs 2T/2L=16/8 samples respectively, in such case, same padding method can be applied to meet the target power-of-2 sample number.

### Division LUT

Division LUT proposed for CCLM/LIC (Local Illumination Compensation) in known standard development like AVC/HEVC/AV1/VVC/AVS can be used for GLM division. For example, reusing the LUT in JCTVC-I0166 for bitdepth=10 case (Table 4). The division LUT can be different from CCLM. For example, CCLM uses min-max with DivTable as in equation 5, but GLM uses 32-entries LMS division LUT as in Table 5.

When GLM is combined with MMLM, the meanL values may not always be positive (e.g., using filtered/gradient values to classify groups), so sgn(meanL) needs to be extracted, and use abs(meanL) to look-up the division LUT. Note division LUT used for MMLM classification and parameter derivation can be different. For example, using lower precision LUT (as the LUT in min-max) for mean classification, and using higher precision LUT (as in the LMS) for parameter derivation.

### Size Restriction and Latency Constraint

Similar to the CCLM design, some size restrictions can be applied for ELM/FLM/GLM. For example, same constraint for luma-chroma latency in dual tree may be applied.

The size restriction can be according to the CU area/width/height/depth. The threshold can be predefined or signaled in SPS/DPS/VPS/SEI/APS/PPS/PH/SH/Region/CTU/CU/Subblock/Sample levels. For example, the predefined threshold may be 128 for chroma CU area.

In one example, the at least one pre-operation is performed in response to determining that the video block meets an enabling threshold, wherein the enabling threshold is associated with area, width, height or partition depth of the video block. Specifically, the enabling threshold may define a minimum or maximum area, width, height or partition depth of the video block. As understood by one skilled in the art, the video block may comprise a current chroma block and its collocated luma block. It is also proposed to apply the above enabling threshold for the current chroma block and its collocated luma block jointly. For example, the at least one pre-operation is performed in response to determining the enabling threshold is met for both the current chroma block and its collocated luma block.

### Line Buffer Reduction

Similar to the CCLM design, if the collocated luma area of the current chroma CU contains the 1st row inside one CTU, the top template samples generation can be limited to 1 row, to reduce CTU row line buffer storage. Note that only one luma line (general line buffer in intra prediction) is used to make the down-sampled luma samples when the upper reference line is at the CTU boundary.

For example, in FIG. 22, if the collocated luma area of the current chroma CU contains the 1st row inside one CTU, top template can be limited to only use 1 row (but not 2) for parameter derivation (other CUs can still use 2 rows). This saves luma sample line buffer storage when processing CTU row by row at decoder hardware. Several methods can be used to achieve the line buffer reduction. Note the example of limited “1” row can be extended to N rows with similar operations. Similarly, 2-tap or multi-tap can also apply such operations. When applying multi-tap, chroma samples may also need to apply operations.

For example, take the 1-tap filter [1, 0, −1; 1, 0, −1] shown in FIG. 24A as an example for illustration. This filter can be reduced to [0, 0, 0; 1, 0, −1], i.e., only use below row coefficients. Alternatively, the limited upper row luma samples can be padded (repetitive, mirror, 0, meanL, meanC . . . , etc.) from the bellow row luma samples.

Take an example where N=4, that is, the video block is at a top boundary of a current CTU, while top 4 rows of neighboring luma sample values and corresponding chroma sample values are used for deriving the linear model. Please note that, the corresponding chroma sample values may refer to corresponding top 4 rows of neighboring chroma sample values (for example, for the YUV 4:4:4 format). Alternatively, the corresponding chroma sample values may refer to corresponding top 2 rows of neighboring chroma sample values (for example, for the YUV 4:2:0 format). In this case, the top 4 rows of neighboring luma sample values and corresponding chroma sample values may be divided into two regions—a first region comprising valid sample values (for example, the one nearest row of luma sample values and corresponding chroma sample values) and a second region comprising invalid sample values (for example, the other three rows of luma sample values and corresponding chroma sample values). Then coefficients of the filter corresponding to sample positions not belonging to the first region may be set as zeros, such that only sample values from the first region are used for calculating the sample differences. For example, as discussed above, in this case the filter [1, 0, −1; 1, 0, −1] can be reduced to [0, 0, 0; 1, 0, −1]. Alternatively, the nearest sample values in the first region may be padded to the second region, such that the padded sample values may be used to calculate the sample differences.

### Fusion of Chroma Intra Prediction Modes

In one example, since GLM can be taken as one special CCLM mode, the fusion design can be reused or have its own way. Multiple (two or more) weights can be applied to generation the final predictor. For example,

$$pred = ( w 0 * pred 0 + w 1 * pred 1 + ( 1 ≪ ( shift - 1 ) ) ) ≫ shift$$

wherein pred0 is the predictor based on non-LM mode, while pred1 is the predictor based on GLM, or
pred0 is the predictor based on one of CCLM (including all MDLM/MMLM), while pred1 is the predictor based on GLM, or
pred0 is the predictor based on GLM, while pred1 is the predictor based on GLM.

Different I/P/B slices can have different designs for weights, w0 and w1, depending on if neighboring blocks is coded with CCLM/GLM/other coding mode or the block size/width/height.

For example, the designs for weights can be determined by the intra prediction mode of adjacent chroma blocks and shift is set equal to 2. Specifically, when the above and left adjacent blocks are both coded with LM modes, then {w0, w1}={1, 3}; when the above and left adjacent blocks are both coded with non-LM modes, then {w0, w1}={3, 1}; otherwise, {w0, w1}={2, 2}. For non-I slices, w0 and w1 can both be set equal to 2.

For the syntax design, if a non-LM mode is selected, one flag is signaled to indicate whether the fusion is applied.

### 1-Tap Linear Model

As described above, the 1-tap GLM has good gain complexity trade-off since it can reuse the existing CCLM module without introducing additional derivation. Such 1-tap design can be extended or generalized further according to one or more aspects of the present disclosure.

In an aspect of the present disclosure, for a chroma sample to be predicted, one single corresponding luma sample L may be generated by combining collocated luma sample and neighboring luma samples. For example, the combination may be a combination of different linear filters, e.g., a combination of a high-pass gradient filter (GLM) and a low-pass smoothing filter (e.g., [1, 2, 1; 1, 2, 1]/8 FIR down-sampling filter that may be generally used in CCLM); and/or a combination of a linear filter and a non-linear filter (e.g., with power of n, e.g., Lⁿ, n can be positive, negative, or +-fractional number (e.g., +½, square root or +3, cube, which can rounding and rescale to bitdepth dynamic range)).

In an aspect of the present disclosure, the combination may be repeatedly applied. For example, a combination of GLM and [1, 2, 1; 1, 2, 1]/8 FIR may be applied on the reconstructed luma samples, and then a non-linear power of ½ may be applied. For example, the non-linear filter may be implemented as LUT (look up table), e.g., for bitDepth=10, power of n, n=½, LUT [i]=(int) (sqrt (i)+0.5)<<5, i=0˜1023, where 5 is to scale to bitdepth=10 dynamic range. The non-linear filter may provide options when linear filter cannot handle the luma-chroma relationship efficiently. Whether to use non-linear term can be predefined or signaled/switched in SPS/DPS/VPS/SEI/APS/PPS/PH/SH/Region/CTU/CU/Subblock/Sample levels.

In the above one or more aspects of the present disclosure, the GLM may refer to Generalized Linear Model (may be used to generate one single luma sample linearly or non-linearly, and the generated one single luma sample may be fed into the CCLM linear model to derive parameters of the CCLM linear model), linear/non-linear generation may be called general patterns. Different gradient or general patterns can be combined to form another pattern. For example, a gradient pattern may be combined with a CCLM down-sampled value; a gradient pattern may be combined with a non-linear L2 value; a gradient pattern may be combined with another gradient pattern, the two gradient patterns to be combined may have different directions or the same direction, e.g., [1, 1, 1; −1, −1, −1] and [1, 2, 1; −1, −2, −1], which both have a vertical direction, may be combined, also [1, 1, 1; −1, −1, −1] and [1, 0, −1; 1, 0, −1], which have a vertical and horizontal directions, may be combined, as shown in FIGS. 24A to 24D. The combination may comprise plus, minus, or linear weighted.

### Glm Applied on Down-Sampled Domain

As described above, pre-operations can be applied repeatedly and GLM can be applied on pre linear weighted/pre-operated samples. For example, as CCLM, one template filtering can be applied to luma samples, in order to remove outliers using the low-pass smoothing FIR filter [1, 2, 1; 1, 2, 1]/8 (i.e., CCLM down-sampling smoothing filter) and to generate down-sampled luma samples (one down-sampled luma sample corresponding to one chroma sample). And after that, 1-tap GLM can be applied on smoothed down-sampled luma samples to derive the MLR model.

Some gradient filter patterns, such as 3×3 Sobel or Prewitt operators, can be applied on down-sampled luma samples. The following table shows some of the gradient filter patterns.

| Gradient filter pattern | Filter shape |
|---|---|
| 0 | [1, 0, −1; |
| | 2, 0, −2; |
| | 1, 0, −1] |
| 1 | [1, 2, 1; |
| | 0, 0, 0; |
| | −1, −2, −1] |
| 2 | [2, 1, 0; |
| | 1, 0, −1; |
| | 0, −1, −2] |
| 3 | [0, 1, 2; |
| | −1, 0, 1; |
| | −2, −1, 0] |
| 4 | [0, 1, −1; |
| | 0, |
| | 2, −2; |
| | 0, 1, −1] |
| 5 | [0, 0, 0; |
| | 1, 2, 1; |
| | −1, −2, −1] |
| 6 | [0, 0, 0; |
| | 0, 2, 0; |
| | 0, 0, −2] |
| 7 | [0, 0, 0; |
| | 0, 2, 0; |
| | −2, 0, 0] |
| 8 | [1, −1, 0; |
| | 2, −2, 0; |
| | 1, −1, 0] |
| 9 | [1, 2, 1; |
| | −1, −2, −1; |
| | 0, 0, 0] |
| 10 | [2, 0, 0; |
| | 0, −2, 0; |
| | 0, 0, 0] |
| 11 | [0, 0, 2; |
| | 0, −2, 0; |
| | 0, 0, 0] |
| 12 | [0, 0, 0; |
| | 2, 0, −2; |
| | 0, 0, 0] |
| 13 | [0, 2, 0; |
| | 0, 0, 0; |
| | 0, −2, 0] |
| 14 | [2, 0, 0; |
| | 0, 0, 0; |
| | 0, 0, −2] |
| 15 | [0, 0, 2; |
| | 0, 0, 0; |
| | −2, 0, 0] |

The gradient filter patterns can be combined with other gradient/general filter patterns in the down-sampled luma domain. In one example, a combined filter pattern may be applied on down-sampled luma samples. For example, the combined filter pattern may be derived by performing addition or subtraction operations to respective coefficients of the gradient filter pattern and a DC/low-pass based filter pattern, such as filter pattern [0, 0, 0; 0, 1, 0; 0, 0, 0], or [1, 2, 1; 2, 4, 1; 1, 2, 1]. In another example, the combined filter pattern is derived by performing addition or subtraction operations to a coefficient of the gradient filter pattern and a non-linear value such as L². In another example, the combined filter pattern is derived by performing addition or subtraction operations to respective coefficients of the gradient filter pattern and another gradient filter pattern having a different or the same direction. In another example, the combined filter pattern is derived by performing linear weighted operations to the coefficients of the gradient filter pattern.

GLM applied on down-sampled domain can fit in CCCM framework but may sacrifice high frequency accuracy since low-pass smoothing is applied before applying GLM.

### Glm Serves as Input of CCCM

As illustrated above, CCCM applies luma down-sampling before convolution as with CCLM. The reconstructed luma samples are down-sampled to match the lower resolution chroma grid when chroma sub-sampling is used. Since 1-tap GLM can also be taken as changing CCLM down-sample filter coefficients (e.g., from [1, 2, 1; 1, 2, 1]/8 to [1, 2, 1, −1, −2, −1], i.e., from low-pass to high-pass), the GLM can serve as the input of CCCM. Specifically, the gradient filter of GLM replaces luma down-sampling filter ([1, 2, 1; 1, 2, 1]/8) with gradient-based coefficients (e.g., [1, 2, 1, −1, −2, −1). In this case, CCCM operation becomes “linear/non-linear combination of gradients”, as shown by the following equation:

predChromaVal=c₀C+c₁N+c₂S+c₃E+c₄W+c₅P+c₆B

where C, N, S, E, W, P are gradients of current or neighboring samples (compared to original down-sample values for CCCM). Related GLM methods described in this disclosure can be applied in the same way before entering CCCM convolution, e.g., classification, separate Cb/Cr control, syntax, pattern combining, PU size restriction etc.

The gradient-based coefficients replacement can apply to specific CCCM taps. Also, not only high-pass but low-pass/band-pass/all-pass coefficients replacement can be used. The replacement can be combined with FLM/CCCM shape switch discussed above (leading to different number of taps). For example, gradient patterns in FIGS. 24A to 24D can be used for replacement. In one example, the operations for applying GLM as input of CCCM includes: predefining one or more coefficients candidates for CCCM/FLM down-sampling; determining CCCM/FLM filter shape and number of filter taps for this CU; applying different CCLM down-sample coefficients to different filter taps, wherein the coefficients can be high-pass filters (GLM), or low-pass/band-pass/all-pass filters; generating the down-sampled luma samples (using the applied coefficients) for CCCM input samples; and feeding the generated down-sampled luma samples into CCCM process.

The following shows some examples for changing the CCLM down-sample filter coefficients:

### Example 1

Candidate filters are [1, 2, 1; 1, 2, 1]/8 and [1, 0, −1; 1, 0, −1]; predChromaVal=c₀C+c₁N+c₂S+c₃E+c₄W+c₅P+c₆B, using typical CCCM cross shape, 7-tap; N, S, W, E use filters [1, 2, 1; 1, 2, 1]/8, keeping original CCLM down-sampling filter; and C, P use filters [1, 0, −1; 1, 0, −1], i.e., horizontal gradient filter, and P then physically means gradient\hat{ }2.

### Example 2

Candidate filters are [1, 2, 1; 1, 2, 1]/8, [1, 0, −1; 1, 0, −1], [1, 2, 1; −1, −2, −1], [2, 1, −1; 1, −1, −2], and [−1, 1, 2; −2, −1, 1]; predChromaVal=c₀C₀+c₁C₁+c₂C₂+c₃C₃+c₄C₄+c₅P+c₆B; C₀ uses filter [1, 2, 1; 1, 2, 1]/8, keeping original CCLM down-sampling filter; C₁ uses filter [1, 0, −1; 1, 0, −1]; C₂ uses filter [1, 2, 1; −1, −2, −1]; C₃ uses filter [2, 1, −1; 1, −1, −2]; C₄ uses filter [−1, 1, 2; −2, −1, 1]; C₅ uses filter [1, 2, 1; 1, 2, 1]/8, keeping original CCLM down-sampling filter; C₀ to C₅, and P have the same down-sampled luma position (==C in typical CCCM cross shape); and C₁ to C₄ are generated by different direction Sobel-based gradient filters (as shown in FIGS. 24A to 24D).

### Example 3

Candidate filters are [1, 2, 1; 1, 2, 1]/8, [1, 0, −1; 1, 0, −1], [1, 2, 1; −1, −2, −1], [0, 1, 1; 0, 1, 1], and [1, 1, 0; 1, 1, 0]; predChromaVal=c₀C₀+c₁C₁+c₂C₂+c₃C₃+c₄C₄+c₅P+c₆B; C₀ uses filter [1, 2, 1; 1, 2, 1]/8, keeping original CCLM down-sampling filter; C₁ uses filter [1, 0, −1; 1, 0, −1]; C₂ uses filter [1, 2, 1; −1, −2, −1]; C₃ uses filter [0, 1, 1; 0, 1, 1]; C₄ uses filter [1, 1, 0; 1, 1, 0]; C₅ uses filter [1, 2, 1; 1, 2, 1]/8, keeping original CCLM down-sampling filter; C₀ to C₅, and P have the same down-sampled luma position (==C in typical CCCM cross shape); C₁ to C₂ are generated by different direction Sobel-based gradient filters (as shown in FIGS. 24A to 24D); and C₃ to C₄ are generated by low-pass filters.

Which CCCM/FLM taps to apply the coefficients replacement can be predefined (as above examples) or signaled/switched in SPS/DPS/VPS/SEI/APS/PPS/PH/SH/Region/CTU/CU/Subblock/Sample levels.

For each CCCM/FLM tap, the coefficients candidate for CCCM/FLM down-sampling can be predefined or signaled/switched in SPS/DPS/VPS/SEI/APS/PPS/PH/SH/Region/CTU/CU/Subblock/Sample levels.

### Example 4

Candidate filters are [1, 2, 1; 1, 2, 1]/8, [1, 0, −1; 1, 0, −1], [1, 2, 1; −1, −2, −1], [2, 1, −1; 1, −1, −2], and [−1, 1, 2; −2, −1, 1]; predChromaVal=c₀C+c₁N+c₂S+c₃E+c₄W+c₅P+c₆B, using typical CCCM cross shape, 7-tap; C uses switching down-sampling filters among 5 candidate filters; N, S, W, E use filter [1, 2, 1; 1, 2, 1]/8, keeping original CCLM down-sampling filter; and P uses switching down-sampling filters among 5 candidate filters.

### Example 5

Candidate filters are: [1, 2, 1; 1, 2, 1]/8, [1, 0, −1; 1, 0, −1], [1, 2, 1; −1, −2, −1], [0, 1, 1; 0, 1, 1], and [1, 1, 0; 1, 1, 0]; predChromaVal=c₀C+c₁W+c₂E+c₃P+c₄B, i.e., horizontal minus sign shape, 5-tap; C uses switching down-sampling filters among 5 candidate filters; W, E use switching down-sampling filters among 3 candidate filters: [1, 2, 1; 1, 2, 1]/8, [0, 1, 1; 0, 1, 1], and [1, 1, 0; 1, 1, 0]; and P uses filter [1, 2, 1; 1, 2, 1]/8, keeping original CCLM down-sampling filter.

### Syntax

In one or more aspects of the present disclosure, one or more syntaxes may be introduced to indicate information on the GLM. An example of GLM syntaxes is illustrated in the following Table 10.

TABLE 10

| Level | Syntax element | Binarization | Meaning |
|---|---|---|---|
| SPS | glm_enabled_flag | FLC | whether GLM is enabled in the |
| | | | sequence, can be inferred off |
| | | | when chromaFormat == |
| | | | CHROMA_400, or CCLM is off |
| PH/SH | ph_glm_flag | FLC | whether GLM is enabled in this |
| | ph_glm_cb_flag | | picture/slice for Cb/Cr, can be |
| | ph_glm_cr_flag | | inferred off when chromaFormat == |
| | | | CHROMA_400, or CCLM is |
| | | | off, one flag can be added to |
| | | | jointly control “if either Cb/Cr is |
| | | | on” |
| PH/SH | ph_glm_ctb_control_flag | FLC | whether to enable Cb/Cr on/off |
| | ph_glm_cb_ctb_control_flag | | control at CTB level, one flag can |
| | ph_glm_cr_ctb_control_flag | | be added to jointly control “if |
| | | | either Cb/Cr is enable on/off |
| | | | control at CTB level” |
| CTU | ctb_glm_flag | CABAC | whether GLM can be enabled for |
| | ctb_glm_cb_flag | | the current Cb or Cr CTB, can be |
| | ctb_glm_cr_flag | | CABAC bypass coded or with N |
| | | | contexts (2: up/left, or N |
| | | | neighboring CTBs), one flag can |
| | | | be added to jointly control “if |
| | | | either Cb/Cr can be enabled” |
| CU | cu_glm_flag | CABAC, TU | whether GLM is enabled for the |
| | cu_glm_cb_flag | | current Cb or Cr CU, can be |
| | cu_glm_cr_flag | | CABAC bypass coded or with N |
| | | | contexts (2: up/left, or N |
| | | | neighboring CUs), one flag can be |
| | | | added to jointly control “if either |
| | | | Cb/Cr can be enabled” |
| CU | glm_cb_filter_idx | CABAC, TU, | which filter shape idx (gradient |
| | glm_cr_filter_idx | FLC | pattern) (in the predefined set) is |
| | | | used for the CU, can be CABAC |
| | | | bypass coded or with N contexts |
| | | | (2: up/left, or N neighboring |
| | | | CUs), as stated in FLM syntax, |
| | | | Cb/Cr can have its own filter |
| | | | shape idx (gradient pattern) or |
| | | | share the same filter shape. |
| CU | glm_cb_mdlm_idx | CABAC, TU | which MDLM idx (GLM, |
| | glm_cr_mdlm_idx | | GLM_L, GLM_T) is used for the |
| | | | CU, can be CABAC bypass coded |
| | | | or with N contexts (2: up/left, or |
| | | | N neighboring CUs) |
| CU | glm_cb_mrl_idx | CABAC, TU | which GLM MRL idx (e.g., 0, 1) |
| | glm_cr_mrl_idx | | is used for the CU, can be |
| | | | CABAC bypass coded or with N |
| | | | contexts (2: up/left, or N |
| | | | neighboring CUs) |

FLC: fixed length code
TU: truncated unary code
EGk: exponential-golomb code with order k, where k can be fixed or signaled/switched in SPS/DPS/VPS/SEI/APS/PPS/PH/SH/Region/CTU/CU/Subblock/Sample levels.
SVLC: signed EG0
UVLC: unsigned EG0

Please be noted that the binarization of each syntax element may be changed.

In an aspect of the present disclosure, The GLM on/off control for Cb/Cr components may be jointly or separately. For example, at CU level, 1 flag may be used to indicate if GLM is active for this CU. If active, 1 flag may be used to indicate if Cb/Cr are both active. If not both active, 1 flag to indicate either Cb or Cr is active. Filter index/gradient (general) pattern may be signaled separately when Cb and/or Cr is active. All flags may have its own context model or be bypass coded.

In another aspect of the present disclosure, whether to signal GLM on/off flags may depend on luma/chroma coding modes, and/or CU size. For example, in ECM5 chroma intra mode syntax, GLM may be inferred off when MMLM or MMLM_L or MMLM_T is applied; when CU area<A, where A can be predefined or signaled/switched in SPS/DPS/VPS/SEI/APS/PPS/PH/SH/Region/CTU/CU/Subblock/Sample levels; If combined with CCCM, GLM may be inferred off when CCCM is on.

Please be noted that when GLM is combined with MMLM, different models may share the same or have their own gradient/general patterns.

| | | |
|---|---|---|
| intra_chroma_pred_mode | bin string | chroma intra mode |

| | | | |
|---|---|---|---|
| 10 | 77 | 00 | DM |
| 11 | | 010 | DIMD_CHROMA |
| 0 | | 01100 | PLANAR |
| 1 | | 01101 | VER |
| 2 | | 01110 | HOR |
| 3 | | 01111 | DC |
| 4 | 67 | 10 | LM |
| 5 | 68 | 110 | MMLM |
| 6 | 69 | 1110 | LM_L |
| 7 | 71 | 11110 | LM_T |
| 8 | 70 | 111110 | MMLM_L |
| 9 | 72 | 111111 | MMLM_T |

When GLM is combined with CCCM/FLM, CU level GLM enabling flag can be inferred off if current CU is enabled as CCCM/FLM.
hasGlmFlag &=!pu.cccmFlag;

### CCCM Without Down-Sampled Process

CCCM requires to process down-sampled luma reference values before the calculation of model parameters and applying the CCCM model, which burden decoder processing cycles. In this section, CCCM without down-sampling process is proposed, including utilizing non-down-sampled luma reference values and/or different selection of non-down-sampled luma reference. One or more filter shapes may be used for the purpose as described below.

In one example, the convolutional 7-tap filter may include a 5-tap plus sign shape spatial component, a non-linear term and a bias term. The input to the spatial 5-tap component of the filter includes a center (C) non-down-sampled luma sample which is collocated with the chroma sample to be predicted and its non-down-sampled above or north (N), below or south(S), left or west (W) and right or east (E) neighbors as illustrated in FIG. 17.

The non-linear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

In another example, the convolutional 7-tap filter may include a 6-tap rectangle shape spatial component and a bias term. The input to the spatial 6-tap component of the filter includes a center (b) non-down-sampled luma sample which is collocated with the chroma sample to be predicted and its non-down-sampled below-left or south-west (d), below-right or south-east (f), below or south (e), left or west (a) and right or east (c) neighbors as illustrated Shape 1 in FIG. 25.

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} B$$

In yet another example, the convolutional 8-tap filter may consist of a 6-tap rectangle shape spatial component, a non-linear term and a bias term. The input to the spatial 6-tap component of the filter consists of a center (b) non-down-sampled luma sample which is collocated with the chroma sample to be predicted and its non-down-sampled below-left or south-west (d), below-right or south-east (f), below or south (e), left or west (a) and right or east (c) neighbors as illustrated Shape 1 in FIG. 25.

The non-linear term P is represented as power of two of the center luma sample (b) and scaled to the sample value range of the content:

$$P = ( b * b + midVal ) ≫ bitDepth$$

That is, for 10-bit content it is calculated as:

$$P = ( b * b + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} P + {c}_{7} B$$

It should be appreciated that the examples illustrated above are merely sample examples, and other implementations may be possible without causing a departure of the present disclosure, such as, with more or less taps and having any shape of the shapes shown in FIG. 25 (where the chroma sample to be predicted is represented as a circle).

In yet another example, the convolutional 9-tap filter may consist of a 6-tap rectangle shape spatial component, two non-linear terms and a bias term. The input to the spatial 6-tap component of the filter consists of a center (b) non-down-sampled luma sample which is collocated with the chroma sample to be predicted and which is located substantially at the center of the filter shape, and its non-down-sampled below-left/south-west (d), below-right/south-east (f), below/south (e), left/west (a) and right/east (c) neighbors as illustrated Shape 1 in FIG. 25.

The non-linear terms P and Q are two non-linear luma sample values, which are represented respectively as power of the luma sample value of the center (b) luma sample and the below/south (e) luma sample then scaled to the sample value range of the content:

$$\begin{matrix}P = ( b * b + midVal ) ≫ bitDepth ; \\ Q = ( e * e + midVal ) ≫ bitDepth .\end{matrix}$$

That is, for 10-bit content it is calculated as:

$$\begin{matrix}P = ( b * b + 512 ) ≫ 10 ; \\ Q = ( e * e + 512 ) ≫ 10.\end{matrix}$$

The bias term B is a bias value which represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} P + {c}_{7} Q + {c}_{8} B$$

It should be understood that the non-linear terms P and Q can be represented as power of any luma sample values of the non-down-sampled luma sample of the filter. The two non-linear terms P and Q are only exemplary, and the corresponding chroma sample value can be calculated based on one or more non-linear values.

In yet another example, as shown in FIG. 30, the convolutional 9-tap filter may include 6-tap spatial terms, two non-linear terms and a bias term. The 6-tap spatial terms correspond to 6 neighboring luma samples (i.e., L₀, L₁, . . . , L₅) to the chroma sample (i.e., the triangle in FIG. 30) to be predicted. Please note that two neighboring original reconstructed luma samples used in non-linear terms may be replaced by any two neighboring original reconstructed luma samples, i.e., without down-sampling as shown in FIG. 30 (i.e., L₀, L₁, . . . , L₅).

$$predChromaVal = {\sum }_{i = 0}^{5} {α}_{i} \cdot {L}_{i} + {\sum }_{i = 6}^{7} {α}_{i} \cdot ( ( {( {L}_{i - 4} )}^{2} + β ) ≫ bitDepth ) + {α}_{8} \cdot β$$

where αᵢ is the coefficient associated with Lᵢ and β is the offset. Same to the existing CCCM design, up to 6 lines/columns of chroma samples above and left to the current CU are applied to derive the filter coefficients. The filter coefficients are derived based on the same LDL decomposition method used in CCCM. The convolutional 9-tap filter may be signaled as one extra CCCM model besides the existing CCCM model. For signaling, when the CCCM is selected, one single flag is signaled and used for both two chroma components to indicate whether the default CCCM model or the proposed extra CCCM model is applied.

In yet another example, the convolutional N-tap (N is an integer and larger than 1) filter may consists of (N−1−M)-tap (M is an integer) spatial terms, M non-linear terms and a bias term. The (N−1−M)-tap spatial terms correspond to neighboring luma samples (i.e., L₀, L₁, . . . , L_{N-1-M}) to the chroma sample to be predicted. Please note that neighboring original reconstructed luma samples used in spatial terms and non-linear terms may be replaced by any neighboring original reconstructed luma samples, i.e., without down-sampling (i.e., L₀, L₁, . . . , L_{N-1-M}).

$$predChromaVal = {\sum }_{i = 0}^{N - 1 - M} {α}_{i} \cdot {L}_{i} + {\sum }_{i = 0}^{M} {α}_{i + N - M} \cdot ( ( {( {L}_{i} )}^{2} + β ) ≫ bitDepth ) + {α}_{N + 1} \cdot β$$

where αᵢ is the coefficient associated with Lᵢ and β is the offset. Same to the existing CCCM design, up to 6 lines/columns of chroma samples above and left to the current CU are applied to derive the filter coefficients. The filter coefficients are derived based on the same LDL decomposition method used in CCCM. The method may be signaled as one extra CCCM model besides the existing CCCM model. For signaling, when the CCCM is selected, one single flag is signaled and used for both two chroma components to indicate whether the default CCCM model or the proposed extra CCCM model is applied.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above (more taps), to have a better performance with certain complexity trade-off.

In this disclosure, reference samples/training templates/reconstructed neighboring regions usually refer to the luma samples used for deriving the MLR model parameters, which are then applied to the inner luma samples in one CU, to predict the chroma samples in the CU.

According to one or more embodiments of the disclosure, the reference samples/training template/reconstructed neighboring region may be predefined or signaled/switched in SPS/DPS/VPS/SEI/APS/PPS/PH/SH/Region/CTU/CU/Subblock/Sample levels. For an example, FIG. 9A shows an example that L-shape reconstructed region, left/top reconstructed region to derive parameters.

According to one or more embodiments of the disclosure, the non-down-sampled luma reference values may be predefined or signaled/switched in SPS/DPS/VPS/SEI/APS/PPS/PH/SH/Region/CTU/CU/Subblock/Sample levels. For an example, to predict chroma sample values based on corresponding non-down-sampled luma reference values, the collocated non-down-sampled luma reference values may be represented by pDsY[x][y] with x=0 . . . nTbW−1, y=0 . . . nTbH−1, where a variable nTbW specifying the transform block width and a variable nTbH specifying the transform block height, wherein pDsY[x][y] are derived as equal to the collocated luma sample values pY[x][y] with x=0 . . . nTbW*SubWidthC−1, y=0 . . . nTbH*SubHeightC−1, i.e., pDsY[x][y] are set equal to the reconstructed luma sample values prior to the deblocking filter process at the locations (xTbY+x, yTbY+y). The factors SubWidthC and SubHeightC are the width/height scale factors corresponding to the chroma format of the current block respectively.

The boundary luma samples pY[x][y] for the boundary part of the block are derived as follows:
When availL is equal to TRUE (i.e., the left luma sample values are available), the boundary luma samples pY[x][y] with x=−3 . . . 1, y=(availT?−1:0) . . . SubHeightC*Max (nTbH, numSampL)−1, are set equal to the reconstructed luma samples prior to the deblocking filter process at the locations (xTbY+x, yTbY+y).
When availT is equal to FALSE (i.e., the top luma sample values are unavailable), the boundary luma samples pY[x][y] with x=−2 . . . SubWidthC*nTbW−1, y=−2 . . . 1, are set equal to the luma samples pY[x][0].
When availT is equal to TRUE (i.e., the top luma sample values are available), the boundary luma samples pY[x][y] with x=(availL?−1:0). SubWidthC*Max(nTbW, numSampT)−1, y=−3 . . . −1, are set equal to the reconstructed luma samples prior to the deblocking filter process at the locations (xTbY+x, yTbY+y).
When availL is equal to FALSE (i.e., the left luma sample values are unavailable), the boundary luma samples pY[x][y] with x=−1, y=−2 . . . SubHeightC*nTbH−1, are set equal to the reconstructed luma samples pY[0][y].

In an example, to predict the chroma sample value for the chroma sample with coordinates (x, y), the central non-down-sampled collocated luma samples pDsY[x][y] with x=0 . . . nTbW−1, y=0 . . . nTbH−1 are determined based on the chroma format of the block, and derived as follows:
If both SubWidthC and SubHeightC are equal to 1 (i.e., the chroma format being 4:4:4), the following applies:

$$pDsY [ x ] [ y ] = pY [ SubWidthC * x ] [ SubHeightC * y ] = pY [ x ] [ y ] ;$$

Otherwise, if SubHeightC is equal to 1 and SubWidthC is equal to 2 (i.e., the chroma format being 4:2:2), the following applies:

$$pDsY [ x ] [ y ] = pY [ SubWidthC * x ] [ SubHeightC * y ] = pY [ 2 * x ] [ y ] ;$$

Otherwise, if SubHeightC is equal to 2 and SubWidthC is equal to 1 (i.e., the chroma format being 4:2:2), the following applies:

$$pDsY [ x ] [ y ] = pY [ SubWidthC * x ] [ SubHeightC * y ] = pY [ x ] [ 2 * y ] ;$$

Otherwise, if both SubWidthC and SubHeightC are equal to 2 (i.e., the chroma format being 4:2:0), the following applies:

$$pDsY [ x ] [ y ] = pY [ SubWidthC * x ] [ SubHeightC * y ] = pY [ 2 * x ] [ 2 * y ] ;$$

In an example, the variables SubWidthC and SubHeightC are specified in the following table, depending on the chroma format sampling structure, which is specified through sps_chroma_format_idc. An additional flag (e.g., sps_chroma_vertical_collocated_flag) may be used to indicate the chroma format 4:2:2 where SubWidthC is equal to 1 and SubHeightC is equal to 2.

| sps_chroma_format_idc | Chroma format | SubWidthC | SubHeightC |
|---|---|---|---|
| 0 | Monochrome | 1 | 1 |
| 1 | 4:2:0 | 2 | 2 |
| 2 | 4:2:2 | 2 | 1 |
| 3 | 4:4:4 | 1 | 1 |

According to one or more embodiments of the disclosure, the luma offset may be removed when the non-down-sampled luma reference values are used. For an example, the samples values used in both model creation and final prediction (i.e., luma and chroma in the reference area, and luma in the current block) are reduced by these fixed values, as follows: Lᵢ′=Lᵢ—offsetLuma, where Lᵢ′ are the new terms for chroma sample prediction, and reference sample values for the sample above and to the left of the top-left sample of the block are used as the offsets (offsetLuma, offsetCb and offsetCr).

In another example, as shown in FIG. 30, the convolutional N-tap (N is an integer and larger than 1) filter may consists of (N−1−M)-tap (M is an integer) spatial terms, M non-linear terms and a bias term. The (N−1−M)-tap spatial terms correspond to neighboring luma samples (i.e., L₀, L₁, . . . , L₅) to the chroma sample to be predicted, reduced by offsetLuma. Please note that neighboring original reconstructed luma samples used in spatial terms and non-linear terms may be replaced by any neighboring original reconstructed luma samples, i.e., without down-sampling as shown in FIG. 30 (i.e., L₀, L₁, . . . , L₅).

$$predChromaVal = {\sum }_{i = 0}^{N - 1 - M} {α}_{i} \cdot ( {L}_{i} - offsetLuma ) + {\sum }_{i = 0}^{M - 1} {α}_{i + N - M} \cdot ( ( {( {L}_{i} - offsetLuma )}^{2} + β ) ≫ bitDepth ) + {α}_{N} \cdot β + offsetChroma$$

where αᵢ is the coefficient associated with Lᵢ and β is the offset (i.e., 1<< (bitDepth−1)). The position and number of spatial term and non-linear term may be different. For examples, using different position and number as shown in following table.

| Number of terms | Position of terms |
|---|---|
| 1 | One of {L₀, L₁, L₂, L₃, L₄, L₅}, i.e., (L₀) or (L₁) or (L₂) or (L₃) or (L₄) |
| | or (L₅) |
| 2 | Two of {L₀, L₁, L₂, L₃, L₄, L₅}, i.e., (L₀, L₁) or (L₀, L₂) or (L₀, L₃) or |
| | (L₀, L₄) or (L₀, L₅) or (L₁, L₂) or (L₁, L₃) or (L₁, L₄) or (L₁, L₅) or (L₂, |
| | L₃) or (L₂, L₄) or (L₂, L₅) or (L₃, L₄) or (L₃, L₅) or (L₄, L₅) |
| 3 | Three of {L₀, L₁, L₂, L₃, L₄, L₅}, i.e., (L₀, L₁, L₂) or (L₀, L₁, L₃) or |
| | (L₀, L₁, L₄) or (L₀, L₁, L₅) or (L₀, L₂, L₃) or (L₀, L₂, L₄) or (L₀, L₂, L₅) |
| | or (L₀, L₃, L₄) or (L₀, L₃, L₅) or (L₀, L₄, L₅) or (L₁, L₂, L₃) or (L₁, L₂, |
| | L₄) or (L₁, L₂, L₅) or (L₁, L₃, L₄) or (L₁, L₃, L₅) or (L₁, L₄, L₅) or (L₂, |
| | L₃, L₄) or (L₂, L₃, L₅) or (L₂, L₄, L₅) or (L₃, L₄, L₅) |
| 4 | Four of {L₀, L₁, L₂, L₃, L₄, L₅}, i.e., (L₂, L₃, L₄, L₅) or (L₁, L₃, L₄, L₅) |
| | or (L₁, L₂, L₄, L₅) or (L₁, L₂, L₃, L₅) or (L₁, L₂, L₃, L₄) or (L₀, L₃, L₄, |
| | L₅) or (L₀, L₂, L₄, L₅) or (L₀, L₂, L₃, L₅) or (L₀, L₂, L₃, L₄) or (L₀, L₁, |
| | L₄, L₅) or (L₀, L₁, L₃, L₅) or (L₀, L₁, L₃, L₄) or (L₀, L₁, L₂, L₅) or (L₀, |
| | L₁, L₂, L₄) or (L₀, L₁, L₂, L₃) |
| 5 | Five of {L₀, L₁, L₂, L₃, L₄, L₅}, i.e., (L₀, L₁, L₂, L₃, L₄) or (L₀, L₁, L₂, |
| | L₃, L₅) or (L₀, L₁, L₂, L₄, L₅) or (L₀, L₁, L₃, L₄, L₅) or (L₀, L₂, L₃, L₄, |
| | L₅) or (L₁, L₂, L₃, L₄, L₅) |
| 6 | (L₀, L₁, L₂, L₃, L₄, L₅) |

### Filter Shape

One or more shape/number of filter taps may be used for CCCM prediction, as shown in FIG. 25, FIG. 26, and FIGS. 27A to 27B. One or more sets of filter taps may be used for FLM prediction, examples being shown in FIGS. 28A to 28G. The selected luma reference values are non-down-sampled. One or more predefined shape/number of filter taps may be used for CCCM prediction based on previous decoded information on TB/CB/slice/picture/sequence level.

Though a multiple tap filter can fit well on training data (i.e., top/left neighboring reconstructed luma/chroma samples), in some cases, that training data do not capture full characteristics of the testing data, and it may result in overfitting and may not predict well on the testing data (i.e., the to-be-predicted chroma block samples). Also, different filter shapes may adapt well to different video block content, leading to more accurate prediction. To address this issue, the filter shape/number of filter taps can be predefined or signaled/switched in SPS/DPS/VPS/SEI/APS/PPS/PH/SH/Region/CTU/CU/Subblock/Sample levels. A set of filter shape candidates can be predefined or signaled/switched in one or more coding levels, i.e., in SPS/DPS/VPS/SEI/APS/PPS/PH/SH/Region/CTU/CU/Subblock/Sample levels.

Different components (U/V) may have different filter switch control. For example, as shown in the following table, predefining a set of filter shape candidates (idx=0˜5), and filter shape (1, 2) denotes a 2-tap luma filter, while filter shape (1, 2, 4) denotes a 3-tap luma filter as shown in FIG. 20 . . . etc. The filter shape selection of U/V components can be switched in PH or in CU/CTU levels. Note that N-tap can represent N-tap with or without the offset β as described above.

In another example, one syntax element is signaled in a relatively high coding level (e.g., the SPS level) to indicate whether to enable different filter shapes and/or the number of filter shapes. If different filter shapes are enabled or the number of filter shapes is indicated, another syntax element is signaled in a lower coding level (e.g. the CU level) to indicate which filter shapes and/or number of filters are used for the lower coding level. In an example, a syntax element may be signaled in the same coding level (e.g. the SPS level) to indicate which filter shapes are used.

In yet another example, one syntax element is signaled in a relatively high coding level (e.g., the SPS level) to indicate whether to enable CCCM and whether to enable different filter shapes and/or the number of filter shapes (e.g. 0: CCCM off, 1: CCCM with 1 filter, 2: CCCM with 2 filters, . . . , N: CCCM with N filters, where Nis an integer number). If CCCM is enabled and different filter shapes are disable, another syntax element may be signaled in a lower level to indicate whether CCCM is used in the block at the lower level. If CCCM is enabled, and different filter shapes are enabled or the number of filter shapes is indicated, another syntax element is signaled in a lower or the same coding level to indicate which filter shapes and/or number of filters are used.

In yet another example, one syntax element is signaled in a relatively high coding level (e.g., the SPS level) to indicate whether to enable CCCM without down-sampled process. If CCCM without down-sampled process is enabled in the high coding level, one syntax element is further signaled in a lower coding level (e.g. the CU level) to indicate whether CCCM without down-sampled process is used for the block at the lower coding level.

| predefined filter shape candidates: | | # of filter taps | filter shape |
|---|---|---|---|
| idx | 0 | 2 | (1, 2) |
| idx | 1 | 2 | (1, 4) |
| idx | 2 | 2 | (1, 5) |
| idx | 3 | 3 | (1, 2, 4) |
| idx | 4 | 4 | (1, 2, 4, 5) |
| idx | 5 | 6 | (0, 1, 2, 3, 4, 5) |

| POC | comp | selected filter shape idx | |
|---|---|---|---|
| 0 | U | 3 | PH switch |
| | V | 0~5 | CU switch |
| 1 | U | 4 | PH switch |
| | V | 0~2 | CTU switch |

Different chroma types/color formats can have different predefined filter shapes/taps. For example, using predefined filter shape for 420 type-0: (1, 2, 4, 5), 420 type-2: (0, 1, 2, 4, 7), 422: (1, 4), 444: (0, 1, 2, 3, 4, 5) as shown in FIG. 21.

The unavailable luma/chroma samples for deriving the MLR model can be padded from available reconstructed samples. For example, if using a 6-tap (0, 1, 2, 3, 4, 5) filter as in FIG. 21, for a CU located at the left picture boundary, the left columns including (0, 3) are not available (out of picture boundary), so (0, 3) are repetitive padding from (1, 4) to apply the 6-tap filter. Note the padding process applied in both training data (top/left neighboring reconstructed luma/chroma samples) and testing data (the luma/chroma samples in the CU).

According to one or more embodiments of the disclosure, the unavailable luma/chroma samples for deriving the MLR model can be skipped and not used. Then the padding process is not needed for the unavailable luma/chroma samples.

Cclm/MMLM with LDL Decomposition

CCCM requires to process LDL decomposition to calculate the model parameters of CCCM model, avoiding using square root operations and only integer arithmetic is required. In this section, CCLM/MMLM with LDL decomposition are proposed. LDL decomposition may also be used in ELM/FLM/GLM, as described above.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above, to have a better performance with certain complexity trade-off.

In this disclosure, reference samples/training templates/reconstructed neighboring regions usually refer to the luma samples used for deriving the MLR model parameters, which are then applied to the inner luma samples in one CU, to predict the chroma samples in the CU.

CCLM/MMLM with Extended Range

One or more reference samples may be used for CCLM/MMLM prediction, i.e., as shown in FIG. 18, the reference area may be the same as the reference area in CCCM. Different reference areas may be used for CCLM/MMLM prediction based on previous decoded information on TB/CB/slice/picture/sequence level.

Though training data with multiple reference areas can fit well on the calculation of model parameters, in some cases that training data do not capture full characteristics of testing data, it may result in overfitting and may not predict well on testing data (i.e., the to-be-predicted chroma block samples). Also, different reference areas may adapt well to different video block content, leading to more accurate prediction. To address this issue, the reference shape/number reference areas can be predefined or signaled/switched in SPS/DPS/VPS/SEI/APS/PPS/PH/SH/Region/CTU/CU/Subblock/Sample levels. A set of reference area candidates can be predefined or signaled/switched in SPS/DPS/VPS/SEI/APS/PPS/PH/SH/Region/CTU/CU/Subblock/Sample levels. Different components (U/V) may have different reference area switch control. For example, predefined a set of reference area candidates (idx=0˜4) as shown in the table below. The reference area selection of U/V components can be switched in PH or in CU/CTU levels. Different chroma types/color formats can have different predefined reference areas.

| | | | | | | # of top-left |
|---|---|---|---|---|---|---|
| Predefined reference area candidates: | | | | # of top samples | # of left samples | samples |
| | | idx | 0 | W(width of | H(high of block) | 1 |
| | | | | block) | | |
| | | idx | 1 | 2W*6 | 2H*6 | 6*6 |
| | | idx | 2 | 2W*6 | 0 | 6*6 |
| | | idx | 3 | 0 | 2H*6 | 6*6 |
| | | idx | 4 | 6W | 6H | 6*6 |
| POC | comp | Selected reference area idx | | | | |
| 0 | U | 4 | | PH switch | | |
| | V | 0~4 | | CU switch | | |
| 1 | U | 0 | | PH switch | | |
| | V | 0~2 | | CTU switch | | |

The unavailable luma/chroma samples for deriving the MLR model can be padded from available reconstructed samples, the padding process being applied in both training data (top/left neighboring reconstructed luma/chroma samples) and testing data (the luma/chroma samples in the CU).

According to one or more embodiments of the disclosure, the unavailable luma/chroma samples for deriving the MLR model can be skipped and not used. Then the padding process is not needed for the unavailable luma/chroma samples.

### FLM/GLM/ELM/CCCM With Minimal Samples Restriction

FLM requires to process down-sampled luma reference values and calculate model parameters, which burden decoder processing cycles, especially for small blocks. In this section, FLM with minimal samples restriction is proposed, for example, FLM is only used for samples larger than predefined number, such as 64, 128. One or more different restrictions may be used for the purpose, for example, FLM is only used in single model for samples larger than a predefined number, such as 256, and FLM is only used in multi model for samples larger than a predefined number, such as 128.

According to one or more embodiments of the disclosure, the number of predefined minimal samples for single model may be larger than or equal to the number of predefined minimal samples for multi model. For example, FLM/GLM/ELM/CCCM is only used in single model for samples larger than or equal to a predefined number, such as 128, and FLM/GLM/ELM/CCCM is only used in multi model for samples larger than or equal to a predefined number, such as 256.

According to one or more embodiments of the disclosure, the number of predefined minimal samples for FLM/GLM/ELM may be larger than or equal to the number of predefined minimal samples for CCCM. For example, CCCM is only used in single model for samples larger than or equal to a predefined number, such as 0, and CCCM is only used in multi model for samples larger than or equal to a predefined number, such as 128. FLM is only used in single model for samples larger than or equal to a predefined number, such as 128, and FLM is only used in multi model for samples larger than or equal to a predefined number, such as 256.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above (more taps), to have a better performance with certain complexity trade-off.

### Combined Multiple Modes of FLM/GLM/ELM/CCCM/CCLM

According to one or more embodiments of the disclosure, two models of multiple modes of FLM/GLM/ELM/CCCM/CCLM may be further combined to bring additional coding efficiency. For example, first the parameters of CCCM(cᵢ) and GLM(a, b) are derived separately, then the weights (wᵢ) between CCCM and GLM are derived by linear regression, finally the weighted CCCM and GLM are used to predict chroma samples from reconstructed luma samples.

$$GLMpredChromaVal = a * lumaVal + b$$

$$CCCMpredChromaVal = {c}_{0} * C + {c}_{1} * N + {c}_{2} * S + {c}_{3} * E + {c}_{4} * W + {c}_{5} * P + {c}_{6} * B$$

$$FinalpredChromaVal = {w}_{0} * GLMpredChromaVal + {w}_{1} * CCCMpredChromaVal$$

According to one or more embodiments of the disclosure, there is a flag signaled/switched in SPS/DPS/VPS/SEI/APS/PPS/PH/SH/Region/CTU/CU/Subblock/Sample levels to indicate whether the combined mode is used or not.

According to one or more embodiments of the disclosure, instead of explicitly signaling the selected mode flag, the mode flag can be derived at decoder to save bit overhead.
(1) Determine M combined candidates for the current CU
(2) Divide the available L-shaped template area into N regions, denoted as R₀, R₁, . . . R_{N-1 (divide the training data into N sets, N-fold training)}
(3) Apply M combined candidates independently to part of available template area (can be single or multiple regions in R₀, R₁, . . . R_{N-1})
(4) Derive M filter coefficient sets (according to M filter shapes), denoted as F₀, F₁, . . . F_{M-1}
(5) Apply the derived F₀, F₁, . . . F_{M-1} filter coefficient sets to other part of available template area, different from the part of available template in (3)
(6) Accumulate errors by SAD, SSD, or SATD, denoted as E₀, E₁, . . . E_{M-1}
(7) Sort and pick K smallest errors, denoted as E′₀, E′₁, . . . E′_{K-1}, which correspond to K combined filters/K filter coefficient sets
(8) Signal and select 1 combined filter in K, to apply to the current CU for chroma prediction; If K is 1, then don't need to signal (the filter shape with the smallest error is the applied combined filter)

For example,
(1) Predefine 3 filter candidates for the current CU, such as CCCM, GLM and combined CCCM and GLM
(2) Divide the available L-shaped template area (CCCM 6 chroma rows/columns, note that in CCCM design, each chroma sample involves 6 luma samples for down-sampling) into 2 regions, denoted as R₀, R₁
E.g., even rows/columns: R₀, odd rows/columns: R₁
FIG. 29A shows the example that in template area, even-row area R₀ is used for training/deriving 3 filter coefficient sets, and odd-row area R₁ is used for validation/comparing and sorting costs of 3 filter coefficient sets.
(3) Apply 3 filter candidates independently to part of available template area (single R₀)
(4) Derive 3 filter coefficient sets (according to 4 filter shapes), denoted as F₀, F₁, F₂
(5) Apply the derived F₀, F₁, F₂ filter coefficient sets to other part of available template area (R₁), different from the part of available template in (3)
(6) Accumulate errors by SAD, SSD, or SATD, denoted as E₀, E₁, E₂
(7) Sort and pick 1 smallest error, denoted as E′₀, which correspond to 1 filter shapes/1 filter coefficient sets
(8) K is 1, then don't need to signal (the filter with the smallest error is the applied filter shape)

Please note that methods/examples in this section can be combined/reused from the methods mentioned in all sections, including but not limited to classification, filter shape, matrix derivation (with special handling), applied region, syntax. Moreover, methods/examples listed in this section can also be applied in all sections to have a better performance with certain complexity trade-off.

CCCM with Non-Down-Sampled and Down-Sampled Luma Reference Values

Only down-sampled luma reference values may be used in CCCM to calculate model parameters and apply the CCCM model. In this section, non-down-sampled luma reference values are also used in CCCM to calculate model parameters and apply the CCCM model, including utilizing non-down-sampled and down-sampled luma reference values in different or the same position. One or more filter shapes may be used for the purpose, as description above.

In one example, the convolutional 8-tap filter may include a 6-tap rectangle shape spatial component, a down-sampled luma sample and a bias term. The input to the spatial 6-tap component of the filter includes a center (b) non-down-sampled luma sample which is collocated with the chroma sample to be predicted and its non-down-sampled below-left or south-west (d), below-right or south-east (f), below or south (e), left or west (a) and right or east (c) neighbors as illustrated Shape 1 in FIG. 25 and a center (C) down-sampled luma sample which is collocated with the chroma sample to be predicted.

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} C + {c}_{7} B$$

In another example, the convolutional 9-tap filter may consist of a 6-tap rectangle shape spatial component, two non-linear terms and a bias term. The input to the spatial 6-tap component of the filter consists of a center (b) non-down-sampled luma sample which is collocated with the chroma sample to be predicted and which is located substantially at the center of the filter shape, and its non-down-sampled below-left/south-west (d), below-right/south-east (f), below/south (e), left/west (a) and right/east (c) neighbors as illustrated Shape 1 in FIG. 25 and a center (C) down-sampled luma sample which is collocated with the chroma sample to be predicted (for example, the center (C) down-sampled luma sample value is determined by a weighted-average operation).

The non-linear terms P and Q are two non-linear luma sample values, which are represented respectively as power of the luma sample value of the center (b) non-down-sampled luma sample and center (C) down-sampled luma sample then scaled to the sample value range of the content:

$$\begin{matrix}P = ( b * b + midVal ) ≫ bitDepth ; \\ Q = ( C * C + midVal ) ≫ bitDepth .\end{matrix}$$

That is, for 10-bit content it is calculated as:

$$\begin{matrix}P = ( b * b + 512 ) ≫ 10 ; \\ Q = ( C * C + 512 ) ≫ 10.\end{matrix}$$

The bias term B is a bias value which represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} P + {c}_{7} Q + {c}_{8} B$$

It should be understood that the non-linear terms P and Q can be represented as power of any luma sample values of down-sampled/non-down-sampled luma samples for predicting the corresponding chroma sample value. The two non-linear terms P and Q are only exemplary, and the corresponding chroma sample value can be calculated based on one or more non-linear values.

As mentions above, the non-linear term Q can also be represented as power of a non-down-sampled luma sample of the filter. In such an example, the convolutional 9-tap filter may consist of a 6-tap rectangle shape spatial component, two non-linear terms and a bias term. The input to the spatial 6-tap component of the filter consists of a center (b) non-down-sampled luma sample which is collocated with the chroma sample to be predicted and which is located substantially at the center of the filter shape, and its non-down-sampled below-left/south-west (d), below-right/south-east (f), below/south (e), left/west (a) and right/east (c) neighbors as illustrated Shape 1 in FIG. 25.

The non-linear terms P and Q are two non-linear luma sample values, which are represented respectively as power of the luma sample value of the center (b) luma sample and the below/south (e) luma sample then scaled to the sample value range of the content:

$$\begin{matrix}P = ( b * b + midVal ) ≫ bitDepth ; \\ Q = ( e * e + midVal ) ≫ bitDepth .\end{matrix}$$

That is, for 10-bit content it is calculated as:

$$\begin{matrix}P = ( b * b + 512 ) ≫ 10 ; \\ Q = ( e * e + 512 ) ≫ 10.\end{matrix}$$

The bias term B is a bias value which represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} a + {c}_{1} b + {c}_{2} c + {c}_{3} d + {c}_{4} e + {c}_{5} f + {c}_{6} P + {c}_{7} Q + {c}_{8} B$$

In yet another example, the convolutional 9-tap filter may include original CCCM 7-tap terms correspond to down-sampled reconstructed luma samples, and 2-tap spatial terms correspond to 2 neighboring original reconstructed luma samples, i.e., without down-sampling as shown in FIG. 30 (i.e., L₂, L₃) to predict the chroma sample. The CCCM 7-tap filter consist of a 5-tap plus sign shape spatial component, a non-linear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 17.

The non-linear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B + {c}_{7} {L}_{2} + {c}_{8} {L}_{3}$$

Please note that L₂, L₃ may be replaced by any two neighboring original reconstructed luma samples, i.e., without down-sampling as shown in FIG. 30 (i.e., L₀, L₁, . . . , L₅).

In yet another example, the convolutional N-tap (N is an integer and larger than 7) filter may include original CCCM 7-tap terms correspond to down-sampled reconstructed luma samples, (N−7−M)-tap (M is an integer) spatial terms and M non-linear terms correspond to neighboring original reconstructed luma samples, i.e., without down-sampling as shown in FIG. 30 (i.e., L₀, L1, . . . , L₅) to the chroma sample. The CCCM 7-tap filter consist of a 5-tap plus sign shape spatial component, a non-linear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 17.

The non-linear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B + {\sum }_{i = 0}^{N - 7 - M} {c}_{i + M + 7 + 1} \cdot {L}_{j} + {\sum }_{i = 0}^{M} {c}_{i + 7} \cdot ( ( {( {L}_{j} )}^{2} + β ) ≫ bitDepth )$$

Please note that original reconstructed luma samples used in spatial terms and non-linear terms may be replaced by any neighboring original reconstructed luma samples, i.e., without down-sampling as shown in FIG. 30 (i.e., L₀, L₁, . . . , L₅).

It should be understood that the filter shape is not limited to the plus sign shape used by CCCM and can be any shape as required. For example, the filter shape may be any one of the shapes as shown in FIG. 25.

Please note that methods/examples in this section can be combined/reused from the methods mentioned above, including but not limited to classification, filter shape, matrix derivation (with special handling), applied region, syntax. Moreover, methods/examples listed in this section can also be applied in the methods mentioned above (more taps), to have a better performance with certain complexity trade-off.

In this disclosure, reference samples/training template/reconstructed neighboring region usually refers to the luma samples used for deriving the MLR model parameters, which are then applied to the inner luma samples in one CU, to predict the chroma samples in the CU.

According to one or more embodiments of the disclosure, CCCM without down-sampled process and CCCM with down-sampled process may be used by different taps or shapes. For example, the filter shape/number of filter taps with down-sampled values and without down-sampled values may be predefined or signaled/switched in SPS/DPS/VPS/SEI/APS/PPS/PH/SH/Region/CTU/CU/Subblock/Sample levels.

In one example, one filter with down-sampled values and one filter without down-sampled values may be signaled/switched in CU levels. The filter with down-sampled values is the same as CCCM. The filter without down-sampled values may consists of (N−1−M)-tap (N and M are integer) spatial terms, M non-linear terms and a bias term. The (N−1−M)-tap spatial terms correspond to neighboring original reconstructed luma samples, i.e., without down-sampling as shown in FIG. 30 (i.e., L₀, L₁, . . . , L₅) to the chroma sample to be predicted.

$$predChromaVal = {\sum }_{i = 0}^{N - 1 - M} {α}_{i} \cdot {L}_{i} + {\sum }_{i = 0}^{M} {α}_{i + N - M} \cdot ( ( {( {L}_{i} )}^{2} + β ) ≫ bitDepth ) + {α}_{N + 1} \cdot β$$

where αᵢ is the coefficient associated with Lᵢ and β is the offset.

In another example, one filter with down-sampled values and two filters without down-sampled values may be signaled/switched in CU levels. The filter with down-sampled values is the same as CCCM. One filter without down-sampled values may consists of (N−1−M)-tap (N and M are integer) spatial terms, M non-linear terms and a bias term. The (N−1−M)-tap spatial terms correspond to neighboring original reconstructed luma samples, i.e., without down-sampling as shown in FIG. 30 (i.e., L₀, L₁, . . . , L₅) to the chroma sample to be predicted.

$$predChromaVal = {\sum }_{i = 0}^{N - 1 - M} {α}_{i} \cdot {L}_{i} + {\sum }_{i = 0}^{M} {α}_{i + N - M} \cdot ( ( {( {L}_{i} )}^{2} + β ) ≫ bitDepth ) + {α}_{N + 1} \cdot β$$

where αᵢ is the coefficient associated with Lᵢ and β is the offset. The other filter without down-sampled values may consists of (N−2)-tap (N is integer) spatial terms, one non-linear terms and a bias term. The (N−2)-tap spatial terms correspond to neighboring original reconstructed luma samples, i.e., without down-sampling to the chroma sample to be predicted.

$$predChromaVal = {\sum }_{i = 0}^{N - 2} {α}_{i} \cdot {L}_{i} + {\sum }_{i = 0}^{1} {α}_{i + N - 1} \cdot ( ( {( {L}_{i} )}^{2} + β ) ≫ bitDepth ) + {α}_{N + 1} \cdot β$$

where αᵢ is the coefficient associated with Lᵢ and β is the offset.

In yet another example, one syntax element is signaled in a relatively high coding level (e.g., the SPS level) to indicate whether to enable CCCM with down-sampled process. And in an example, one syntax element is signaled in the high coding level to indicate whether to enable CCCM without down-sampled process. In an example, if CCCM with down-sampled process is enabled in the high coding level, one syntax element is further signaled in a lower coding level (e.g. the CU level) to indicate whether CCCM with down-sampled process is used for the block at the lower level. In an example, if CCCM without down-sampled process is enabled in the high coding level, one syntax element is further signaled in a lower coding level (e.g. the CU level) to indicate whether CCCM without down-sampled process is used for the block at the lower level.

In yet another example, one syntax element is signaled in a relatively high coding level (e.g., the SPS level) to indicate whether to enable CCCM with down-sampled process and whether to enable CCCM without down-sampled process (e.g. 0: CCCM off, 1: CCCM with down-sampled process enabled, 2: CCCM without down-sampled process enabled, 3: both CCCM with down-sampled process and CCCM without down-sampled process enabled). Then in a lower coding level (e.g., the CU level), another syntax element is signaled to indicate whether to enable CCCM with down-sampled process and whether to enable CCCM without down-sampled process in the block at the lower coding level. In an example, if CCCM with down-sampled process is enabled in the high coding level, another syntax element is signaled in a lower coding level (e.g., the CU level) to indicate whether CCCM with down-sampled process is used or not in the block at the lower coding level. In an example, if both CCCM with down-sampled process and CCCM without down-sampled process are enabled in the high coding level, another syntax element is signaled in a lower coding level (e.g. the CU level) to indicate whether to enable CCCM with down-sampled process or whether to enable CCCM without down-sampled process in the block at the lower coding level.

According to one or more embodiments of the disclosure, the reference samples/training template/reconstructed neighboring region used for derivation of multi-model parameters and the reference samples/training template/reconstructed neighboring region used for computing multi-model thresholds may be different.

According to one or more embodiments of the disclosure, the reference samples/training template/reconstructed neighboring region may be predefined or signaled/switched in SPS/DPS/VPS/SEI/APS/PPS/PH/SH/Region/CTU/CU/Subblock/Sample levels. For an example, FIG. 9A shows an example that L-shape reconstructed region, left/top reconstructed region to derive parameters.

According to one or more embodiments of the disclosure, the non-down-sampled luma reference values may be predefined or signaled/switched in SPS/DPS/VPS/SEI/APS/PPS/PH/SH/Region/CTU/CU/Subblock/Sample levels. For an example, to predict chroma sample values based on corresponding non-down-sampled luma reference values, the collocated non-down-sampled luma reference values may be represented by pDsY[x][y] with x=0 . . . nTbW−1, y=0 . . . nTbH−1, where a variable nTbW specifying the transform block width and a variable nTbH specifying the transform block height, wherein pDsY[x][y] are derived as equal to the collocated luma sample values pY[x][y] with x=0 . . . nTbW*SubWidthC−1, y=0 . . . nTbH*SubHeightC−1, i.e., pDsY[x][y] are set equal to the reconstructed luma sample values prior to the deblocking filter process at the locations (xTbY+x, yTbY+y). The factors SubWidthC and SubHeightC are the width/height scale factors corresponding to the chroma format of the current block respectively.

The boundary luma samples pY[x][y] for the boundary part of the block are derived as follows:
When availL is equal to TRUE (i.e., the left luma sample values are available), the boundary luma samples pY[x][y] with x=−3 . . . 1, y=(availT?−1:0) . . . . SubHeightC*Max(nTbH, numSampL)−1, are set equal to the reconstructed luma samples prior to the deblocking filter process at the locations (xTbY+x, yTbY+y).
When availT is equal to FALSE (i.e., the top luma sample values are unavailable), the boundary luma samples pY[x][y] with x=−2 . . . . SubWidthC*nTbW−1, y=−2 . . . 1, are set equal to the luma samples pY[x][0].
When availT is equal to TRUE (i.e., the top luma sample values are available), the boundary luma samples pY[x][y] with x=(availL?−1:0) . . . . SubWidthC*Max (nTbW, numSampT)−1, y=−3 . . . 1, are set equal to the reconstructed luma samples prior to the deblocking filter process at the locations (xTbY+x, yTbY+y).
When availL is equal to FALSE (i.e., the left luma sample values are unavailable), the boundary luma samples pY[x][y] with x=−1, y=−2 . . . . SubHeightC*nTbH−1, are set equal to the reconstructed luma samples pY[0][y].

In an example, to predict the chroma sample value for the chroma sample with coordinates (x, y), the central non-down-sampled collocated luma samples pDsY[x][y] with X=0 . . . nTbW−1, y=0 . . . nTbH−1 are determined based on the chroma format of the block, and derived as follows:
If both SubWidthC and SubHeightC are equal to 1 (i.e., the chroma format being 4:4:4), the following applies:

$$pDsY [ x ] [ y ] = pY [ SubWidthC * x ] [ SubHeightC * y ] = pY [ x ] [ y ] ;$$

Otherwise, if SubHeightC is equal to 1 and SubWidthC is equal to 2 (i.e., the chroma format being 4:2:2), the following applies:

$$pDsY [ x ] [ y ] = pY [ SubWidthC * x ] [ SubHeightC * y ] = pY [ 2 * x ] [ y ] ;$$

Otherwise, if SubHeightC is equal to 2 and SubWidthC is equal to 1 (i.e., the chroma format being 4:2:2), the following applies:

$$pDsY [ x ] [ y ] = pY [ SubWidthC * x ] [ SubHeightC * y ] = pY [ x ] [ 2 * y ] ;$$

Otherwise, if both SubWidthC and SubHeightC are equal to 2 (i.e., the chroma format being 4:2:0), the following applies:

$$pDsY [ x ] [ y ] = pY [ SubWidthC * x ] [ SubHeightC * y ] = pY [ 2 * x ] [ 2 * y ] .$$

In an example, the variables SubWidthC and SubHeightC are specified in the following table, depending on the chroma format sampling structure, which is specified through sps_chroma_format_idc. An additional flag (e.g., sps_chroma_vertical_collocated_flag) may be used to indicate the chroma format 4:2:2 where SubWidthC is equal to 1 and SubHeightC is equal to 2.

| sps_chroma_format_idc | Chroma format | SubWidthC | SubHeightC |
|---|---|---|---|
| 0 | Monochrome | 1 | 1 |
| 1 | 4:2:0 | 2 | 2 |
| 2 | 4:2:2 | 2 | 1 |
| 3 | 4:4:4 | 1 | 1 |

According to one or more embodiments of the disclosure, the luma offset may be removed when the non-down-sampled luma reference values are used. For an example, the samples values used in both model creation and final prediction (i.e., luma and chroma in the reference area, and luma in the current block) are reduced by these fixed values, as follows: Lᵢ′=Lᵢ—offsetLuma, where Lᵢ′ are the new terms for chroma sample prediction, and reference sample values for the sample above and to the left of the top-left sample of the block are used as the offsets (offsetLuma, offsetCb and offsetCr).

In another example, as shown in FIG. 30, the convolutional N-tap (N is an integer and larger than 1) filter may consists of (N−1−M)-tap (M is an integer) spatial terms, M non-linear terms and a bias term. The (N−1−M)-tap spatial terms correspond to neighboring luma samples (i.e., L₀, L₁, . . . , L₅) to the chroma sample to be predicted, reduced by offsetLuma. Please note that neighboring original reconstructed luma samples used in spatial terms and non-linear terms may be replaced by any neighboring original reconstructed luma samples, i.e., without down-sampling as shown in FIG. 30 (i.e., L₀, L₁, . . . , L₅).

$$predChromaVal = {\sum }_{i = 0}^{N - 1 - M} {α}_{i} \cdot ( {L}_{i} - offsetLuma ) + {\sum }_{i = 0}^{M - 1} {α}_{i + N - M} \cdot ( ( {( {L}_{i} - offsetLuma )}^{2} + β ) ≫ bitDepth ) + {α}_{N} \cdot β + offsetChroma$$

where αᵢ is the coefficient associated with Lᵢ and β is the offset (i.e., 1<<(bitDepth−1)). The position and number of spatial term and non-linear term may be different. For examples, using different position and number as shown in following table.

| Number of terms | Position of terms |
|---|---|
| 1 | One of {L₀, L₁, L₂, L₃, L₄, L₅}, i.e., (L₀) or (L₁) or (L₂) or (L₃) or (L₄) |
| | or (L₅) |
| 2 | Two of {L₀, L₁, L₂, L₃, L₄, L₅}, i.e., (L₀, L₁) or (L₀, L₂) or (L₀, L₃) or |
| | (L₀, L₄) or (L₀, L₅) or (L₁, L₂) or (L₁, L₃) or (L₁, L₄) or (L₁, L₅) or (L₂, |
| | L₃) or (L₂, L₄) or (L₂, L₅) or (L₃, L₄) or (L₃, L₅) or (L₄, L₅) |
| 3 | Three of {L₀, L₁, L₂, L₃, L₄, L₅}, i.e., (L₀, L₁, L₂) or (L₀, L₁, L₃) or |
| | (L₀, L₁, L₄) or (L₀, L₁, L₅) or (L₀, L₂, L₃) or (L₀, L₂, L₄) or (L₀, L₂, L₅) |
| | or (L₀, L₃, L₄) or (L₀, L₃, L₅) or (L₀, L₄, L₅) or (L₁, L₂, L₃) or (L₁, L₂, |
| | L₄) or (L₁, L₂, L₅) or (L₁, L₃, L₄) or (L₁, L₃, L₅) or (L₁, L₄, L₅) or (L₂, |
| | L₃, L₄) or (L₂, L₃, L₅) or (L₂, L₄, L₅) or (L₃, L₄, L₅) |
| 4 | Four of {L₀, L₁, L₂, L₃, L₄, L₅}, i.e., (L₂, L₃, L₄, L₅) or (L₁, L₃, L₄, L₅) |
| | or (L₁, L₂, L₄, L₅) or (L₁, L₂, L₃, L₅) or (L₁, L₂, L₃, L₄) or (L₀, L₃, L₄, |
| | L₅) or (L₀, L₂, L₄, L₅) or (L₀, L₂, L₃, L₅) or (L₀, L₂, L₃, L₄) or (L₀, L₁, |
| | L₄, L₅) or (L₀, L₁, L₃, L₅) or (L₀, L₁, L₃, L₄) or (L₀, L₁, L₂, L₅) or (L₀, |
| | L₁, L₂, L₄) or (L₀, L₁, L₂, L₃) |
| 5 | Five of {L₀, L₁, L₂, L₃, L₄, L₅}, i.e., (L₀, L₁, L₂, L₃, L₄) or (L₀, L₁, L₂, |
| | L₃, L₅) or (L₀, L₁, L₂, L₄, L₅) or (L₀, L₁, L₃, L₄, L₅) or (L₀, L₂, L₃, L₄, |
| | L₅) or (L₁, L₂, L₃, L₄, L₅) |
| 6 | (L₀, L₁, L₂, L₃, L₄, L₅) |

CCCM with Location Information

No location information is used in CCCM when calculating the filter coefficients and predicting the chroma sample values. In this section, location information is also used in CCCM to calculate the filter coefficients and predict the chroma sample values, including utilizing horizontal/vertical/diagonal distances between the center luma sample of the filter and a reference luma sample, and the non-linear terms of the distances. One or more location information may be used for the purpose.

In one example, the location based parameter is a distance value related to the vertical and horizontal coordinates (Xc, Yc) of the center luma sample of the filter and it is calculated with respect to the coordinates of a reference luma sample, for example, the coordinates (Xtl, Ytl) for the luma sample above and to the left of the top-left luma sample of the block, e.g. Xc−Xtl+Yc−Ytl. In this example, the CCCM includes a term (Xc−Xtl+Yc−Ytl) corresponding to the sum of horizontal coordinate difference and vertical coordinate difference between the center luma sample and the luma sample above and to the left of the top-left luma sample of the block.

In another example, the location based parameters are distance values related to the vertical and horizontal coordinates (Xc, Yc) of the center luma sample of the filter and they are calculated with respect to the reference coordinates (Xtl, Ytl) of the block, e.g. Xc−Xtl+Yc−Ytl, Xc−Xtl, Yc−Ytl. In this example, besides the term corresponding to (Xc−Xtl+Yc−Ytl), the CCCM further includes a term corresponding to the horizontal coordinate difference (Xc−Xtl) and a term corresponding to the vertical coordinate difference (Yc−Ytl).

In yet another example, the location based parameter is a distance value related to the vertical and horizontal coordinates (Xc, Yc) of the center luma sample of the filter and it is calculated with respect to the reference coordinates (Xtl, Ytl) of the block, e.g. (Xc−Xtl+Yc−Ytl)/N, where N is predefined number, such as 2. In this example, the CCCM includes a term corresponding to a product of (Xc−Xtl+Yc−Ytl) and a factor 1/N.

In yet another example, the location based parameters are distance values related to the vertical and horizontal coordinates (Xc, Yc) of the center luma sample of the filter and they are calculated with respect to the reference coordinates (Xtl, Ytl) of the block, e.g. (Xc−Xtl+Yc−Ytl)/N1, (Xc−Xtl)/N2, (Yc−Ytl)/N3, where N1˜N3 are predefined numbers, such as 2, 3, and 4. In this example, the CCCM further includes terms corresponding to a product of (Xc−Xtl+Yc−Ytl) and a factor 1/N1; a product of (Xc−Xtl) and a factor 1/N2; and a product of (Yc−Ytl) and a factor 1/N3.

In yet another example, the location based non-linear terms are represented as power of two of the horizontal/vertical/diagonal distances, e.g. (Xc−Xtl+Yc−Ytl)*(Xc−Xtl+Yc−Ytl), (Xc−Xtl)*(Xc−Xtl), (Yc−Ytl)*(Yc−Ytl), where (Xc, Yc) are vertical and horizontal coordinates of the center luma sample of the filter and (Xtl, Ytl) are reference coordinates.

### Inherited FLM/GLM/ELM/CCCM

In this section, it is proposed to inherit the derived parameters of FLM/GLM/ELM/CCCM from previous decoded blocks at e.g., TB/CB/slice/picture/sequence level. According to one or more embodiments of the disclosure, one control flag is signaled in e.g., TB/CB/slice/picture/sequence level to indicate whether the signaling of inherited FLM/GLM/ELM/CCCM is enabled or disabled. When the control flag is signaled as enabled, a flag of inherited FLM/GLM/ELM/CCCM is further signaled to decoder to indicate whether the inherited FLM/GLM/ELM/CCCM is used or not at the signaled coding level.

According to one or more embodiments of the disclosure, the derived parameters of FLM/GLM/ELM/CCCM from previous decoded block at e.g., TB/CB/slice/picture/sequence level can be stored and used as current parameters of FLM/GLM/ELM/CCCM (which is called inherited FLM/GLM/ELM/CCCM) for the current block. In one example, for a given block, a flag is signaled to the decoder to indicate whether the block uses an inherited FLM/GLM/ELM/CCCM or not. If the block is coded using an inherited FLM/GLM/ELM/CCCM, an index of inherited list is further signaled to decoder to indicate which inherited mode is used. Additionally, if the number of inherited candidates is one, no further syntax element is signaled to indicate the index for inherited mode and a default index (e.g. 0) is used for inherited mode.

According to one or more embodiments of the disclosure, the index of inherited intra mode may be binarized by different methods. Different methods may be used to derive the variable sets of binary codewords, with some exemplar methods listed as follows: Fixed length binarization; Truncated Rice binarization; Truncated unary binarization; Truncated Binary (TB) binarization; k-th order Exp-Golomb binarization (EGk); and Limited k-th order Exp-Golomb binarization.

According to one or more embodiments of the disclosure, the derived parameters of FLM/GLM/ELM/CCCM from previous decoded block at TB/CB/slice/picture/sequence level can be stored and used as parameters of FLM/GLM/ELM/CCCM (which is called inherited FLM/GLM/ELM/CCCM) for the current block when the calculation of filter coefficients reaches to singularity.

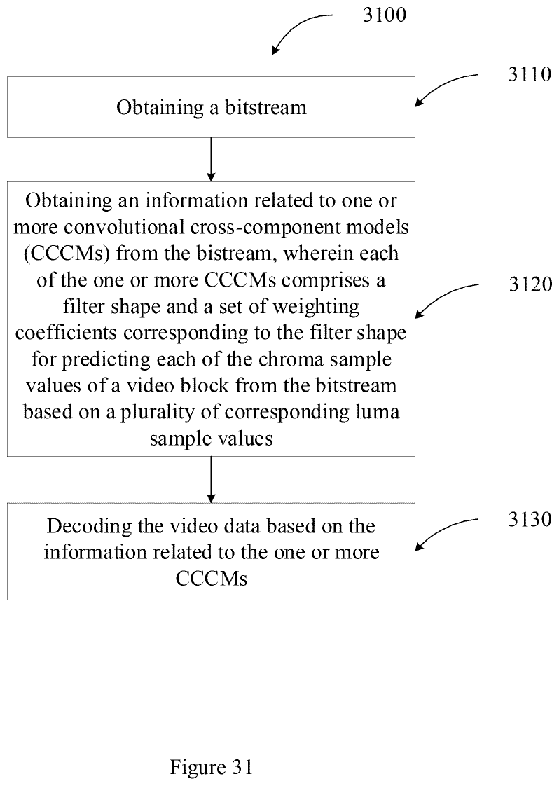

FIG. 31 illustrates a workflow of a method 3100 for decoding video data according to one or more aspects of the present disclosure.

At step 3110, the method 3100 comprises obtaining a bitstream.

At step 3120, the method 3100 comprises obtaining an information related to one or more convolutional cross-component models (CCCMs) from the bitstream, wherein each of the one or more CCCMs comprises a filter shape and a set of weighting coefficients corresponding to the filter shape for predicting each of the chroma sample values of a video block from the bitstream based on a plurality of corresponding luma sample values.

At step 3130, the method 3100 comprises decoding the video data based on the information related to the one or more CCCMs.

In one example, the one or more CCCMs comprises one or more respective CCCMs for decoding the video data at different coding levels.

In one example, the information comprises a first syntax element in a first coding level for indicating one or more of: whether to enable CCCM with down-sampled process at the first coding level; whether to enable CCCM without down-sampled process at the first coding level; whether to enable different filter shapes at the first coding level; the number of different filter shapes being used at the first coding level; or which of the filter shapes are used at the first coding level.

In one example, the information further comprises a second syntax element in a second coding level lower than the first coding level for indicating one or more of: whether to enable CCCM with down-sampled process at the second coding level; whether to enable CCCM without down-sampled process at the second coding level; whether to enable different filter shapes at the second coding level; the number of different filter shapes being used at the second coding level; or which of the filter shapes are used at the second coding level.

In one example, the method 3100 further comprises: in response to the first syntax element indicating that different filter shapes are enabled at the first coding level or the number of different filter shapes being used at the first coding level, determining that the second syntax element is used to indicate: the number of different filter shapes being used at the second coding level; or which of the filter shapes are used at the second coding level.

In one example, the method 3100 further comprises: in response to the first syntax element indicating that CCCM without down-sampled process is enabled at the first coding level, determining that the second syntax element is used to indicate: whether to enable CCCM without down-sampled process at the second coding level.

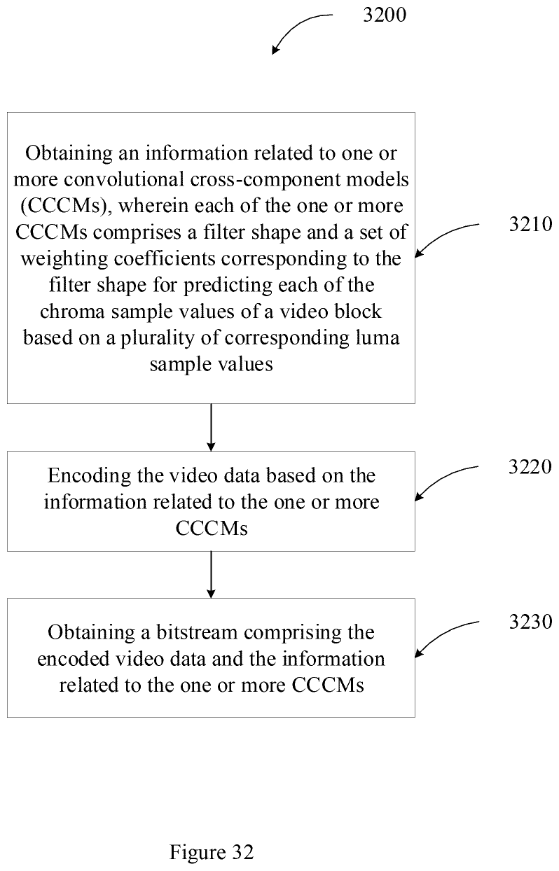

FIG. 32 illustrates a workflow of a method 3200 for encoding video data according to one or more aspects of the present disclosure.

At step 3210, the method 3200 comprises obtaining an information related to one or more convolutional cross-component models (CCCMs), wherein each of the one or more CCCMs comprises a filter shape and a set of weighting coefficients corresponding to the filter shape for predicting each of the chroma sample values of a video block based on a plurality of corresponding luma sample values.

At step 3220, the method 3200 comprises encoding the video data based on the information related to the one or more CCCMs.

At step 3230, the method 3200 comprises obtaining a bitstream comprising the encoded video data and the information related to the one or more CCCMs.

In one example, the one or more CCCMs comprises one or more respective CCCMs for encoding the video data at different coding levels.

In one example, the information comprises a first syntax element in a first coding level for indicating one or more of: whether to enable CCCM with down-sampled process at the first coding level; whether to enable CCCM without down-sampled process at the first coding level; whether to enable different filter shapes at the first coding level; the number of different filter shapes being used at the first coding level; or which of the filter shapes are used at the first coding level.

In one example, the information further comprises a second syntax element in a second coding level lower than the first coding level for indicating one or more of: whether to enable CCCM with down-sampled process at the second coding level; whether to enable CCCM without down-sampled process at the second coding level; whether to enable different filter shapes at the second coding level; the number of different filter shapes being used at the second coding level; or which of the filter shapes are used at the second coding level.

In one example, the method 3200 further comprises: when the first syntax element indicates different filter shapes are enabled at the first coding level or the number of different filter shapes being used at the first coding level, setting the second syntax element to indicate: the number of different filter shapes being used at the second coding level; or which of the filter shapes are used at the second coding level.

In one example, the method 3200 further comprises: when the first syntax element indicates CCCM without down-sampled process is enabled at the first coding level, setting the second syntax element to indicate: whether to enable CCCM without down-sampled process at the second coding level.

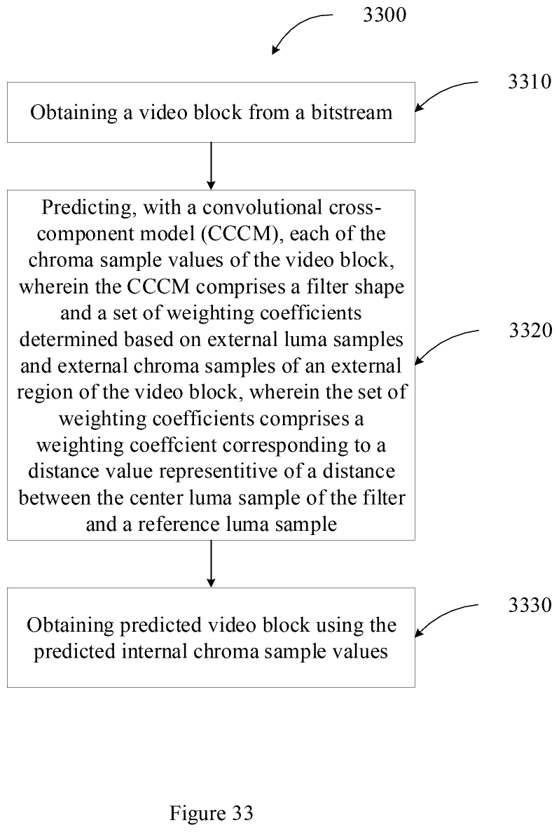

FIG. 33 illustrates a workflow of a method 3300 for decoding video data according to one or more aspects of the present disclosure.

At step 3310, the method 3300 comprises obtaining a video block from a bitstream.

At step 3320, the method 3300 comprises predicting, with a convolutional cross-component model (CCCM), each of the chroma sample values of the video block, wherein the CCCM comprises a filter shape and a set of weighting coefficients determined based on external luma samples and external chroma samples of an external region of the video block, wherein the set of weighting coefficients comprises a weighting coefficient corresponding to a distance value representative of a distance between the center luma sample of the filter and a reference luma sample.

At step 3330, the method 3300 comprises obtaining predicted video block using the predicted internal chroma sample values.

In one example, the reference luma sample is the luma sample above and to the left of the top-left luma sample of the video block.

In one example, the distance value is determined as one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

In one example, the distance value is determined as a square of one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

In one example, the distance value is determined as a product of a factor and one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

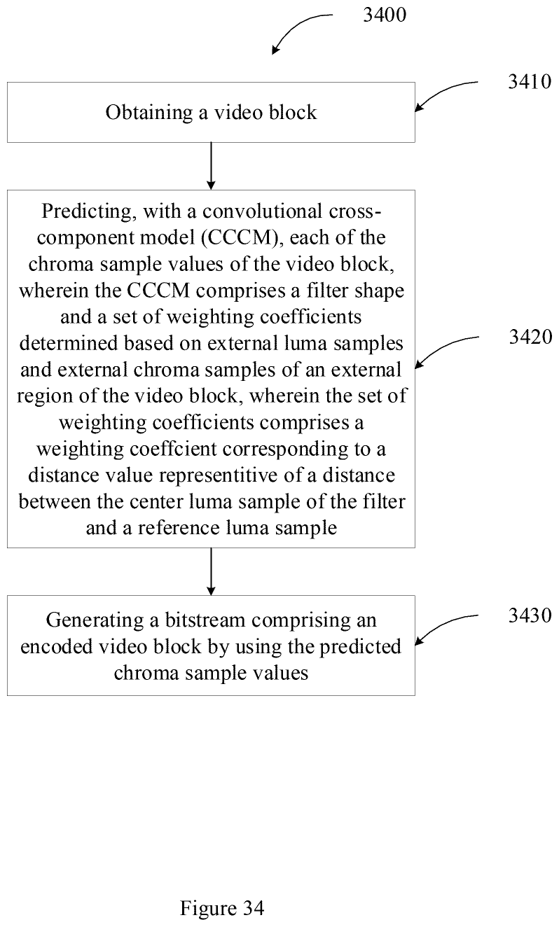

FIG. 34 illustrates a workflow of a method 3400 for encoding video data according to one or more aspects of the present disclosure.

At step 3410, the method 3400 comprises obtaining a video block.

At step 3420, the method 3400 comprises predicting, with a convolutional cross-component model (CCCM), each of the chroma sample values of the video block, wherein the CCCM comprises a filter shape and a set of weighting coefficients determined based on external luma samples and external chroma samples of an external region of the video block, wherein the set of weighting coefficients comprises a weighting coefficient corresponding to a distance value representative of a distance between the center luma sample of the filter and a reference luma sample.

At step 3430, the method 3400 comprises generating a bitstream comprising an encoded video block by using the predicted chroma sample values.

In one example, the reference luma sample is the luma sample above and to the left of the top-left luma sample of the video block.

In one example, the distance value is determined as one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

In one example, the distance value is determined as a square of one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

In one example, the distance value is determined as a product of a factor and one of: the sum of horizontal coordinate difference and vertical coordinate difference between the center luma sample and the reference luma sample; the horizontal coordinate difference between the center luma sample and the reference luma sample; or the vertical coordinate difference between the center luma sample and the reference luma sample.

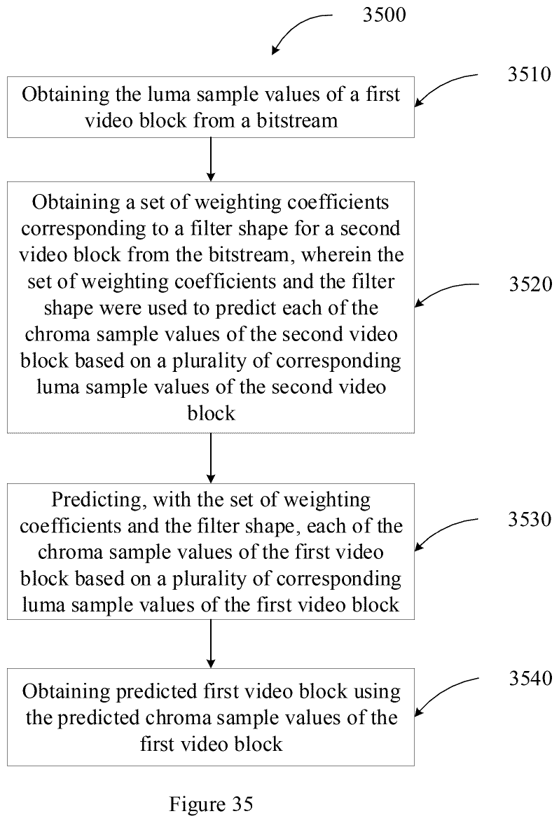

FIG. 35 illustrates a workflow of a method 3500 for decoding video data according to one or more aspects of the present disclosure.

At step 3510, the method 3500 comprises obtaining the luma sample values of a first video block from a bitstream.

At step 3520, the method 3500 comprises obtaining a set of weighting coefficients corresponding to a filter shape for a second video block from the bitstream, wherein the set of weighting coefficients and the filter shape were used to predict each of the chroma sample values of the second video block based on a plurality of corresponding luma sample values of the second video block.

At step 3530, the method 3500 comprises predicting, with the set of weighting coefficients and the filter shape, each of the chroma sample values of the first video block based on a plurality of corresponding luma sample values of the first video block.

At step 3540, the method 3500 comprises obtaining predicted first video block using the predicted chroma sample values of the first video block.

In one example, the method 3500 further comprises obtaining, from the bitstream, information related to whether to predict the chroma sample values of the first video block with the obtained set of weighting coefficients and the filter shape.

In one example, the method 3500 further comprises obtaining an index indicating different sets of weighting coefficients and the corresponding filter shapes.

In one example, the method 3500 further comprises determining the set of weighting coefficients and the filter shape for predicting each of the chroma sample values of the first video block based on the index and a syntax element from the bitstream.

In one example, the index is binarized by one of: Fixed length binarization; Truncated Rice binarization; Truncated unary binarization; Truncated Binary (TB) binarization; k-th order Exp-Golomb binarization (EGk); or Limited k-th order Exp-Golomb binarization.

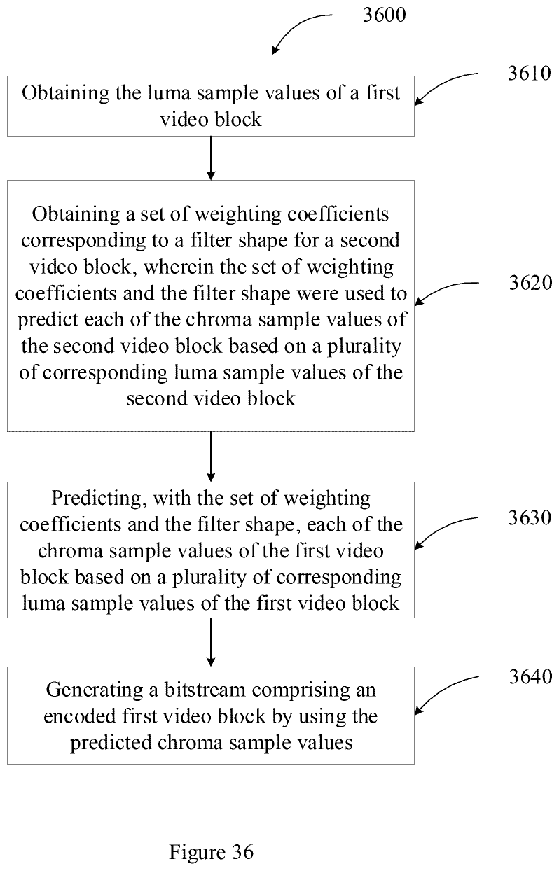

FIG. 36 illustrates a workflow of a method 3600 for encoding video data according to one or more aspects of the present disclosure.

At step 3610, the method 3600 comprises obtaining the luma sample values of a first video block.

At step 3620, the method 3600 comprises obtaining a set of weighting coefficients corresponding to a filter shape for a second video block, wherein the set of weighting coefficients and the filter shape were used to predict each of the chroma sample values of the second video block based on a plurality of corresponding luma sample values of the second video block.

At step 3630, the method 3600 comprises predicting, with the set of weighting coefficients and the filter shape, each of the chroma sample values of the first video block based on a plurality of corresponding luma sample values of the first video block.

At step 3640, the method 3600 comprises generating a bitstream comprising an encoded first video block by using the predicted chroma sample values.

In one example, the method 3600 further comprises determining information related to whether to predict the chroma sample values of the first video block with the obtained set of weighting coefficients and the filter shape.

In one example, the method 3600 further comprises determining an index indicating different sets of weighting coefficients and the corresponding filter shapes.

In one example, the method 3600 further comprises determining the set of weighting coefficients and the filter shape for predicting each of the chroma sample values of the first video block based on the index and a syntax element.

In one example, the index is binarized by one of: Fixed length binarization; Truncated Rice binarization; Truncated unary binarization; Truncated Binary (TB) binarization; k-th order Exp-Golomb binarization (EGk); or Limited k-th order Exp-Golomb binarization.

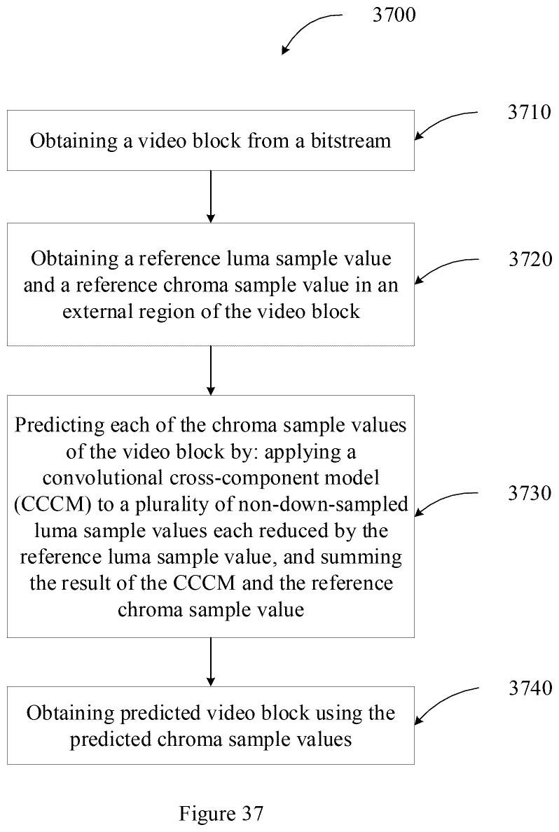

FIG. 37 illustrates a workflow of a method 3700 for decoding video data according to one or more aspects of the present disclosure.

At step 3710, the method 3700 comprises obtaining a video block from a bitstream.

At step 3720, the method 3700 comprises obtaining a reference luma sample value and a reference chroma sample value in an external region of the video block.

At step 3730, the method 3700 comprises predicting each of the chroma sample values of the video block by: applying a convolutional cross-component model (CCCM) to a plurality of non-down-sampled luma sample values each reduced by the reference luma sample value, and summing the result of the CCCM and the reference chroma sample value.

At step 3740, the method 3700 comprises obtaining predicted video block using the predicted chroma sample values.

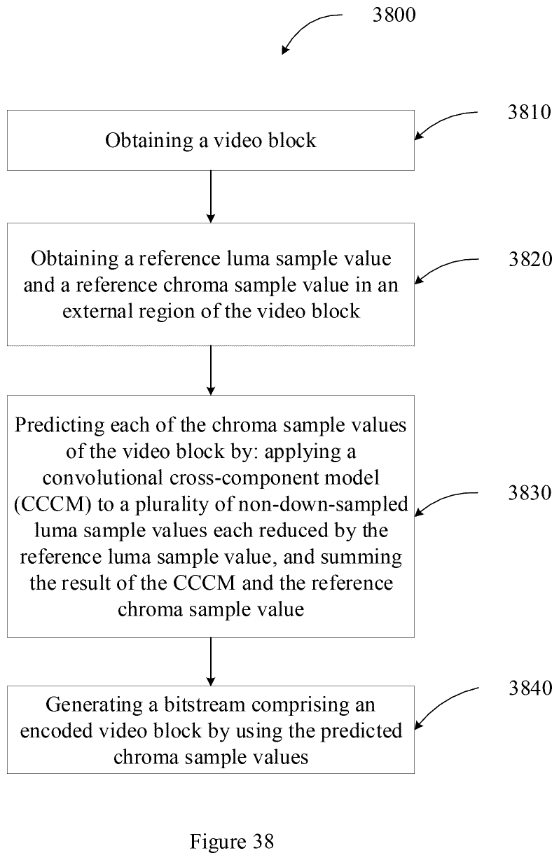

FIG. 38 illustrates a workflow of a method 3800 for encoding video data according to one or more aspects of the present disclosure.

At step 3810, the method 3800 comprises obtaining a video block.

At step 3820, the method 3800 comprises obtaining a reference luma sample value and a reference chroma sample value in an external region of the video block.

At step 3830, the method 3800 comprises predicting each of the chroma sample values of the video block by: applying a convolutional cross-component model (CCCM) to a plurality of non-down-sampled luma sample values each reduced by the reference luma sample value, and summing the result of the CCCM and the reference chroma sample value.

At step 3840, the method 3800 comprises generating a bitstream comprising an encoded video block by using the predicted chroma sample values.

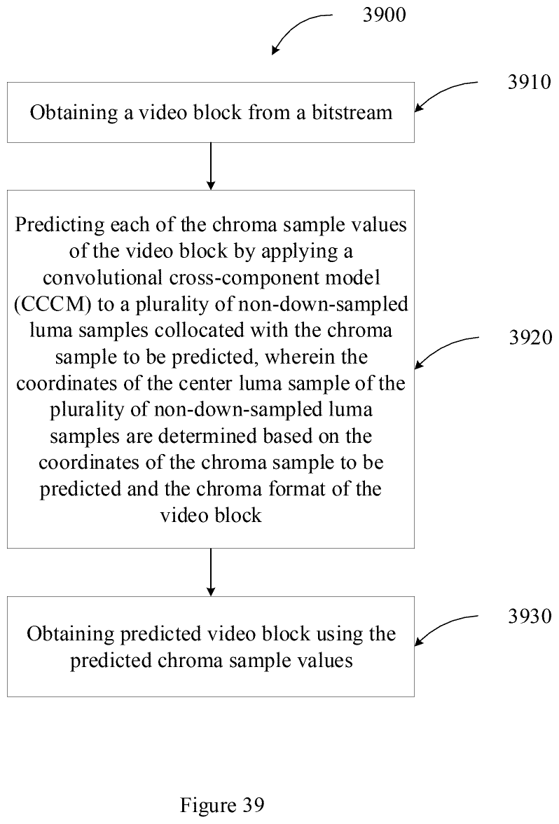

FIG. 39 illustrates a workflow of a method 3900 for decoding video data according to one or more aspects of the present disclosure.

At step 3910, the method 3900 comprises obtaining a video block from a bitstream.

At step 3920, the method 3900 comprises predicting each of the chroma sample values of the video block by applying a convolutional cross-component model (CCCM) to a plurality of non-down-sampled luma samples collocated with the chroma sample to be predicted, wherein the coordinates of the center luma sample of the plurality of non-down-sampled luma samples are determined based on the coordinates of the chroma sample to be predicted and the chroma format of the video block.

At step 3930, the method 3900 comprises obtaining predicted video block using the predicted chroma sample values.

In one example, when the chroma format is 4:4:4, the coordinates of the center luma sample are determined as equal to the coordinates of the chroma sample to be predicted.

In one example, when the chroma format is 4:2:2, one of the horizontal and vertical coordinates of the center luma sample is determined as equal to the corresponding coordinate of the chroma sample to be predicted, while the other one of the horizontal and vertical coordinates is determined as equal to the twice of the other coordinate of the chroma sample to be predicted.

In one example, when the chroma format is 4:2:0, the coordinates of the center luma sample are determined as equal to the twice the coordinates of the chroma sample to be predicted.

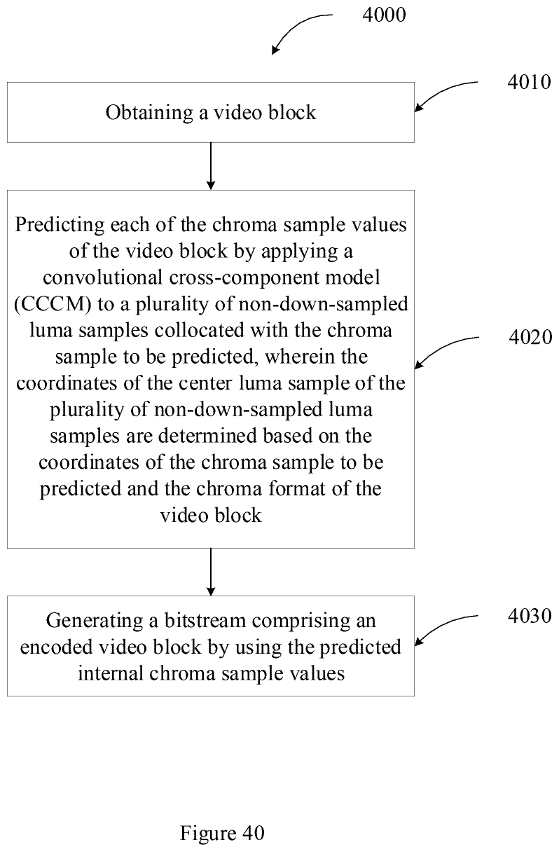

FIG. 40 illustrates a workflow of a method 4000 for encoding video data according to one or more aspects of the present disclosure.

At step 4010, the method 4000 comprises obtaining a video block.

At step 4020, the method 4000 comprises predicting each of the chroma sample values of the video block by applying a convolutional cross-component model (CCCM) to a plurality of non-down-sampled luma samples collocated with the chroma sample to be predicted, wherein the coordinates of the center luma sample of the plurality of non-down-sampled luma samples are determined based on the coordinates of the chroma sample to be predicted and the chroma format of the video block.

At step 4030, the method 4000 comprises generating a bitstream comprising an encoded video block by using the predicted internal chroma sample values.

In one example, when the chroma format is 4:4:4, the coordinates of the center luma sample are determined as equal to the coordinates of the chroma sample to be predicted.

In one example, when the chroma format is 4:2:2, one of the horizontal and vertical coordinates of the center luma sample is determined as equal to the corresponding coordinate of the chroma sample to be predicted, while the other one of the horizontal and vertical coordinates is determined as equal to the twice of the other coordinate of the chroma sample to be predicted.

In one example, when the chroma format is 4:2:0, the coordinates of the center luma sample are determined as equal to the twice the coordinates of the chroma sample to be predicted.

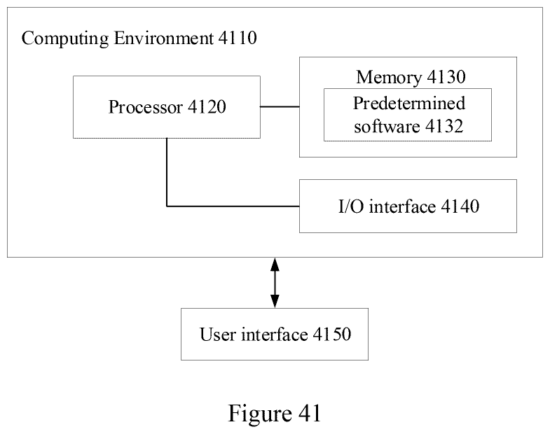

FIG. 41 shows a computing environment 4110 coupled with a user interface 4150. The computing environment 4110 can be part of a data processing server. The computing environment 4110 includes a processor 4120, a memory 4130, and an Input/Output (I/O) interface 4140.

The processor 4120 typically controls overall operations of the computing environment 4110, such as the operations associated with display, data acquisition, data communications, and image processing. The processor 4120 may include one or more processors to execute instructions to perform all or some of the steps in the above-described methods. Moreover, the processor 4120 may include one or more modules that facilitate the interaction between the processor 4120 and other components. The processor may be a Central Processing Unit (CPU), a microprocessor, a single chip machine, a Graphical Processing Unit (GPU), or the like.

The memory 4130 is configured to store various types of data to support the operation of the computing environment 4110. The memory 4130 may include predetermined software 4132. Examples of such data includes instructions for any applications or methods operated on the computing environment 4110, video datasets, image data, etc. The memory 4130 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 4140 provides an interface between the processor 4120 and peripheral interface modules, such as a keyboard, a click wheel, buttons, and the like. The buttons may include but are not limited to, a home button, a start scan button, and a stop scan button. The I/O interface 4140 can be coupled with an encoder and decoder.

In an embodiment, there is also provided a non-transitory computer-readable storage medium comprising a plurality of programs, for example, in the memory 4130, executable by the processor 4120 in the computing environment 4110, for performing the above-described methods and/or storing a bitstream generated by the encoding method described above or a bitstream to be decoded by the decoding method described above. In one example, the plurality of programs may be executed by the processor 4120 in the computing environment 4110 to receive (for example, from the video encoder 20 in FIG. 2) a bitstream or data stream including encoded video information (for example, video blocks representing encoded video frames, and/or associated one or more syntax elements, etc.), and may also be executed by the processor 4120 in the computing environment 4110 to perform the decoding method described above according to the received bitstream or data stream. In another example, the plurality of programs may be executed by the processor 4120 in the computing environment 4110 to perform the encoding method described above to encode video information (for example, video blocks representing video frames, and/or associated one or more syntax elements, etc.) into a bitstream or data stream, and may also be executed by the processor 4120 in the computing environment 4110 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 4120); and the non-transitory computer-readable storage medium or the memory 4130 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 4130, executable by the processor 4120 in the computing environment 4110, for performing the above-described methods. For example, the computer program product may include the non-transitory computer-readable storage medium.

In an embodiment, the computing environment 4110 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for decoding video data, comprising:
obtaining a bitstream;
obtaining an information related to one or more convolutional cross-component models (CCCMs) from the bitstream, wherein each of the one or more CCCMs comprises a filter shape and a set of weighting coefficients corresponding to the filter shape for predicting each of chroma sample values of a video block from the bitstream based on a plurality of corresponding luma sample values; and
decoding the video data based on the information related to the one or more CCCMs.

2. The method of claim 1, wherein the one or more CCCMs comprises one or more respective CCCMs for decoding the video data at different coding levels.

3. The method of claim 2, wherein the information comprises a first syntax element in a first coding level for indicating one or more of:
whether to enable CCCM with down-sampled process at the first coding level;
whether to enable CCCM without down-sampled process at the first coding level;
whether to enable different filter shapes at the first coding level;
the number of different filter shapes being used at the first coding level; or
which of the filter shapes are used at the first coding level.

4. The method of claim 3, wherein the information further comprises a second syntax element in a second coding level lower than the first coding level for indicating one or more of:
whether to enable CCCM with down-sampled process at the second coding level;
whether to enable CCCM without down-sampled process at the second coding level;
whether to enable different filter shapes at the second coding level;
the number of different filter shapes being used at the second coding level; or
which of the filter shapes are used at the second coding level.

5. The method of claim 4, further comprising: in response to the first syntax element indicating that different filter shapes are enabled at the first coding level or the number of different filter shapes being used at the first coding level, determining that the second syntax element is used to indicate:
the number of different filter shapes being used at the second coding level; or
which of the filter shapes are used at the second coding level.

6. The method of claim 4, further comprising: in response to the first syntax element indicating that CCCM without down-sampled process is enabled at the first coding level, determining that the second syntax element is used to indicate:
whether to enable CCCM without down-sampled process at the second coding level.

7. A method for encoding video data, comprising:
obtaining an information related to one or more convolutional cross-component models (CCCMs), wherein each of the one or more CCCMs comprises a filter shape and a set of weighting coefficients corresponding to the filter shape for predicting each of chroma sample values of a video block based on a plurality of corresponding luma sample values;
encoding the video data based on the information related to the one or more CCCMs; and
obtaining a bitstream comprising the encoded video data and the information related to the one or more CCCMs.

8. The method of claim 7, wherein the one or more CCCMs comprises one or more respective CCCMs for encoding the video data at different coding levels.

9. The method of claim 8, wherein the information comprises a first syntax element in a first coding level for indicating one or more of:
whether to enable CCCM with down-sampled process at the first coding level;
whether to enable CCCM without down-sampled process at the first coding level;
whether to enable different filter shapes at the first coding level;
the number of different filter shapes being used at the first coding level; or
which of the filter shapes are used at the first coding level.

10. The method of claim 9, wherein the information further comprises a second syntax element in a second coding level lower than the first coding level for indicating one or more of:
whether to enable CCCM with down-sampled process at the second coding level;
whether to enable CCCM without down-sampled process at the second coding level;
whether to enable different filter shapes at the second coding level;
the number of different filter shapes being used at the second coding level; or
which of the filter shapes are used at the second coding level.

11. The method of claim 10, further comprising: when the first syntax element indicates different filter shapes are enabled at the first coding level or the number of different filter shapes being used at the first coding level, setting the second syntax element to indicate:
the number of different filter shapes being used at the second coding level; or
which of the filter shapes are used at the second coding level.

12. The method of claim 10, further comprising: when the first syntax element indicates CCCM without down-sampled process is enabled at the first coding level, setting the second syntax element to indicate:
whether to enable CCCM without down-sampled process at the second coding level.

13. An electronic apparatus, comprising:
one or more processors; and
one or more memories storing computer-executable instructions that, when executed by the one or more processors, cause the electronic apparatus to perform decoding operations such that the one or more processors are configured to:
obtain a bitstream;
obtain an information related to one or more convolutional cross-component models (CCCMs) from the bitstream, wherein each of the one or more CCCMs comprises a filter shape and a set of weighting coefficients corresponding to the filter shape for predicting each of chroma sample values of a video block from the bitstream based on a plurality of corresponding luma sample values; and
decode video data based on the information related to the one or more CCCMs

14. A non-transitory computer readable storage medium storing a bitstream to be decoded by the decoding method according to claim 1.
